(19) United States
(12) Patent Application Publication
(10) Pub. No.: US 2025/0142595 A1
(43) Pub. Date: May 1, 2025

(54) METHODS FOR SIDELINK UNLICENSED CHANNEL ACCESS

(71) Applicant: INTERDIGITAL PATENT HOLDINGS, INC., Wilmington, DE (US)

(72) Inventors: Tao Deng, New York, NY (US); Patrick Tooher, Montreal (CA); Tuong Hoang, Montreal (CA); Moon IL Lee, Melville, NY (US); Martino Freda, Laval (CA); Faris Alfarhan, Montreal (CA); Aata El Hamss, Laval (CA)

(73) Assignee: INTERDIGITAL PATENT HOLDINGS, INC., Wilmington, DE (US)

(21) Appl. No.: 18/837,477

(22) PCT Filed: Feb. 8, 2023
(86) PCT No.: PCT/US2023/012632

§ 371 Date: Aug. 9, 2024

Related U.S. Application Data
(60) Provisional application No. 63/308,341, filed on Feb. 9, 2022.
(60) Provisional application No. 63/327,206, filed on Apr. 4, 2022.
(60) Provisional application No. 63/395,220, filed on Aug. 4, 2022.
(60) Provisional application No. 63/410,907, filed on Sep. 28, 2022.
(60) Provisional application No. 63/421,831, filed on Nov. 2, 2022.

(51) Int. Cl. H04W 72/25; H04L 27/26; H04W 72/0446

(52) U.S. Cl. CPC H04W 72/25; H04L 27/2607; H04W 72/0446

(57) ABSTRACT

There may be approaches for sidelink unlicensed (SL U) channel access in Mode 2. For example, a wireless transmit receive unit (WTRU) may perform SL U channel access and resource selection for channel occupancy time (COT) sharing and COT initiation within a resource selection window (RSW). The WTRU may detect COT and share based on control information, such as remaining duration, the number of scheduled transmission(s) within the COT, frequency resource assignment, priority, cast type, WTRU source and/or destination ID, COT/resource reservation, channel congestion, etc. The WTRU may determine SL COT initiation based on LBT and SCI sensing information including COT/resource reservation, priority, cast type, WTRU source and/or destination ID, channel congestion, etc. The WTRU may determine transmission resources within shared and initiated SL COT based on WTRU source and/or destination ID of a TB to transmit, RB interlace assignment indicated in decoded SCI associated with an overlapping reserved COT.

### CROSS-REFERENCE TO RELATED APPLICATIONS

This application claims the benefit of U.S. Provisional Application No. 63/308,341, filed Feb. 9, 2022, U.S. Provisional Application No. 63/327,206 filed Apr. 4, 2022, U.S. Provisional Application No. 63/395,220 filed Aug. 4, 2022, U.S. Provisional Application No. 63/410,907 filed Sep. 28, 2022, and U.S. Provisional Application No. 63/421,831 filed Nov. 2, 2022, the contents of which are incorporated herein by reference.

### BACKGROUND

In unlicensed spectrum communication, a process known as listen before talk may be employed to ensure that each device operating in the unlicensed spectrum does not interrupt another device. There is a need, however, to improve this basic concept to provide for a more efficient and capable system for communicating in unlicensed spectrum.

### SUMMARY

There may be approaches for sidelink unlicensed (SL U) channel access in Mode 2. For example, a wireless transmit receive unit (WTRU) may perform SL U channel access and resource selection for channel occupancy time (COT) sharing and COT initiation within a resource selection window (RSW). The WTRU may detect COT and share based on control information, such as remaining duration, the number of scheduled transmission(s) within the COT, frequency resource assignment, priority, cast type, WTRU source and/or destination ID, COT/resource reservation, channel congestion, etc. The WTRU may determine SL COT initiation based on LBT and SCI sensing information including COT/resource reservation, priority, cast type, WTRU source and/or destination ID, channel congestion, etc.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIGS. 2A and 2B illustrate an examples of SL U resource allocation unit;

FIG. 3 illustrates an example of sharing WTRU determination of Type 2 LBT for COT sharing;

FIGS. 4A, 4B, and 4C illustrate an example of SL U channel access and resource selection example;

FIG. 5 illustrates an example of a WTRU determination of COT starting position within a SL slot;

FIG. 6 illustrates an example of a WTRU resource group/COT selection before Type 1 LBT for COT initiation; and

FIG. 7 illustrates an example of a process for a WTRU to transmit in unlicensed spectrum.

### DETAILED DESCRIPTION

As discussed herein, there may be one or more abbreviations as indicated in Table 1.

TABLE 1

| | |
|---|---|
| ACK | Acknowledgement |
| AGC | Automatic Gain Control |
| BLER | Block Error Rate |
| BWP | BandWidth Part |
| CAPC | Channel Access Priority Class |
| CB | Contention-Based (e.g. access, channel, resource) |
| CBR | Channel Busy Ratio |
| CCA | Clear Channel Access |
| CORSET | COntrol Resource SET |
| COT | Channel Occupancy Time |
| CP | Cyclic Prefix |
| CP-OFDM | Conventional OFDM (relying on cyclic prefix) |
| CQI | Channel Quality Indicator |
| CR | Channel Occupancy Ratio |
| CRC | Cyclic Redundancy Check |
| CSI | Channel State Information |
| D2D | Device to Device transmissions (e.g. LTE Sidelink) |
| DCI | Downlink Control Information |
| DFN | Direct Frame Number |
| DFT-s-OFDM | Digital Fourier Transform spread OFDM |
| DL | Downlink |
| DMRS | Demodulation Reference Signal |
| FR | Frequency Range |
| FB | Feed Back |
| FDD | Frequency Division Duplexing |
| FDM | Frequency Division Multiplexing |
| GNSS | Global Navigation Satellite System |
| LBT | Listen-Before-Talk |
| LLC | Low Latency Communications |
| LTE | Long Term Evolution e.g. from 3GPP LTE R8 and up |
| MAC | Medium Access Control |
| NACK | Negative ACK |
| MBB | Massive Broadband Communications |
| MC | MultiCarrier |
| MCOT | Maximum Channel Occupancy Time |
| MCS | Modulation and Coding Scheme |
| NR U | NR Unlicensed |
| OFDM | Orthogonal Frequency-Division Multiplexing |
| OCB | Occupied Channel Bandwidth |
| OOB | Out-Of-Band (emissions) |
| P_{cmax} | Total available WTRU power in a given TI |
| PDB | Packet Delay Budget |
| PHY | Physical Layer |
| PRB | physical Resource Block |
| PSCCH | Physical SL Control Channel |
| PSFCH | Physical SL Feedback Channel |
| PSD | Power Spectrum Density |
| PSS | Primary Synchronization Signal |
| PSSCH | Physical SL Shared Channel |
| PSSCH-RSRP | PSSCH Reference Signal Received Power |
| PT-RS | Phase Tracking Reference Signal |
| QCL | Quasi Co Location |
| QoS | Quality of Service (from the physical layer perspective) |
| RE | Resource Element |
| RNTI | Radio Network Identifier |
| RRC | Radio Resource Control |
| RRM | Radio Resource Management |
| RS | Reference Signal |
| RTT | Round-Trip Time |
| SL-RSSI | SL Received Signal Strength Indicator |
| SCI | SL Control Information |
| SL | Side Link |
| SL U | Side Link in Unlicensed spectrum |
| SPS | Semi Persistent Scheduling |
| SRI | SRS Resource Indicator |
| SRS | Sounding Reference Signal |
| SS | Synchronization Signal |
| SSS | Secondary Synchronization Signal |
| SSB | Synchronization Signal Block |
| TB | Transport Block |
| TCI | Transmission Configuration Indication |
| TDD | Time-Division Duplexing |
| TDM | Time-Division Multiplexing |
| TPMI | Transmitted Precoding Matrix Indicator |
| TTI | Transmission Time Interval |
| TRP | Transmission/Reception Point |
| TRX | Transceiver |
| UL | Uplink |
| URLLC | Ultra-Reliable and Low Latency Communications |
| V2X | Vehicular communications |
| VRU | Vulnerable Road User |
| WI | Working Item |
| ZC | Zadoff Chu |

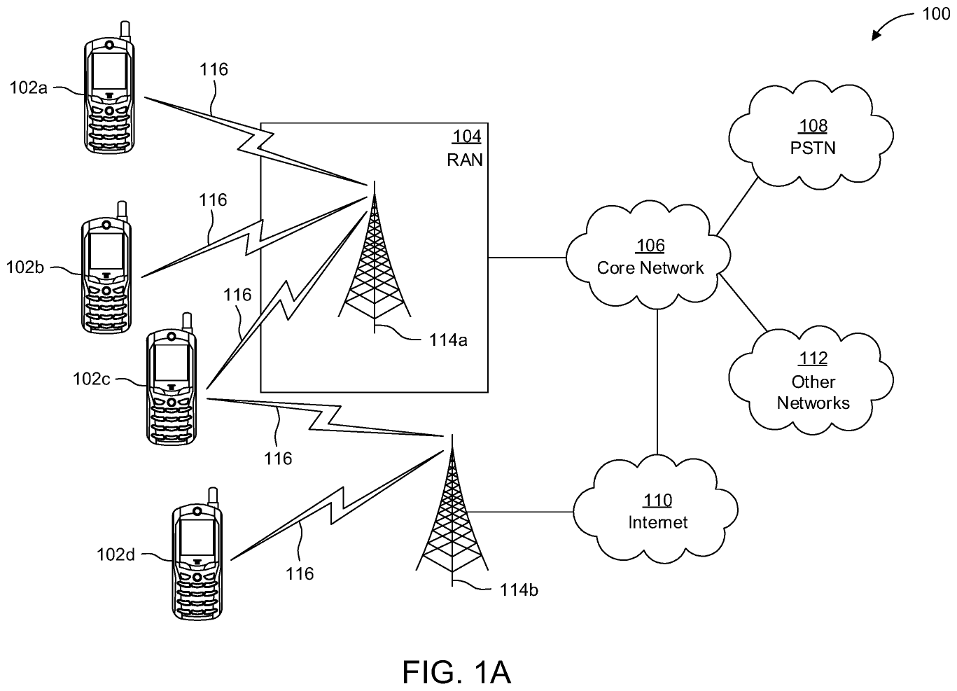

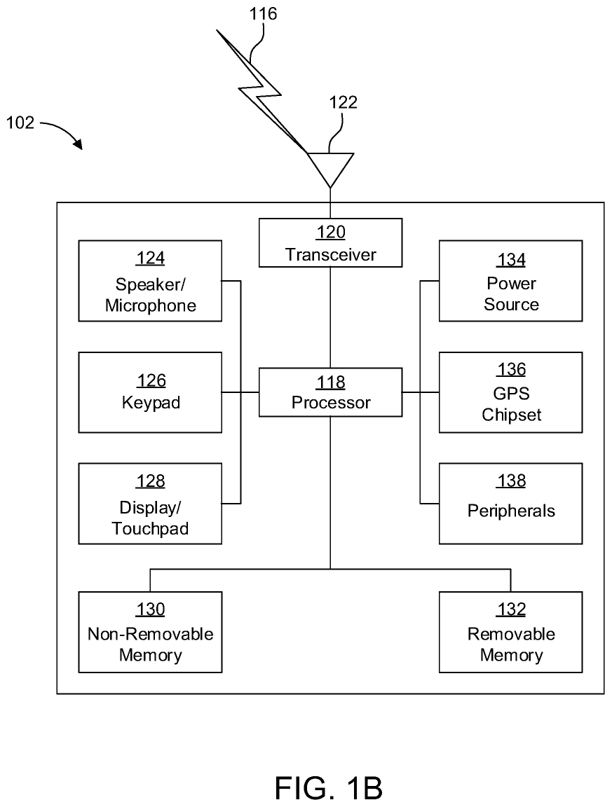

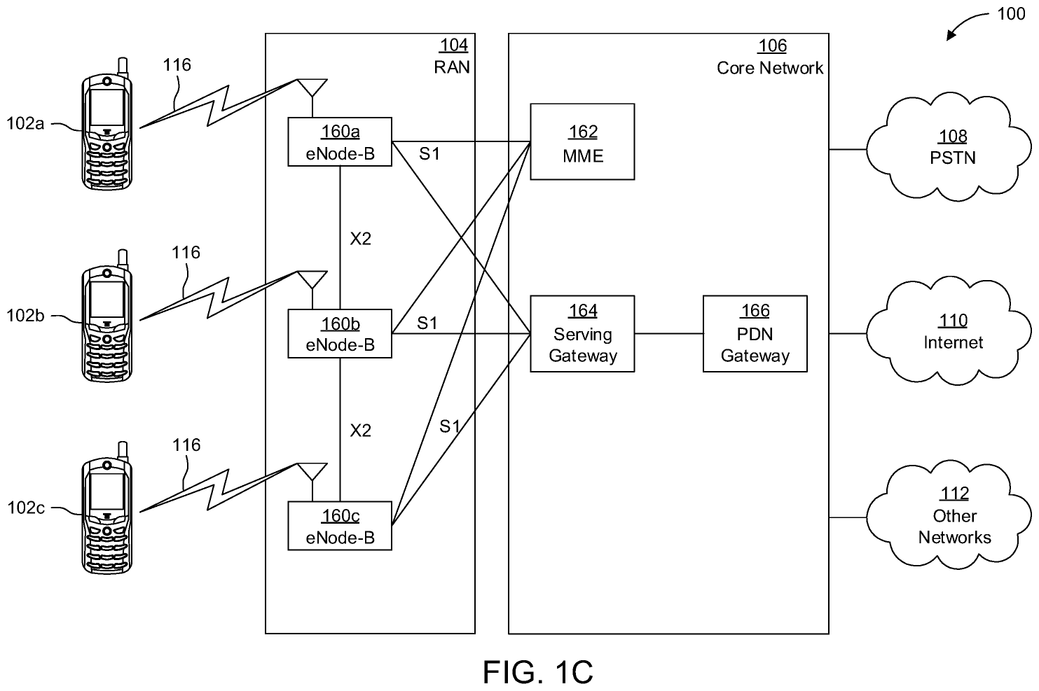

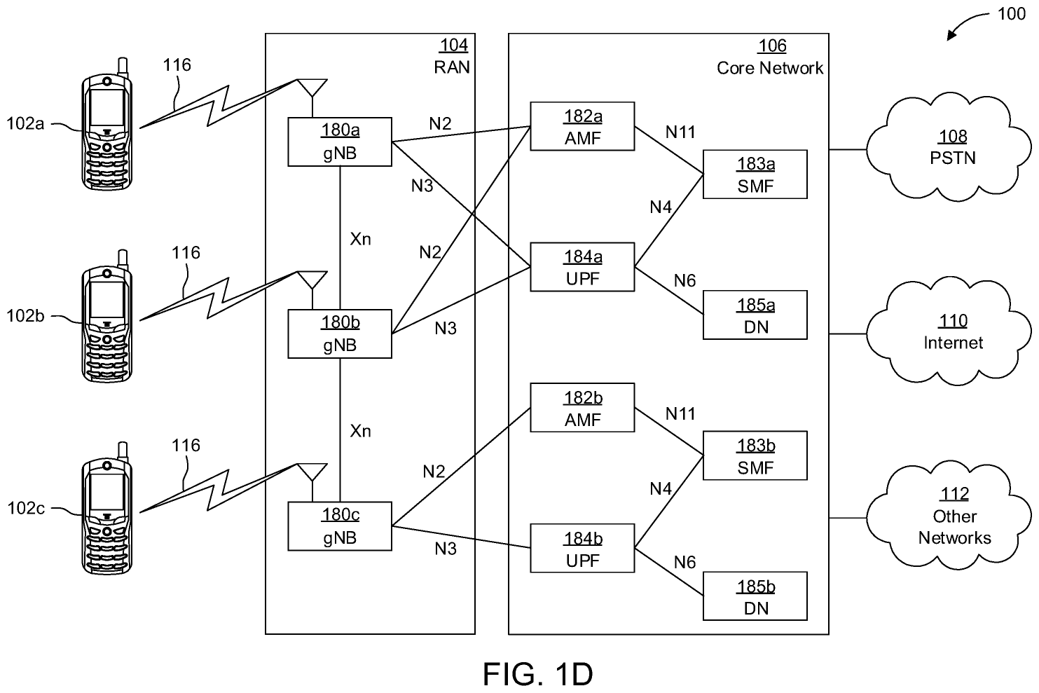

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (e.g., which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some cases, a WTRU may operate in unlicensed (U) spectrum. Further, the WTRU may communicate using sidelink (SL) communication. Accordingly, there may be sidelink operation for both Mode 1 and Mode 2 in an unlicensed spectrum, such as Frequency Range 1 (FR1), which may be referred to as sidelink unlicensed (SL U). For example, the unlicensed SL frequency bands may be 5 GHz and 6 GHz and the Uu operation related to Mode 1 may be limited to licensed spectrum only. The SL U channel access design may be based on regional regulation requirements with New Radio Unlicensed (NR U) channel access as a starting point.

SL resource allocation mechanism(s) for licensed spectrum may be (re)used in SL U. SL U may cover changes to NR SL PHY channel structures and procedures to operate in unlicensed spectrum.

In some cases, a WTRU may operate in unlicensed spectrum. Further, the WTRU may communicate in an NR system. In New Radio Unlicensed (NR U), a WTRU may access a channel for UpLink (UL) transmission(s) according to one of Type 1 or Type 2 UL channel access procedures. The procedures may be designed to comply with regulatory requirements related to, for example, sensing (e.g., Listen Before Talk (LBT)), Maximum Channel Occupancy Time (MCOT), Occupied Channel Bandwidth (OCB), and/or Power Spectral Density (PSD).

Type 1 channel access procedure may include LBT sensing with random back-off and a variable extended Clear Channel Assessment (CCA) period based on a contention window; the contention window size may be selected based on Channel Access Priority Class (CAPC) configuration. A base station (e.g., gNB, etc.) or WTRU may perform Type 1 channel access procedure to initiate a Channel Occupancy Time (COT). Type 2A and 2B channel access may be performed when a transmission gap is 25 us and 16 us, respectively. When a transmission gap is smaller than 16 us, Type 2C channel access may be applied with an immediate transmission after the gap without performing sensing.

For initial access, NR U may use one or more Discovery Reference Signals (DRSs) containing Synchronization Signal/Physical Broadcast Channel (SSB) block burst set with an increasing number of candidate SSB positions within a DRS window. The related design may also include handling of reduced SSB blocks and Remaining Minimum System Information (RMSI) transmission opportunities due to LBT failure. Modifications to the random-access procedure may be adopted to handle reduced message 1/2/3/4 transmission opportunities due to LBT failure such as Physical Random-Access Channel (PRACH) repetition in frequency domain and extension of random-access response window. PRACH preamble formats may also be extended to meet the OCB requirement.

For DownLink (DL) transmissions, NR U may address COT structure indication, dynamic PDCCH monitoring, and/or flexible PDSCH starting positions because of the uncertainty caused by LBT. For UL control and data channel transmissions, to comply with one or more OCB requirements, new block interlaced-based transmissions may be used for PUCCH and PUSCH with flexible starting positions for PUSCH. The NR U Sounding Reference Signal (SRS) transmission may also be enhanced with additional flexibility in configuration and triggering. Additionally, NR U may support frame structure with multiple DL-to-UL and UL-to-DL switching points within a shared COT.

NR U may support additional HARQ transmission opportunities and immediate HARQ transmission for corresponding data in the same shared COT as well as the subsequent COT to ensure the channel access of HARQ transmissions.

One or more issues may arise for a WTRU operating in unlicensed spectrum.

For example, SL PHY layer structure and signal may not need to be modified in order to address parameters required with Occupied Channel Bandwidth (OCB) and Power Spectrum Density (PSD). In unlicensed spectrum, a transmission may be required to occupy at least a certain amount X %, such as 90%, of the channel bandwidth. This OCB requirement may ensure the occupancy of a channel can be detected. Also, a maximum PSD may be needed on a transmission in unlicensed spectrum to spread out the resulting interference throughout the unlicensed carrier. SL PHY layer structure and signal design may need to address these issues. For example, in one case, a SL transmission may span over one or multiple sub-channels and occupy only a part of a SL carrier. The maximum PSD within such a transmission may be significantly higher than the maximum PSD requirement. Also, a guard symbol may be used at the end of a SL slot and between PSSCH and PSFCH symbols in a SL slot (e.g., the length of the guard symbol may be more than 16 us). Transmissions from a WTRU separated by such a gap may be considered to be separate transmission bursts and a new sensing for channel access may need to be performed after the gap and thus a single-slot SL transmission may not be completed with one channel access. Additionally, a SL resource pool may comprise of logical slots that are not consecutive in time domain, and a SL transmission burst over a number of such logical slots indicated by consecutive indexed may have gaps within the transmission and thus cannot be performed in one COT.

In another example of potential issues, SL resource allocation and reservation may not be feasible in unlicensed spectrum due to regulation requirements for fair co-existence. In some cases, for unlicensed spectrum, all nodes must follow channel access procedures specified for unlicensed spectrum to enforce a fair co-existence. SL resource allocation and reservation in Mode 1 and Mode 2 may not include the LBT sensing-based channel access and therefore improved mechanisms may be needed for SL resource acquisition in unlicensed spectrum, especially considering the one or more changes in PHY layer structure and resulting granularity of resources for SL transmissions. The reservation for resources, such as for re-transmissions of an aperiodic SL TB or for transmission of another new SL TB (e.g., semi-persistent transmission), may be deterministic in SL design with the reserved future resources indicated in SL Control Information (SCI) in a PSCCH. However, in unlicensed spectrum, due to the uncertainty of the outcome of sensing and channel access, resources may not be able to be reserved in the same way as in SL and new resource reservation designs may be needed.

In another example of potential issues, there may be no centralized base station (e.g., gNB) to coordinate and schedule COT sharing in Mode 2. In NR U design, a WTRU may receive UL scheduling information that contains COT indication and sharing information, such as COT duration and channel access for COT sharing. As a central node, a base station may be able to coordinate a set of DL and UL transmissions to and from WTRUs to enable a WTRU to share a base station-initiated COT. For example, a base station may schedule a UL transmission with a timing that may be aligned with its DL transmission so the WTRU can share the COT using Type 2C channel access without performing sensing. In SL Mode 2, when a WTRU acquires and reserve resource without base station involvement, COT sharing between WTRUs may be performed by WTRUs in a distributed manner and therefore there is a need for one or more procedures to address this approach.

As discussed herein, there may be one or more approaches that address the aforementioned potential issues as well as other issues not disclosed herein.

In some cases (e.g., for time domain) a WTRU may determine SL U resources belonging to a SL U resource pool. A minimum SL U time domain allocation unit for a PSSCH/PSCCH transmission may be some unit of time, such as a slot, a mini-slot, etc. A WTRU may be (pre)configured with a unit of time configuration for a (pre)configured SL U resource pool. A unit of time configuration may include a duration of (e.g., for a mini-slot, such as 2-symbol, 5-symbol or 7-symbol). As discussed herein, although some examples herein may refer to a specific unit of time for demonstration purposes, any reference to a unit of time, such as a slot may, refer to a slot and/or a mini-slot, and/or any other unit of time as discussed herein).

A WTRU may perform a transmission of a TB in a PSSCH with an associated PSCCH within a slot. An associated PSCCH transmission may carry a 1^{st} stage of SCI (SCI-1) associated with the PSSCH transmission. A 2^{nd} stage SCI (SCI-2) may be multiplexed with PSSCH within the resource(s) allocated for the PSSCH transmission. In some instances, a WTRU may not switch between PSCCH transmission and reception within a slot. In another example, a PSCCH may carry all control information of an associated SL PSSCH transmission.

In one approach, a WTRU may be (pre)configured with all symbols for PSSCH/PSCCH transmission within a slot. A WTRU may perform a PSSCH/PSCCH transmission and associated DMRS transmission in consecutive symbols within such a PSSCH/PSCCH slot.

A WTRU may be (pre)configured with an Automatic Gain Control (AGC) symbol as the 1^{st} symbol of a slot. A WTRU may duplicate the content of the 2^{nd} symbol to the AGC symbol. The AGC symbol may enable the convergence of AGC for a PSSCH/PSCCH transmission reception. During a AGC symbol, a WTRU may adjust the RX front-end radio gain to achieve a desired baseband input power level. Due to the variation of the received incoming signal, it may take some time for gain to converge to a desired level.

A WTRU may be (pre)configured with a set of DMRS configurations for PSSCH/PSCCH transmission. Each configuration may include the indices of symbols used for DMRS transmission in a slot. A WTRU may determine a DMRS configuration and indicate the determined DMRS configuration in the SCI in the associated PSCCH transmission.

In some cases (e.g., for frequency domain) a WTRU may be (pre)configured with one or more SL U carrier(s). A WTRU may be (pre)configured with one or more SL U Bandwidth Parts (BWP(s)) within a (pre)configured SL U carrier.

A WTRU may be (pre)configured with one or more RB set(s) in a SL U BWP. Each RB set may comprise of a number of contiguous RBs and the (pre)configuration of a RB set may include the index of the start RB and the number of RBs within the RB set. Within a SL U BWP, RB sets may be indexed in increasing order. A WTRU may determine the frequency resource allocation of a RB set based on the RB set index.

A minimum SL U frequency domain allocation unit for a PSSCH/PSCCH transmission may be an RB interlace. A SL U transmission based on RB interlace(s) may meet Occupied Channel Bandwidth (OCB) requirements of the unlicensed spectrum. Over the frequency bandwidth of a RB set, a WTRU may be (pre)configured with M RB interlaces. The value of M may be associated with Subcarrier Spacing (SCS), such as 10 for 15-kHz and 5 for 30-kHz. Each RB interlace within a RB set and/or resource pool may be indicated by an index (m) where m may be an integer from 0 to M−1. RB interlace (m) may comprise of RBs of index (m, m+M, m+2×M, m+3×M, . . . , m+N×M) where N may be a (pre)configured total number of RBs of a RB interlace.

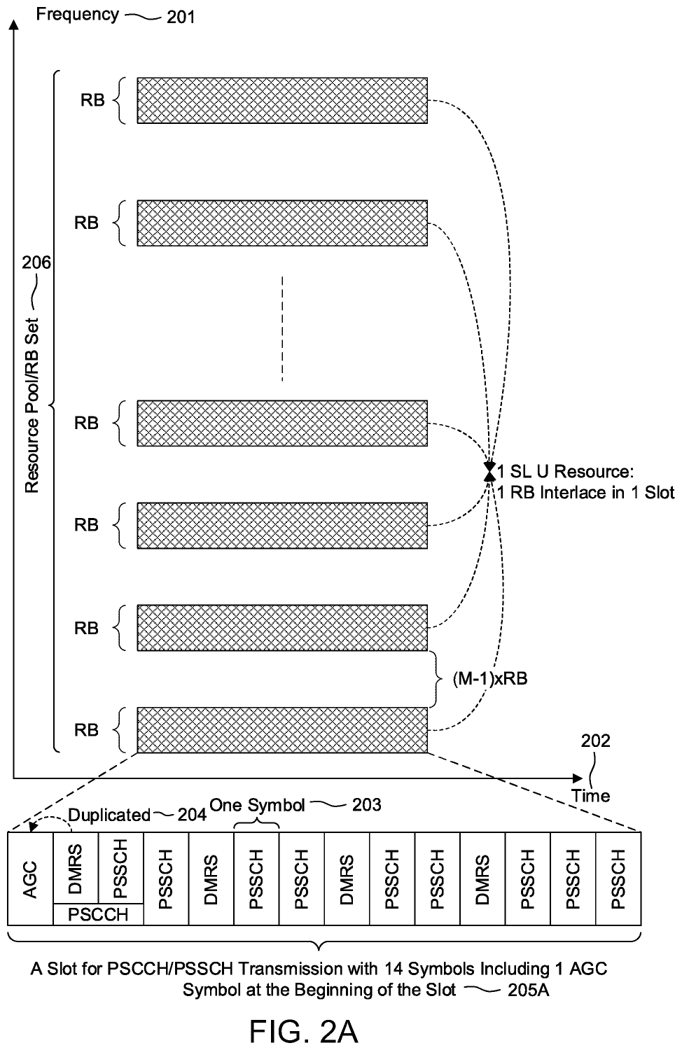

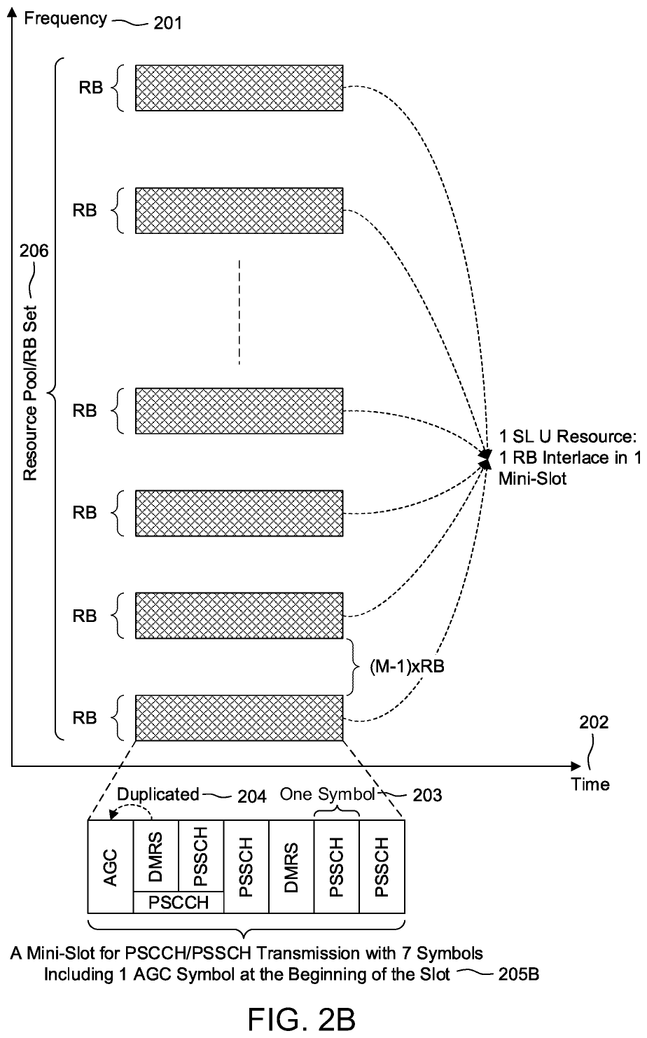

In some cases, a WTRU may determine SL U resources that belong to a resource pool. FIG. 2 may be referred to herein as referencing both FIG. 2A and FIG. 2B. FIG. 2 illustrates an example of a SL U resource that comprises a RB interlace within a time period (e.g., FIG. 2A relates to an example of a slot, and FIG. 2B relates to an example of a mini-slot).

As shown in FIG. 2A and FIG. 2B, both show a set of resource blocks, where time (202) is illustrated in the horizontal axis and frequency (201) is illustrated in the vertical axis. Underneath each graph of RBs is an example of how the RB may be used (e.g., for each symbol 203 in the RB, there may be different types of transmissions reserved or scheduled for these locations in time, such as an AGC, DMRS, PSSCH, PSCCH, etc.): At 205A, there is a slot for PSCCH/PSSCH transmission with 14 symbols including an AGC symbol at the beginning of the slot; and, at 205B there is a mini-slot for PSCCH/PSSH transmission with 7 symbols including an AGC symbol at the beginning of the slot. For illustrations purposes, a set of RBs 206 is shown in one SL U resource pool, however, there may be more than one RB set in a given pool. For illustration purposes, only one slot/mini-slot is shown, however, there may be more than one slot/mini-slot (e.g., one or more sets) in a resource pool. In one example, as shown, the AGC symbol may be used for converging (as discussed herein), so it cannot hold useful data. Accordingly, the data may be copy/duplicated at the next symbol to the AGC symbol, hence, duplicated 204.

A WTRU may be (pre)configured with one or more SL U resource pool(s). A WTRU may allocate and reserve one or more such SL resource(s) belonging to a resource pool for a SL U transmission.

The frequency domain resource allocation of such a SL U resource pool may include one or more RB sets. For a resource pool and/or a RB set, a WTRU may be (pre)configured with M RB interlaces. Each RB interlace may comprise of N RBs separated by M−1 RBs and N may be (pre)configured for a resource pool and/or a RB set.

In the time domain, a WTRU may determine a set(s) of slots that may belong to a SL resource pool based on a (pre)configured bitmap associated with the resource pool and the S-SSB transmission (pre)configuration. A WTRU may index the set of slots within a SFN or DFN cycle in an increasing order as (t₀, t₁, . . . , tₘₐₓ) where max may be the maximum index (e.g., 10240 for 15-kHz SCS, 20480 for 30-kHz SCS and 40960 for 60-kHz SCS) and to may indicate the 1^{st} slot of a radio frame corresponding to SFN 0 of the serving cell or DFN 0. The slots indexed within such a set may be denoted as physical slots, and the physical slots of the set may be consecutive in the time domain.

A WTRU may first exclude the slots (pre)configured for S-SS/PSBCH Block (S-SSB) transmission from the set. The number of such slots (N_{S-SSB}) may be determined based on the (pre)configured S-SSB parameters, such as the duration of an S-SSB transmission period, the number of S-SSB slot(s) within an S-SSB transmission period, and/or the periodicity of S-SSB transmissions.

A WTRU may determine which of the remaining (N-N_{S-SSB}) slots in the set may be assigned to a resource pool based on the bitmap configuration associated with the resource pool. The bitmap may include L bits, and a WTRU may expect that the (N-N_{S-SSB}) MOD L equals to zero. A WTRU may apply the bitmap for every L slots in the set with each bit corresponding to a slot. If the (pre)configured bit value is one, a WTRU may determine that the corresponding slot may belong to the resource pool. A WTRU may exclude the slot(s) or mini-slot(s) corresponding to a bit value of zero from the set. A WTRU may determine all the remaining slots may belong to a resource pool.

In another approach, a WTRU may determine a set of slots that may belong to a SL resource pool based on a set of (pre)configured non-SL slots, a (pre)configured bitmap associated with the resource pool, and/or the S-SSB transmission (pre)configuration.

A WTRU may exclude a set of non-SL slots from the same physical slot set. A non-SL slot may be a physical slot not available for SL transmission and/or reception, and thus, a WTRU may not include a non-SL slot in a resource pool.

In one example, a WTRU may receive a SL symbol (pre)configuration, which may include a starting symbol index and the number of symbols following the starting symbols. A WTRU may determine that a physical slot may be a SL slot when the symbols within the slot corresponding to the (pre)configuration may be an UL symbol. A WTRU may be (pre)configured to perform SL operation over UL symbols, and thus, a WTRU may determine that a physical slot may be a non-SL slot when one or more SL symbols corresponding to the SL symbol (pre)configuration may not be an UL symbol.

In another example, a WTRU may receive a SL slot (pre)configuration, which may indicate which slot may be available for SL transmission and/or reception in a carrier. Such a (pre)configuration may include a pattern of physical slots allocated to Uu (DL/UL) and SL operation. A WTRU may determine a physical slot may be a non-SL slot when the slot may be (pre)configured for Uu operation.

A WTRU may exclude the determined non-SL slots from the physical slot set and the number of such non-SL slots may be denoted as N_{non-SL}. Also, a WTRU may exclude N_{S-SSB} slots (pre)configured for S-SS/PSBCH Block (S-SSB) transmission, as discussed above.

A WTRU may determine which of the remaining (N−N_{S-SSB}−N_{non-SL}) slots in the set may be assigned to a resource pool based on the bitmap configuration associated with the resource pool. The bitmap may include L bits and a WTRU may further exclude N_{reserved} slots from the slot set where N_{reserved} may equal to (N−N_{S-SSB}−N_{non-SL}) MOD L. A WTRU may apply the bitmap for every L slots in the set with each bit corresponding to a slot. If the (pre)configured bit value is one, a WTRU may determine the corresponding physical slot may belong to the resource pool. A WTRU may exclude the physical slots corresponding to a bit value of zero from the set.

A WTRU may determine all the remaining physical slots may belong to a resource pool (pre)configured with the associated bitmap. A WTRU may re-index consecutively the determined slots of the resource pool in an increasing order as (T₀, T₁, . . . , Tₘₐₓ) where Tₘₐₓ may equal to tₘₐₓ−N_{S-SSB}−N_{non-SL}−N_{reserved}. A WTRU may apply these re-indexed slots of a resource pool as logical slots.

In some cases, a WTRU may determine time consecutiveness of logical slots in a resource pool.

In one example, a WTRU may determine that a resource pool may include all available physical slots when one or more of the following conditions are met: all slots may be (pre)configure for SL operation in a carrier (N_{non-SL}=0); SSB transmission may not be (pre)configured (N_{S-SSB}=0); the value of each bit in the (pre)configured bitmap associated with the resource pool may equal to one (N_{non-allocated}=0), such as all slots allocated to the associated resource pool; and/or, (N−N_{S-SSB}−N_{non-SL}) MOD L may equal to zero (Nᵣₑₛₑᵣᵥ=0).

Alternatively, a WTRU may be (pre)configured with a resource pool including all available physical slots. When a resource pool includes all available physical slots, a logical slot may correspond to a physical slot denoted with the same index, such as tᵢ=Tᵢ (i from 0 to tₘₐₓ). The logical slots of such a resource pool may be consecutive in the time domain.

In another example, a WTRU may determine a resource pool that may include a subset of all available physical slots when one or more of the following physical slots are excluded from the resource pool: A physical slot in which one or more (pre)configured SL symbols are not an UL symbol according to (pre)configured DL/UL TDD configuration (N_{non-SL}>0); A physical slot in which SSB transmission(s) are (pre)configured (N_{S-SSB}>0); A physical slot for which the value of the corresponding bit in the (pre)configured bitmap associated with the resource pool may be equal to zero (N_{non-allocated}>0), such as a physical slot not allocated to the associated resource pool; and/or, A physical slot identified as a reserved slot, where a WTRU may determine Nᵣₑₛₑᵣᵥ slots, where Nᵣₑₛₑᵣᵥ=(N−N_{S-SSB}−N_{non-SL}) MOD L and (Nᵣₑₛₑᵣᵥ>0), to be excluded from the resource pool to ensure the indexes of logical slots of a resource pool may repeat in each SFN/DFN cycle.

In such a resource pool, a logical slot may not correspond to a physical slot with the same index and the set of determined logical slots of a resource pool may not be consecutive in the time domain. In this case, a WTRU may determine a mapping between indexes of logical slots of a resource pool and indexes of the corresponding physical slots. A WTRU may determine whether any two logical slots of a resource pool with consecutive indexes may be consecutive in the time domain.

In another case, a WTRU may not re-index the logical slots included in a resource pool and denote the logical slots of a resource pool with the index of its corresponding physical slot. In this case, a WTRU may determine whether two logical slots may be time consecutive based on the consecutiveness of the indexes of the slots.

In some cases, a WTRU may send/receive a PSSCH transmission and an associated PSCCH transmission. A WTRU may perform transmission of a PSSCH and associated PSCCH in one or more RB interlace(s) within a slot. A WTRU may indicate the RB interlace assignment of a PSSCH in a bit field of “Frequency resource assignment” in the SCI in the associated PSCCH transmission. The indication may include one or more RB interlace index(s) and/or a RB set index.

A WTRU may be (pre)configured with a number of symbols within a slot for PSCCH transmission, as shown in the examples of FIG. 2. For instance, the 2^{nd} and 3^{rd} symbols of a slot may be (pre)configured for PSCCH transmission for a resource pool. In addition, a WTRU may transmit a PSCCH transmission in (pre)configured PSCCH RBs in the (pre)configured PSCCH symbols. In one example, a WTRU may transmit a PSCCH transmission in the (pre)configured RBs starting from the lowest RBs of a RB interlace with the lowest RB interlace index when one or more RB interlaces are assigned for a PSSCH/PSCCH transmission.

A WTRU may perform a SL transmission burst in an initiated or shared COT in a resource pool. A SL transmission burst may comprise of PSSCH/PSCCH transmissions over consecutive logical and/or physical slots of the applied resource pool in time domain with one PSSCH/PSCCH transmission in each slot.

In some cases, a WTRU may be in a particular mode (e.g., Mode 2), and there may be one or more procedures for determining a SL U channel access and resource selection. In some cases, the SL U channel access and/or resource selection may be based on LBT and/or SCI sensing. A WTRU may perform LBT sensing to determine the availability of a SL U channel before transmission(s) on the SL U channel. A SL U channel may refer to a resource pool and/or a RB set (pre)configured for SL transmission in shared spectrum. A WTRU may perform LBT sensing over a bandwidth identical to the bandwidth of a SL U resource pool and/or a RB set and within a LBT sensing slot with a duration of Tₛₗ=9 us, for example.

A WTRU may perform SL U channel access and resource selection procedure to determine whether or not the WTRU may transmit in the sensed SL U channel, and which resource(s) to select and/or reserve for SL transmission(s). Generally, in order to reserve something for SL transmission, a WTRU may send a reservation signal, transmission, and/or message for the purposes of indicating to other devices that this WTRU is attempting to reserve the channel for use. In one instance, one type of reservation signal may be a cyclic prefix extension (CPE), and a CPE and reservation signal may be interchangeable as disclosed herein. In another instance, a reservation transmission may be any type of message disclosed herein (e.g., SCI, control information, reservation message, reservation signal, channel occupancy information, window information, etc.). In one instance, a reservation signal may be transmitted continuously, one time only per desired period, periodically, and/or intermittently, as required by the given situation to reserve the channel. A WTRU may perform one or more SL transmissions within a Channel Occupancy Time (COT) upon success of a SL U channel access and resource selection procedure.

A WTRU may perform SL U channel access and resource selection procedure for COT initiation to initiate a COT. A WTRU may perform one or more SL contiguous transmissions from the beginning of an initiated COT. A SL U channel access and resource selection procedure for COT initiation may include LBT sensing-based channel access for COT initiation and SCI sensing-based channel access and resource selection for COT initiation. For example, a LBT sensing-based channel access for COT initiation may be based on Type 1 channel access.

A WTRU may perform transmission(s) in a COT initiated by another WTRU, such as sharing a COT, when the gap between the two WTRUs' transmissions is up to a threshold (e.g., 25 us). A WTRU may perform SL transmission(s) in a set of determined slots and/or mini-slots within a shared COT. A WTRU may perform a SL U channel access and resource selection procedure for COT sharing to share a detected and on-going COT. A SL U channel access and resource selection procedure for COT sharing may include a LBT sensing-based channel access for COT sharing and SCI sensing-based channel access and resource selection for COT sharing.

For one or more techniques disclosed herein, there may be a determination of a SL U LBT energy detection threshold (EDT). A WTRU may perform Type 1 and/or Type 2 LBT sensing based on power detection (e.g., RSSI measurement) performed in a sensing slot with a (pre)configured duration (e.g., of 9 us). A WTRU may determine whether a channel is available during a sensing slot when the detected power (e.g., measured RSSI), is less than an energy detection threshold (EDT) for at least a specified amount of time (e.g., 4 us) within the sensing slot duration (e.g., of 9 us). Otherwise, a WTRU may determine the channel is busy during the sensing slot. It is recognized that a low EDT may make it more difficult to acquire a channel, but the acquired channel would have less interference (e.g., due to collision) compared to a high EDT. Considering the distributed manner of channel access by SL WTRUs, it may be beneficial to allow a WTRU to adjust EDT under real-time conditions so that a WTRU is able to acquire a channel more easily when the channel congestion level, and by association the collision risk, is low.

In one approach, a WTRU may determine a default EDT for a LBT procedure based on one or more of the following: (pre)configured EDT (e.g., maximum EDT (pre)configured by a higher layer); EDT level required by regulation (e.g., an explicit level in dBm); (pre)configured channel access type (e.g., a dynamic channel access, such as Load Based Equipment (LBE), or semi-static channel access, such as Frame Based Equipment (FBE)); (pre)configured SL U maximum transmit power in the LBT channel; and/or, (pre)configured LBT bandwidth.

A WTRU may dynamically determine an EDT for an upcoming LBT procedure based on the default EDT and one or more of the following: Channel congestion level (e.g., SL CBR, CO and/or RSSI); Type of the channel to transmit (e.g., PSSCH/PSCCH or PSFCH); Priority of the SL TB(s) to transmit; Remaining PDB of the SL TB(s) to transmit; Remaining duration of the resource selection window of the SL TB(s) to transmit; Received HARQ feedback status associated with transmissions performed in the LBT channel; Received SL CSI reporting (e.g., a CQI measurement); and/or, Type 1 LBT (COT initiation) or Type 2 (COT sharing).

A WTRU may increase the default EDT by a (pre)configured offset (e.g., X dBm) when one or more of the following conditions occur: channel congestion level (e.g., SL CBR, CO and/or RSSI) measured in the channel is below a (pre)configured threshold; remaining PDB and/or remaining duration of the resource selection window of the SL TB(s) to transmit is below a (pre)configured threshold; the number of HARQ ACK received from the transmissions performed in the channel may exceed a (pre)configured threshold; the number of reported SL CSI (e.g., a CQI measurement) above a (pre)configured threshold may exceed a (pre)configured threshold; and/or, a WTRU performs a Type 2 LBT for COT sharing for PSSCH/PSCCH and/or PSFCH transmission.

A WTRU may decrease the default EDT by a (pre)configured offset (e.g., X dBm) when one or more of the following conditions occur: Channel congestion level (e.g., SL CBR, CO and/or RSSI) measured in the channel exceeds a (pre)configured threshold; the priority of the TB to transmit is higher than a (pre)configured threshold; the number of HARQ NACK received from the transmissions performed in the channel may exceed a (pre)configured threshold; the number of reported SL CSI (e.g., a CQI) measurement below a (pre)configured threshold may exceed a (pre)configured threshold; and/or, a WTRU performs a Type 1 LBT for COT initiation for PSFCH transmission.

In some cases, a WTRU may perform SCI decoding for SCI sensing. A WTRU may monitor for PSCCH transmission in each slot belonging to one or more (pre)configured resource pool(s) except for those in which the WTRU performs transmission(s). A WTRU may perform blind decoding in the (pre)configured PSCCH resources, such as the lowest RBs of each RB interlace (pre)configured for the resource pool and/or RB set in each monitored slot. The number of such blind decoding(s) may depend on the number of RB interlaces (pre)configured for each resource pool and/or RB set, the number of RB set(s) (pre)configured for a resource pool, and/or the number of (pre)configured resource pools for the SCI monitoring.

When a WTRU successfully decodes SCI in a slot (t), a WTRU may receive information from the corresponding bit fields included in the decoded SCI.

In an example, a WTRU may decode and receive SCI information associated with the TB carried in the PSSCH transmission. A level of (e.g., L1) priority assigned to the TB, cast type of the TB, and/or Source ID and Destination ID. The cast type of the TB may be indicated as unicast, groupcast, or broadcast.

In an example, a WTRU may decode and receive SCI information associated with the COT in which the decoded SCI is transmitted (e.g., a current COT), such as remaining COT duration, MCOT duration, COT starting slot index, COT initiation/sharing indication, COT sharing for PSSCH/PSCCH indication, COT sharing for PFSCH indication, and/or channel congestion indication.

The remaining COT duration may be the remaining time of the COT used between the slot in which the SCI is decoded and the end of the COT. The unit of such remaining COT duration indication may in a unit of time (e.g., ms) and/or number of slots. For example, a remaining COT duration of 5 slots indicated in the SCI received in slot (t) may indicate the current COT may include contiguous slots from slot (t+1) to slot (t+5). In one example, the unit of the remaining COT duration may be a logical slot of the resource pool used for the PSSCH/PSCCH transmission carrying the decoded SCI. In another example, a physical slot may be applied to indicate the time duration. A WTRU may determine the number of logical slots or time (e.g., ms) remaining in this COT with respect to the maximum COT. In one case, based on this indicator and the remaining transmission indicator in SCI, a WTRU may determine the period of time and/or number of logical slots within the COT that may not be scheduled for transmissions and thus may be applied for COT sharing. In one example, the value may be indicated using Time Resource Indication Value (TRIV).

For MCOT duration, a WTRU may determine the maximum COT duration of an on-going COT based on this SCI indication. The maximum COT value indicated in this SCI field may be determined by an initiating WTRU for a COT corresponding to a CAPC configuration of the performed Type 1 LBT procedure.

For COT starting slot index, a WTRU may determine the logical slot index of the first slot of a COT. In another instance, when a WTRU decodes a SCI within a COT, the WTRU may determine the period of time and/or number of logical slots within the COT based on the indicated COT starting slot index and the MCOT duration indicated in the same SCI.

For COT initiation/sharing indication, a WTRU may determine the received SCI may be transmitted by a WTRU initiating the COT when this SCI indicator indicates COT initiation. A WTRU may further identify the initiating WTRU by the WTRU source and/or destination ID indicated in the same SCI. Similarly, a WTRU may determine the received SCI may be transmitted by a WTRU sharing the COT when this SCI indicator indicates COT sharing. A WTRU may further identify the sharing WTRU by the WTRU source and/or destination ID indicated in the same SCI. In one example, one value may correspond to COT initiation (e.g., 0) and the value may be incremented by each WTRU sharing the COT (e.g., 1 may indicate the 1st WTRU sharing the COT and 2 the 2nd WTRU sharing the COT, and so on). A WTRU may determine the number of WTRUs sharing the current COT based on this indication. A WTRU may determine not to share a COT when the number of WTRU(s)s sharing the COT may exceed a (pre)configured threshold.

COT sharing for PSSCH/PSCCH indication may indicate whether the current COT may be sharable, for example, and may be shared by another WTRU to perform PSSCH/PSCCH transmission(s) within the COT. When a sharable COT is indicated, a WTRU may perform SL U channel access and resource selection procedure for COT sharing to perform PSSCH/PSCCH transmission(s) in the current COT.

COT sharing for PSFCH indication may indicate whether one or more PSFCH(s) carrying HARQ feedback corresponding to one or more PSSCH/PSCCH transmission(s) within the current COT may be transmitted within the COT. When a sharable COT for PSFCH is indicated, a WTRU may perform SL U channel access and resource selection procedure for COT sharing to perform PSFCH transmission(s) in the current COT.

Channel congestion indication may be an indication of the congestion status of the SL U channel. In one example, a binary channel congestion indication may be (pre)configured and a value of one may indicate a congested channel and a value of zero may indicate a channel may not be congested.

Indication of SL slots for sharing within a COT may be an indication of which SL slots in the COT may be shared. In one example, a TRIV may be used to indicate a logical slot offset, such as a number of logical slots between the SL slot including the SCI indication and the SL slot indicated for sharing. In another example, the logical slot index of the SL slot for sharing may be indicated.

In an example, a WTRU may decode and receive one or more of the following SCI information associated with the resource allocation of the PSSCH/PSCCH transmission(s) performed within the current COT, such as remaining transmission duration, and/or frequency resource assignment(s) of PSCCH transmission(s).

The remaining transmission duration may be the number of contiguous slot(s) scheduled for PSCCH/PSSCH transmission(s) in the remaining COT duration. For example, a Time Resource Indication Value (TRIV) may be used to indicate the number of remaining scheduled slot(s). A TRIV of x in the SCI received in slot (t) may indicate the WTRU transmitting the decoded SCI may continue PSCCH/PSSCH transmissions in the next x contiguous slots from slot (t+1) to slot (t+x). In one example, the slot applied in this indication may be a logical slot of the resource pool used for the PSSCH/PSCCH transmission carrying the decoded SCI, such as x contiguous slots may be x contiguous logical slots. In another example, a physical slot may be applied. In one example, the value may be indicated using TRIV.

Frequency resource assignment(s) of PSSCH(s) may be the RB interlace index(s) and/or RB set index(s) of the PSSCH transmission(s) performed within the current COT. In one example, a WTRU may perform transmissions of a TB and/or different TBs within a COT using identical frequency resource assignments. A WTRU may indicate a Frequency Resource Indication Value (FRIV) value based on the frequency resource assignment, such as the index of an assigned starting RB interlace and a number of RB interlace(s) and/or RB set assigned for a PSSCH transmission, in the SCI associated with each PSSCH transmission scheduled within the COT. In this example, the FRIV value may be computed based on the starting RB interlace and the number of RB interlace(s) used for the PSSCH transmission in each slot within the COT. In another example, a WTRU may perform transmissions of a TB and/or different TBs within a COT using different frequency resource assignments (e.g., different RB interlace indices in one resource pool and/or a RB set). In this example, a WTRU may indicate a Frequency Resource Indication Value (FRIV) in the SCI transmitted in slot (t) computed based on the frequency resource assignment of the PSSCH transmission(s) in each of the contiguous slot(s) from (t) to (t+a) where a may be a (pre)configured value for a resource pool. For example, with a=2, a FRIV value indicated in the SCI transmitted in slot (t) may be computed based on the starting RB interlace and number of RB interlace(s) of PSSCH transmissions in slot (t), slot (t+1) and slot (t+2).

In an example, a WTRU may decode and receive SCI information associated with a reservation of COT and/or resource for transmission(s) by the WTRU transmitting the decoded SCI, such as COT/resource reservation interval, and/or COT/resource reservation window. Such a reservation by a WTRU may indicate the WTRU may perform a channel access and resource selection for COT initiation to initiate a COT after the reservation interval or within the duration of the reservation window. A WTRU performing channel access based on such decoded SCI information may exclude the slots associated with the reserved COT and/or reservation window from its SL U channel access and resource selection procedure for COT initiation.

COT and/or resource reservation interval may be a time period in unit of ms or number of slots between the current COT and/or resource(s) indicated in the decoded SCI and a reserved COT and/or resources for transmission(s) for another TB(s) by the same WTRU. The range of the reservation interval may be (pre)configured in a resource pool and a WTRU may determine the length of the interval based on the traffic periodicity of a SL service and/or application. A WTRU may reserve the same frequency resource(s) within the reserved COT as the ones used in the current COT. A WTRU may reserve a COT of the same length as that of the current COT. For example, the reserved COT length may be determined based on the association with an L1 priority indicated for the TB(s) transmitted in the current COT. In another example, a reservation window may be (pre)configured with association with the length of the reserved COT. In another example, a reservation window associated with the indicated COT and/or resource reservation interval may be indicated in the same SCI. A WTRU may perform a channel access and resource selection to initiate such a reserved COT within the (pre)configured window. In one example, the unit of COT and/or resource reservation interval may be a logical slot of the resource pool used for the PSSCH/PSCCH transmission carrying the decoded SCI. In another example, a physical slot may be applied to indicate this interval time. In one example, the value may be indicated using TRIV.

COT and/or resource reservation window may be a time period in unit of ms or number of slots following the end of the current COT indicated in the decoded SCI. The length of the window may be (pre)configured in a resource pool. In one example, a WTRU may determine the length of the window based on the remaining packet delay budget (PDB) of a TB transmitted in the current COT. In one example, the unit of COT and/or resource reservation window may be a logical slot of the resource pool used for the PSSCH/PSCCH transmission carrying the decoded SCI. In another example, a physical slot may be applied to indicate this window length. In one example, the value may be indicated using TRIV.

In an example, a WTRU may decode and receive SCI information associated with a HARQ process of the PSSCH/PSCCH transmission in slot (t), such as a HARQ process number, and/or HARQ feedback enabled/disabled indication. A HARQ process number may be a new data indicator and/or a redundancy version. A HARQ feedback enabled/disabled indication may be an indication of whether HARQ feedback is enabled and a PSFCH carrying the HARQ ACK/NACK is expected for the PSSCH/PSCCH transmission.

In an example, a WTRU may decode and receive SCI information associated with a transmission configuration of the PSSCH/PSCCH transmission in slot (t), such as transmission configuration including a number of DMRS port, DMRS pattern, MCS value and/or MCS table indication.

In an example, a WTRU may decode and receive SCI information associated with SCI-2 transmission multiplexed with PSSCH transmission in slot (t), such as an indication of the SCI-2 format and Beta Offset value.

In an example, a WTRU may decode and receive one or more of the following SCI information associated with the WTRU geographic location and range requirement of the transmitted TB in slot (t): zone ID of the WTRU; and/or, index corresponding to a (pre)configured minimum communication range (MCR) requirement in unit of meters.

In an example, a WTRU may decode and receive one or more of the following SCI information that is associated with the synchronization source of the WTRU performing the received PSSCH transmission in slot (t): based on the indication of the synchronization source, a WTRU may determine that the received transmissions in a COT are performed by a WTRU who synchronizes with GNSS, gNB, SyncRef WTRU, or an internal WTRU clock; and/or, a WTRU may determine the SLSS ID of the SL synchronization signal of the indicated SyncRef WTRU.

In some cases, a WTRU may perform SCI decoding within a detected SL COT. When a WTRU decodes a SCI in a slot (t) and detects a COT indicated in the SCI, the WTRU may determine one or more COT-specific PSCCH resource(s) within which the WTRU may perform SCI decoding during the remaining duration of the detected COT. A COT-specific PSCCH resource may comprise of: a number of (pre)configured symbols in each slot included in the detected COT; and/or, a number of (pre)configured RBs in one or more RB interlaces scheduled for PSSCH transmission within the detected COT.

In one example, a WTRU may determine one or more COT-specific PSCCH resource(s) based on the time (TRIV) and frequency (FRIV) resource assignment indicated in a decoded SCI. A WTRU may determine the RB interlace including PSCCH RBs based on the PSSCH interlace indexed indicated in FRIV. A WTRU may switch from blind decoding in each RB interlace (pre)configured in a resource pool to performing a COT-specific SCI decoding in the determined COT-specific PSCCH resource(s) for the remaining duration of the detected COT. A WTRU may switch back to blind decoding of SCI after the end of the detected COT.

In another example, a WTRU may determine to stop SCI decoding for the remaining COT duration indicated in the decoded SCI when the WTRU source and/or destination ID indicated in the same SCI may not be (pre)configured by higher layers. In this case, a WTRU may not be (pre)configured to receive the TB(s) transmitted within the detected COT. A WTRU may enter an inactive state when SL DRX may be (pre)configured and enabled. A WTRU may determine an inactive state of micro sleep, light sleep, and/or deep sleep based on length of the remaining duration of the detected COT. A WTRU may wake up and resume SCI decoding (e.g., blind decoding) in the first SL slot after the end of the detected COT.

In some cases, there may be a SL U channel access and resource selection procedure(s) for COT sharing. In some cases, the WTRU may perform SCI sensing for the access and resource selection. A WTRU may be triggered by higher layers to perform a SL U channel access and resource selection for COT sharing in a slot (n) for transmission(s) of one or more TB(s). A WTRU may perform SCI sensing for the triggered SL U channel access and resource selection for COT sharing as discussed herein.

A WTRU may be provided with one or more of the following information by higher layers for the SCI sensing: the resource pool and/or RB set(s) applicable to the SL channel and resource selection determination, such as an index indicating the resource pool and/or RB set; the priority of the TB(s) (Priority_{TX}), where a WTRU may determine this priority to be the highest priority of TBs (e.g., the lowest L1 priority value) when the SCI sensing may be triggered for transmissions of different TBs; a number of RB interlaces to be used for the PSSCH/PSCCH transmission carrying the TB in one slot (L_{RB_interface}); a remaining packet delay budget (PDB), where a WTRU may determine the value of this remaining PDB to be the smallest remaining PDB of TBs when the SCI sensing may be triggered for transmissions of different TBs; and/or, a COT and/or resource reservation interval (P_{rsvp_TX}) when the traffic type of the TB(s) is periodic and the COT and/or resource reservation for another TB is enabled in the (pre)configuration of the indicated resource pool and/or RB set.

A WTRU may determine a resource selection window (RSW), such as a time interval between slot (n+T₁) and (n+T₂). A WTRU may determine T₂ based on the indicated remaining PDB (e.g., T₂ may be equal to the indicated remaining PDB value). A WTRU may determine T₁ based on a processing time (e.g., T_{process,1} may be (pre)configured for the indicated resource pool and/or RB set). The (pre)configured processing time may indicate a time period for a WTRU to process decoded SCI(s) and measured RSRP(s) within a SCI sensing window. In one example, a WTRU may determine a T₁ value based on its capability with T_{process,1} as the upper limit.

A WTRU may determine a number (N_{TX}) of transmission(s), including initial transmission(s) and re-transmission(s) to be performed within the determined RSW. The determination may be based on the QoS requirement of the TB(s), such as the priority, reliability, and/or latency. A WTRU may determine the corresponding total number (N_{r_total}) of SL U resources within the RSW, for example N_{r_total} equal to N_{TX}. In another example, N_{r_total} may be equal to N_{TX} times the number of RB interlaces of a transmission. A WTRU may determine the number of RB interlaces for a transmission based on MCS and RB interlace configuration of the resource pool. Each SL U resource available for a transmission may comprise of the indicated number of RB interlaces in one slot and may be referred to as a candidate resource herein.

A WTRU may perform SCI sensing for SL U channel access and resource selection for COT sharing in each slot (i) starting from slot (n) until the determined N_{TX} transmissions may be performed within the RSW. When the number of performed transmissions with the RSW is less than the determined N_{TX}, a WTRU may perform SCI sensing for a SL U channel access and resource selection for COT sharing in each slot (i) starting from slot (n) until slot (n+T₂−T_{proc,1}).

A WTRU may determine a SCI sensing window, such as a time interval between slot (i−T₀) and (i−T_{proc,0}) for each slot (i). A WTRU may be (pre)configured with T₀ values for the indicated resource pool and/or RB set. For example, when the reservation of a COT and/or resource for another TB is enabled in the (pre)configuration of a resource pool, a WTRU may be (pre)configured with a T₀ values corresponding to the maximum length of (pre)configured reservation intervals. When reservation of a COT and/or resource for another TB is disabled in the (pre)configuration of a resource pool, a WTRU may be (pre)configured with a T₀ values corresponding to the maximum value of (pre)configured COT lengths. A WTRU may be (pre)configured with a T_{proc,0} value for a resource pool associated with the SCS, such as 1 slot for 15-kHz SCS.

A WTRU may monitor SCI in PSCCH in slots belonging to the indicated resource pool within the determined sensing window except for those in which the WTRU performs transmission(s). A WTRU may perform blind decoding in the (pre)configured lowest RBs of each RB interlace (pre)configured for the indicated resource pool and/or RB set within each monitored slot. When a WTRU successfully decodes a SCI in a slot in a SCI sensing window, a WTRU may measure the RSRP of the DMRS associated with the detected PSSCH/PSCCH transmission. A WTRU may process decoded SCI and measured RSRP data based on SCI sensing from a SCI sensing window between slot (i−T₀) and (i−T_{proc,0}).

In some cases, a WTRU may determine COT sharing based on SCI sensing. A WTRU may be triggered by higher layers to perform a SL U channel access and resource selection for COT sharing in a slot (n) for transmission(s) of one or more TB(s). A WTRU may perform SCI sensing to determine whether a WTRU may perform COT sharing for the transmission(s) of the TB(s).

A WTRU may determine whether to perform a COT sharing in a slot (t) for each slot within the RSW based on SCI sensing information, for example in slot (t−T_{proc,1}). A WTRU may detect a COT in slot (t) when the WTRU determines a remaining COT duration (e.g., TRIV) indicated in a SCI decoded in the sensing window (e.g., that includes slot (t)). The detected COT may be referred to as a current COT herein.

A WTRU may determine the number (N_{r_COT}) of available candidate resources for COT sharing within the current COT based on one or more of the following SCI sensing information: remaining COT duration (T_{remaining_COT}); remaining transmission duration (T_{remaining_TX}); frequency resource assignment(s) of PSSCH transmissions within scheduled in the current COT, such as index(es) of RB interlace(s) and/or RB set(s); and/or, candidate resource, such as, L_{RB_interface} RB interlaces in one slot, for the TB(s) to transmit.

A WTRU may determine the last slot of the current COT may be slot (t+T_{remaining_COT}) and the number of slots (N_{slot_no_tx}) without transmission between slot (t) and slot (t+T_{remaining_COT}) may be (T_{remaining_COT}−T_{remaining_TX}). For example, if the remaining COT duration and remaining transmission duration indicated for slot (t) is 5 and 2 slots respectively, a WTRU may determine the number of slots without scheduled transmissions in the current COT will be 3 slots.

A WTRU may determine the number (N_{r_COT}) of available candidate resource(s) for COT sharing within the current COT. This number may be the sum of one or more of the number of available candidate resource(s) in the determined slots without transmission within the current COT, and/or the number of available candidate resource(s) in the slots scheduled for transmission(s) within the current COT. For example, there may be just one COT called the shared current COT, and there may be two types of slots within the shared current COT: the 1st type are the slots un-occupied by the transmissions by the WTRU who initiates the COT and the 2nd type are the slots occupied by the transmissions by the WTRU who initiates the COT. In the unoccupied slots, the number of resources may be equal to a number of interlaces per slot multiplied by the number of unoccupied slots, and in the occupied slots the number of resources may depend on how many interlaces are occupied by the WTRU who initiates the COT, so the number may be calculated based on the number of unused interlaces multiplied by the number of occupied slots; the total resources may be the sum of the numbers of these two types.

For the number of available candidate resource(s) in the determined slots without transmission within the current COT, a WTRU may determine such a number to be N_{slot_no_tx}×floor (M/L_{RB_interface}) where N_{slot_no_tx} may be the number of slots without transmission in the current COT, M may be the (pre)configured number of RB interlaces of the indicated resource pool and/or RB set and floor (M/L_{RB_interface}) may be the number of available candidate resources in each such slot.

For the number of available candidate resource(s) in the slots scheduled for transmission(s) within the current COT, a WTRU may determine such a number to be T_{remaining_TX}×floor ((M−N_{assigned_interface})/L_{RB_interface}) where T_{remaining_TX} is the number of slots with a scheduled transmission in the current COT, M is the (pre)configured number of RB interlaces of the indicated resource pool and/or RB set, N_{assigned_interface} is the number of assigned/occupied RB interlaces and floor ((M−N_{assigned_interface})/L_{RB_interface}) is the number of available candidate resources in each of such slot.

In SCI sensing, a WTRU may also determine whether a current COT may overlap with a reserved COT and/or resource(s) based on the decoded SCI information associated with a reservation of COT and/or resource for transmission(s). Such SCI information may include COT and/or resource reservation interval (e.g., for a semi-persistent reservation) and COT and/or resource reservation window (e.g., for a re-transmission reservation). A WTRU may determine one or more slot(s) within the RSW included in such COT and/or resource reservation. A WTRU may determine that a current COT may overlap with such a reserved COT and/or resource(s) when the slot(s) are included in the current COT. A WTRU may associate a L1 priority (e.g., the L1 priority indicated in the SCI from which the COT and/or resource reservation may be decoded) and a measured RSRP value (e.g., measured on DMRS of the PSCCH and/or PSSCH transmission including the SCI from which the COT and/or resource reservation may be decoded) with a determined overlapping.

A WTRU may determine whether to share the current COT based on one or more of the following information: COT sharing enabled/disabled (pre)configured in the resource pool; COT sharing for PSSCH/PSCCH indication associated with the current COT, such as the indication included in the SCI in which the current COT information may be decoded; Number of determined available candidate resource(s) for COT sharing (N_{r_COT}); Channel congestion indication associated with the current COT, such as the indication included in the SCI in which the current COT information may be decoded; L1 priority (Priority_{COT}), cast type, WTRU Source and/or Destination ID of the TB(s) transmitted in the current COT; L1 priority (Priority_{TX}), cast type, WTRU Source and/or Destination ID of the TB(s) to transmit by the WTRU; Determined overlapping between the current COT and a reserved COT and/or resource and associated L1 priority (Priorityᵣₑₛᵥ) and RSRP value; Distance to the WTRU who may have initiated the current COT; Measured RSRP of the PSCCH DMRS and/or PSSCH DMRS associated with SCI carrying the information of the current COT; Measured congestion level (e.g., SL U CBR and RSSI); the cast type of the PSSCH/PSCCH transmissions within a COT by the WTRU initiating the COT; WTRU source and/or destination ID of the WTRU initiating the COT; a COT initiation and/or sharing indication in SCI; and/or, an indication of SL slots for sharing within a COT.

A WTRU may determine whether to share the current COT based on one or more conditions.

In an example, a WTRU may determine to share the current COT when COT sharing is (pre)configured as enabled in the indicated resource pool.

In an example, a WTRU may determine to share the current COT when COT sharing indication indicates the current COT may be shared.

In an example, a WTRU may determine to share the current COT when L1 priority of the TB(s) to transmit (Priority_{TX}) is higher than a threshold (pre)configured for the resource pool. In another example, such a threshold may be associated with channel congestion status with a higher threshold value for a congested channel (e.g., when the channel congestion indication associated with current COT may be one). A WTRU may determine the threshold corresponding to the value of channel congestion indication associated with the current COT. The association may prioritize WTRUs with TBs of high priorities in COT sharing.

In an example, a WTRU may determine to share the current COT when L1 priority of the TB(s) to transmit (Priority_{TX}) may be equal to or higher than L1 priority (Priority_{COT}) associated with the TB(s) transmitted in the current COT.

In an example, a WTRU may determine to share the current COT when one or more conditions may be met (e.g., both): a COT initiation is indicated in the SCI decoded in the current COT; and/or, the priority value of the TB to transmit in the COT (Priority_{TX}) is lower than or equal to the priority value indicated in the SCI decoded in the current COT (Priority_{COT}), such as the priority of the TB to transmit is higher than or equal to the priority of TB transmitted in the COT. Since the priority indicated in the COT by the initiating WTRU is used to set the LBT and resource selection parameters to acquire and initiate a COT, it may not be fair for other non-3GPP systems in the unlicensed spectrum that another WTRU may share the COT to transmit TBs with a lower priority.

In an example, a WTRU may determine to share the current COT when the cast type of the TB(s) transmitted in the current COT is unicast and the pair of WTRU Source and Destination ID of the unicast transmission and the pair of WTRU Source and Destination ID of the TB(s) to transmit is associated with a same unicast SL (e.g., a WTRU may share the current COT for TB(s) associated with the same unicast link). When two WTRUs establish a unicast SL between each other, each WTRU may be (pre)configured with a pair of unidirectional WTRU Source and Destination ID associated for transmission(s) of the unicast SL. The two WTRUs may exchange the WTRU Source and Destination ID information via RRC connection establishment and/or configuration signaling so each WTRU may associate the two pairs of WTRU Source and Destination ID with the same unicast SL.

In an example, a WTRU may determine to share the current COT when the WTRU who initiates the COT is a peer WTRU that has a unicast link (pre)configured between the initiating WTRU and the WTRU that shares the COT. Each WTRU may indicate a pair of WTRU IDs in the SCI of PSSCH/PSCCH transmissions to the peer WTRU for the unicast link traffic as discussed herein. Accordingly, when COT initiation is indicated in the SCI, a WTRU may determine the initiating WTRU may be the peer WTRU of a (pre)configured unicast link when the pair of source and destination WTRU IDs indicated in the same SCI is (pre)configured for the unicast link. In one case, a WTRU may share a COT initiated by a peer WTRU of a (pre)configured unicast link and perform PSSCH/PSCCH transmissions to the peer WTRU (e.g., initiating WTRU) for the traffic associated with the unicast link. In this case, the COT sharing may be exclusively applied to the traffic of a unicast link carried in SL transmissions between the two WTRUs (pre)configured for the unicast link. In another case, a WTRU may share a COT initiated by a peer WTRU of a (pre)configured unicast link and perform PSCCH/PSCCH transmissions for traffic associated with unicast, groupcast, and/or broadcast link operated by the WTRU.

In an example, a WTRU may determine to share the current COT when the cast type of the TB(s) transmitted in the current COT is groupcast and the WTRU Destination ID of the groupcast transmission is the same as the WTRU Destination ID of the TB(s) to transmit, such as a WTRU may share the current COT with transmission(s) of TB(s) associated with the same groupcast SL.

In an example, a WTRU may determine to share the current COT when the cast type of the TB(s) transmitted in the current COT is broadcast and the WTRU Destination ID of the broadcast transmission is the same as the WTRU Destination ID of the TB(s) to transmit, such as a WTRU may share the current COT with transmission(s) of TB(s) associated with the same broadcast SL.

In an example, a WTRU may determine not to share a COT when the SCI decoded in the current COT indicates COT sharing, such as the COT may be already shared by another WTRU. In this case, a COT initiated by a WTRU may be shared by no more than one WTRU. However, in a groupcast and/or broadcast transmission, it may be beneficial that multiple WTRUs share a COT for SL traffic associated with the same groupcast and/or broadcast link. Thus, in another case, a WTRU may determine to share a COT when the SCI decoded in the current COT indicates COT sharing and the WTRU is a member of the group indicated by the WTRU destination ID in the SCI decoded in the current COT. A WTRU may share the COT and perform transmissions of TB(s) associated with the same WTRU destination ID indicated in the SCI received in the COT, such as the traffic belonging to the same groupcast and/or broadcast link.

In an example, a COT sharing by one or more WTRUs, such as discussed herein, may be enabled or disabled by a (pre)configuration of a resource pool. In addition, when such sharing is enabled, there may be a maximum number of sharing WTRUs (pre)configured in the resource pool. When a WTRU detects a sharable WTRU and determines the value of the COT sharing indication is below the (pre)configured maximum number of sharing WTRU for a COT, a WTRU may determine to share the COT. Otherwise, a WTRU may determine not to share the COT.

A WTRU may determine to share a COT when the synchronization source indicated in SCI(s) decoded in the current sharable COT is identical to and/or belongs to the same (pre)configured synchronization source group with its own synchronization source. In another example, when both the indicated and its own synchronization sources are SyncRef WTRU, a WTRU may determine to share a COT when the indicated SLSS ID is also identical to that of its own SyncRef WTRU, such as the initiating WTRU and the sharing WTRU of the COT may synchronize with the same SyncRef WTRU. A WTRU may determine not to share the COT when the SLSS IDs are different.

In an example, a WTRU may determine to share the current COT when the number of determined available candidate resource(s) for COT sharing (N_{r_COT}) are equal to or larger than a (pre)configured threshold. In one example, the value of such a threshold may be associated with the L1 priority of the TB(s) to transmit with large threshold values corresponding to high L1 priority. In another example, the value of such a threshold may also be associated with the channel congestion status, with large values corresponding to a channel congestion indication of one. A WTRU may determine such a threshold corresponding to the L1 priority of the TB(s) to transmit and/or the value of channel congestion indication associated with the current COT. When such a (pre)configured is not present or the (pre)configure value is zero, a WTRU may determine to share the current COT without consideration of the number of determined available candidate resource(s) for COT sharing.

In an example, a WTRU may determine not to share the current COT when the determined available candidate resource(s) overlap with one reserved COT and/or resource, and the RSRP associated with the overlapping (e.g., determined in SCI sensing) is higher than a (pre)configured threshold. In one example, the value of such a threshold may be determined based on the L1 priority associated with the overlapping (Priorityᵣₑₛᵥ) and the L1 priority of the TB(s) to transmit (Priority_{TX}). In another example, the value of such a threshold may be associated with channel congestion. A WTRU may determine the RSRP threshold corresponding to Priorityᵣₑₛᵥ, Priority_{TX} and channel congestion indicated in the SCI of the current COT. This may ensure a WTRU with TBs with higher priorities share the same current COT specifically in a congested channel.

In an example, a WTRU may determine to share the current COT when the distance between itself and the WTRU that initiates the current COT is below a (pre)configured threshold. A WTRU may determine such a distance (e.g., in unit of meters) based on its own location information, such as GNSS geographic coordinates and/or the zone ID indicated in the SCI carrying the information of the current COT. In one example, a (pre)configured threshold may be the MCR requirement indicated in the SCI carrying the information of the current COT.

In an example, a WTRU may determine to share the current COT when the RSRP measured on PSCCH DMRS and/or PSSCH DMRS associated with the SCI carrying the information of the current COT is higher than a (pre)configured threshold. In one example, such a threshold may be (pre)configured to be associated with L1 priority of the TB(s) to transmit (Priority_{TX}) and/or L1 priority (Priority_{COT}) associated with the TB(s) transmitted in the current COT. A lower threshold may be associated with higher priority of the TB(s) to transmit (Priority_{TX}) so that a WTRU with TB(s) with higher priority may be prioritized to share a current COT.

In an example, a WTRU may determine to share the current COT when the measured congestion level is below a (pre)configured threshold. A WTRU may determine such a congestion level based on one or more (pre)configured measurements performed in LBT sensing and/or SCI sensing. The measurements may include: RSSI measured in a sensing slot, RSSI measured in a SL slot, RSRP measured on PSCCH DMRS, PSSCH DMRS associated with a decoded SCI, and/or the number of slots in which a LBT sensing result of the channel may be busy, etc. A WTRU may perform such a congestion level measurement within a (pre)configured SL U channel congestion measurement window. The channel congestion level based on the measurement may be expressed as a ratio of the number of slots in which the measured values (e.g., RSSI or number of busy sensing slots) exceeds a (pre)configured level to the total number of measured sensing and/or SL slots in a resource pool. In one example, the (pre)configured threshold is associated with L1 priority of the TB(s) to transmit (Priority_{TX}) and/or L1 priority (Priority_{COT}) associated with the TB(s) transmitted in the current COT. A higher threshold may be associated with a higher priority of the TB(s) to transmit (Priority_{TX}) so at a given congestion level a WTRU with TB(s) with higher priority may be allowed to share a current COT. A WTRU may determine to share the current COT when the indication of SL slots sharing in the COT is present.

In some cases, a WTRU may select resources within a shared COT. When a WTRU determines to perform COT sharing, the WTRU may determine the available candidate resource(s) within the current COT to use for transmission of the TB(s) based on one or more factors, such as: the determined total number of resource(s) for the transmission of the TB(s) (N_{r_total}); the determined available candidate resource(s) in the shared current COT (N_{r_COT}); L1 priority (Prio_{TX}) of the TB(s) to transmit.

A WTRU may be (pre)configured with a maximum number of available candidate resource(s) for COT sharing in a resource pool (N_{r_max}) and a WTRU may determine the number of resources to use (N_{r_share}) to be N_{r_share}=N_{r_max}. In another example, such a value may be associated with L1 priority. A WTRU may determine a N_{r_max} based on the (pre)configured association and the L1 priority (Priority_{TX}) of the TB(s) to transmit. The maximum resource determination may allow the current COT to be shared among WTRUs.

In another approach, a WTRU may be (pre)configured with a ratio (P %) relative to the determined available candidate resource(s) for COT sharing (N_{r_COT}). A WTRU may determine the number of resources to use (N_{r_share}) in the current COT to be N_{r_share}=N_{r_COT}×P %. The value of P may be associated with L1 priority and a WTRU may determine the value of P based on L1 priority (Priority_{TX}) of the TB(s) to transmit. In another example, the value of P may be associated with channel congestion status. A WTRU may determine the value of P based on L1 priority (Priority_{TX}) of the TB(s) to transmit and/or the channel congestion indication associated with the current COT. More resources may thus be selected when a channel is not congested.

When a WTRU is not (pre)configured with such N_{r_max} and/or P ratio, a WTRU may determine to use all determined available candidate resource(s) in the shared current COT, N_{r_share}=N_{r_COT}. When the determined N_{r_share} is larger than or equal to the determined total number of resource(s) for the transmission of the TB(s) (N_{r_share}>=N_{r_total}), a WTRU may determine the number of N_{r_share}=N_{r_total}. In this case, a WTRU may complete the determined transmission(s) of the TBs in the shared current COT.

A WTRU may index the N_{r_COT} determined available candidate resource(s) for COT sharing in an ascending order in terms of RB interlace index and slot index. For example, a WTRU may index available candidate resource(s) first in a slot in the order of ascending RB interlace indexes and then continue the indexing to candidate resource(s) in the next slot until the last slot for sharing in the current COT. A WTRU may denote each available candidate resource(s) with such an index as rⱼ where the index j may be an integer in (0,1, N_{r_COT}−1).

A WTRU may select N_{r_share} available candidate resource(s) for the transmission(s) of the TBs from the N_{r_COT} such resources as discussed herein. A WTRU may determine to have one or more available candidate resource(s) in each slot of the shared current COT that may not include a scheduled transmission.

A WTRU may determine which N_{r_share} available candidate resource(s) to use for transmission(s) of the TB(s) based on one or more of the following: random selection; WTRU source, and/or destination ID; slot index; cast type; and/or, (pre)configured resource patterns.

A WTRU may randomly select N_{r_share} indexes from the range of (0,1, N_{r_COT}−1) and determine to use available candidate resource(s) denoted by the selected indices. A WTRU may determine N_{r_share} indexes based on cast type and numeric value of associated WTRU Source and/or Destination ID. In one example, for a unicast transmission, a WTRU may determine a random selection initialization seed based on WTRU Source ID and/or WTRU Destination ID. In addition, a WTRU may also include slot index in the initialization of the seed. In another example, for a groupcast transmission, a WTRU may determine a random selection initialization seed based on WTRU Destination ID and/or a (pre)configured group member ID. For a broadcast transmission, a WTRU may determine a random selection initialization seed based on WTRU Destination ID.

A WTRU may be (pre)configured with a set of available candidate resource patterns. For example, a WTRU may select the first group of consecutive N_{r_share} available candidate resources whose indexes are denoted by (r₀, r₁, r_{Nr_sharing}). When N_{r_share}=N_{r_total}, a WTRU may perform all transmissions of the TB(s) within the first consecutive available candidate resources within the shared current COT.

In another example, a WTRU may select a group of consecutive N_{r_tx_sharing} available candidate resources whose indexes are denoted by (r_{offset}, r_{offset+1}, r_{offset+Nr_sharing}). A WTRU may determine the available candidate resource group offset value based on the WTRU Source and/or Destination ID for a unicast transmission and WTRU Destination ID. A WTRU may determine the available candidate resource group offset value based on the WTRU Destination ID and/or a (pre)configured groupcast member ID for a groupcast transmission. A WTRU may determine the available candidate resource group offset value based on the WTRU Destination ID for a broadcast transmission. For example, a WTRU may determine such an offset by performing a modular function using the numeric value of the said WTRU ID(s) and/or groupcast member ID and the number of available candidate resource group, which may equal to floor (N_{r_COT}/N_{r_share}).

In another approach, a WTRU determines the frequency resource for a PSSCH/PSCCH transmission to share a COT based on a WTRU source and/or destination ID. The frequency resource may include one or more RB, RB interlace, sub-channel, and/or RB set. A WTRU may be (pre)configured with a set of such frequency resources, each denoted by an index. A WTRU may perform a modulo operation of the total number of the resources and numeric version of the WTRU source and/or destination ID to determine the index of the starting frequency resource of the PSSCH/PSCCH transmission. In another example, a WTRU may select the frequency resource(s) based on resource group and/or COT reservation information. A WTRU may exclude the reserved frequency resources from the (pre)configured frequency resource set before performing a selection based on the WTRU IDs as discussed above.

In some cases, there may be frequency-multiplexing-based COT sharing COT, where a frequency-multiplexing-based COT sharing scheme may be (pre)configured as Enabled or Disabled in a resource pool. When the scheme is (pre)configured as Disabled in a resource pool, a WTRU may share a COT by performing SL transmissions in the remaining unused SL slots (e.g., without scheduled transmissions) of a shared COT after a Type 2 LBT procedure as described herein. When the scheme is (pre)configured as Enabled in a resource pool, a WTRU may share a COT by performing SL transmissions both in the remaining unused slots (e.g., as discussed herein) and using available RB interlaces in the SL slots with existing SL transmissions.

A WTRU may determine the number of the unused slots in a COT to be shared based on received SCI indications including remaining COT duration, remaining scheduled transmissions, maximum COT duration, and/or logical slot index of the starting slot of the sharing COT.

A WTRU may determine one or more available RB interlaces in a SL slot with existing SL transmissions in a shared COT based on the frequency assignment in the SCI of the PSSCH/PSCCH transmissions within the COT. In one case, a WTRU may randomly select one or more available RB interlaces for a SL transmission multiplexed with an existing SL transmission (e.g., by the initiating WTRU) in a shared COT.

In another case, a WTRU may determine which of the available RB interlaces to use for the transmissions to share the COT based on the synchronization source indicated in the SCI decoded in the COT. In one example, a WTRU may apply any available RB interlaces for SL transmission when the indicated synchronization source is identical (e.g., GNSS, same gNB and/or same SyncRef WTRU) to and/or belongs to the same (pre)configured synchronization source group with its own synchronization source. A common synchronization source may mitigate the inter-RB interference between transmission(s) from different WTRUs multiplexed frequency domain.

When the indicated synchronization source is different than and/or does not belong to the same (pre)configured synchronization source group with its own synchronization source, a WTRU may not perform frequency-multiplexing-based COT sharing. In this case, a WTRU may select one or more RB interlaces for transmissions among the available RB interlaces based on a muting (pre)configuration. In one example, a WTRU may mute (e.g., does not select and transmit in) a RB interlace adjacent to the ones used for the SL transmissions in the COT (e.g., by the initiating WTRU).

Further, when a WTRU determines to perform such a frequency-multiplexing-based COT sharing, it may determine a maximum power of its SL transmission multiplexed with existing SL transmission in a SL slot based on: Measured power level (e.g., RSSI) of the existing SL transmission in the SL slot in the shared COT; and/or, Power Spectrum Density (PSD) requirement imposed by regulation in the channel (e.g., maximum of P₀ dBm/MHz).

A WTRU may determine the maximum power of the SL slot is the maximum PSD specified in the regulation P=P₀ (dBm/MHz)×total transmission bandwidth (MHz), where the total transmission bandwidth may be the LBT BW. A WTRU may determine the maximum power for the SL transmissions to perform in the same slot as P−P_{measured} where P_{measured} may be the power level measured in the SL slot.

In one approach, a sharing WTRU may share a current COT by performing PSSCH/PSCCH transmission(s) in the slots including PSSCH/PSCCH transmission(s) by the WTRU initiating the current COT. The initiating WTRU may indicate a gap for Type 2 LBT in the SCI of each PSSCH/PSCCH transmission. In another example, a WTRU may be (pre)configured with such a gap in the end of the PSSCH/PSCCH transmission.

A sharing WTRU may determine the frequency resources scheduled for the PSSCH/PSCCH transmission(s) by the initiating WTRU based on the frequency assignment information in the decoded SCI. A sharing WTRU may select a frequency resource, such as a set of RBs, RB interlaces, and/or sub-channels for PSSCH/PSCCH transmission(s). In one example, a sharing WTRU may determine such a frequency resource allocation by excluding the decoded frequency resources from the (pre)configured resource pool and selecting a frequency resource among the remaining frequency resources based on the WTRU source and/or destination ID.

A WTRU may perform a Type 2 LBT, such as Type 2B LBT in the indicated or (pre)configured gap. When the channel is available, a WTRU may perform PSSCH/PSCCH transmission using the determined frequency resources in the slots including PSSCH/PSCCH transmission by the initiating WTRU. When the channel is not available, the physical layer may indicate a LBT failure to higher layers.

In some cases, a WTRU may send PSSCH/PSCCH transmission in a shared current COT. A WTRU may send PSSCH/PSCCH transmission(s) of one or more TB(s) in the determined N_{r_share} available candidate resource(s) within the shared current COT. A WTRU may perform LBT sensing for SL U channel access and resource selection when there are gap(s) within the PSSCH/PSCCH transmission(s) performed for COT sharing. A WTRU may determine to perform a LBT sensing (e.g., a Type 2A LBT channel access as discussed herein) following such a gap of 25 us. A WTRU may determine to perform a LBT sensing (e.g., a Type 2B LBT channel access as discussed herein) following such a gap of 16 us. A WTRU may determine to perform a LBT sensing (e.g., a Type 2C LBT channel access as discussed herein) following such a gap smaller than 16 us. A WTRU may perform LBT sensing over a bandwidth of the resource pool and/or RB set indicated for the SCI sensing.

In some cases, a WTRU may select a Type 2 LBT procedure for COT sharing. A WTRU may enable sharing of a COT, that is initiated and/or shared by the WTRU based on one or more scenarios (e.g., where the WTRU performs an action).

In one example scenario, a WTRU may set the value of COT sharing for PSSCH/PSCCH indication in the SCI of the PSSCH/PSCCH transmissions in the COT as “Enabled” when the COT is to be shared by another WTRU's PSCCH/PSSCH transmissions.

In one example scenario, a WTRU may set the value of COT sharing for PSFCH indication in the SCI of the PSSCH/PSCCH transmissions in the COT as “Enabled” when the COT is to be shared by another WTRU's PSFCH transmission.

In one example scenario, a WTRU may not transmit in a (pre)configured Type 2 LBT occasion (e.g., a gap period) at the end of the last PSCCH/PSSCH transmission scheduled in a COT (e.g., an end-of-COT gap). A WTRU may perform rate matching for the shortened PSSCH/PSCCH transmission in the last PSCCH/PSSSCH slot. In one example, such a gap may be (pre)configured as one symbol, such as in a SL slot of 14 symbols, the last PSCCH/PSSCH transmission may occupy 13 symbols in a COT and the last symbol may be empty.

A WTRU that detects a sharable current COT may perform a Type 2 LBT procedure at the beginning of the Type 2 LBT occasion to acquire the channel before sharing the COT. A Type 2 LBT procedure may include Type 2A, Type 2B, and/or a Type 2C LBT procedure.

When performing a Type 2A LBT procedure, a WTRU may transmit immediately after sensing the channel to be available for a sensing period of 25 us. Within the sensing period, a WTRU may perform LBT sensing over two sensing slots of 9 us and when the channel is available in both sensing slots, the WTRU may determine the channel to be available.

When performing a Type 2B LBT procedure, a WTRU may perform transmission immediately after sensing the channel to be available for a sensing period of 16 us. A WTRU may perform LBT in one sensing slot of 9 us and when the channel is sensed to be available for a total of at least 5 us with at least 4 us within the sensing slot, the WTRU may determine the channel to be available.

When performing a Type 2C LBT procedure, a WTRU may perform transmission without performing sensing. The duration of such a transmission without sensing may be at most 584 us.

When a WTRU performs a Type 2A or Type 2B LBT to acquire a channel to share a COT, the WTRU may transmit until the end of the maximum duration (MCOT) of the shared COT. A WTRU may determine this information based on the SCI indications including the remaining COT duration, MCOT, and/or logical slot index of the starting slot of the COT received in the COT. A WTRU may stop transmission in a sharing COT at the end of the MCOT duration of the shared COT.

When a WTRU performs a Type 2C LBT to acquire a channel to share a COT, the WTRU may perform SL transmissions within a duration of the minimum between 584 us and the remaining COT duration until the end of the maximum duration (e.g., MCOT).

In one approach, a WTRU may determine a Type 2 LBT occasion within a COT based on one or more SCI indications received in the COT, such as a remaining scheduled transmission duration, a remaining COT duration, and/or an index of the logical slot of the COT. At the beginning of Type 2 LBT occasion in a detected sharable COT, a WTRU may perform one of the Type 2 LBT procedures described herein. A WTRU may determine which Type 2 LBT procedure (e.g., 2A, 2B or 2C) to perform based on one or more of the following before sharing a COT: L1 priority of the TB(s) to transmit (Priority_{TX}) in the shared COT; L1 priority (Priority_{COT}) associated with the TB(s) transmitted in the current COT; Remaining PDB of the TB(s) to transmit in the shared COT; Duration of the transmissions of the TB(s) in the shared COT; Remaining duration of the resource selection window of the TB(s) to transmit in the shared COT; Cast type of the TB(s) to transmit in the shared COT; Type of SL channel to share the COT (e.g., PSFCH or PSSCH/PSCCH transmission); Measured channel congestion level (e.g., SL CBR, CO, RSSI); Channel congestion indication in the SCI transmitted by the initiating WTRU in the COT; Measured RSRP of PSCCH and/or PSSCH received in the COT; and/or, Distance between the initiating and sharing WTRU.

A WTRU may perform Type 2C LBT procedure when the priority (Priority_{TX}) associated with its transmission may be higher than a (pre)configured threshold and the transmission duration may be less than 584 us (e.g., a PSSCH/PSCCH transmission using 60-kHz SCS over one SL slot). In another case, a WTRU may perform Type 2C LBT procedure when the remaining PDB of the TB(s) and/or the remaining duration of the resource selection window may be less than a (pre)configured threshold and the transmission duration may be less than 584 us.

A WTRU may perform Type 2C LBT procedure when the WTRU transmits one or more PSFCHs in a shared COT.

When a SL transmission duration exceeds 485 us, a WTRU may determine whether to use a Type 2B or Type 2A LBT procedure. In one case, a WTRU may be (pre)configured to perform a Type 2A LBT for unicast and/or groupcast transmission and Type 2B LBT for broadcast transmissions.

In one case, a WTRU may determine to perform Type 2A LBT if the priority of the TB (Priority_{TX}) is higher than or equal to a (pre)configured threshold and Type 2B LBT otherwise. In another case, a WTRU may perform Type 2B LBT procedure if the remaining PDB of the TB(s) is less than or equal to a (pre)configured threshold and Type 2A LBT procedure otherwise.

In another case, there may be two criteria, such as when the channel congestion level is higher than or equal to a (pre)configure threshold (e.g., first criteria), and when the priority of the TB (Priority_{TX}) is higher than or equal to a (pre)configured threshold (e.g., second criteria) a WTRU may determine to perform a Type 2A LBT procedure (e.g., in a busy channel for a high priority TB, longer LBT is applied). A WTRU may determine to perform a Type 2B LBT procedure otherwise if one or both criteria are not met. When the channel is busy, a WTRU may perform longer sensing to reduce collision for high-priority TBs.

When the channel congestion level is below a (pre)configured threshold, a WTRU may determine to perform a Type 2B LBT procedure when the priority of the TB (Priority_{TX}) is higher than or equal to a (pre)configured threshold. A WTRU may determine to perform a Type 2A LBT procedure when the priority is lower than the threshold. When the channel is not busy, a WTRU may perform shorter sensing for high-priority TBs to acquire the channel faster.

A WTRU may determine the channel congestion level based on the measurement of SL CBR, CO, and/or RSSI of the channel (pre)configured for the LBT. In another example, a WTRU may determine the information based on the congestion level indicated in the COT by the initiating WTRU.

In one example, the (pre)configured priority threshold applied in Type 2 LBT determination discussed above may be based on the priority (Priority_{COT}) associated with the TB(s) transmitted in the current COT.

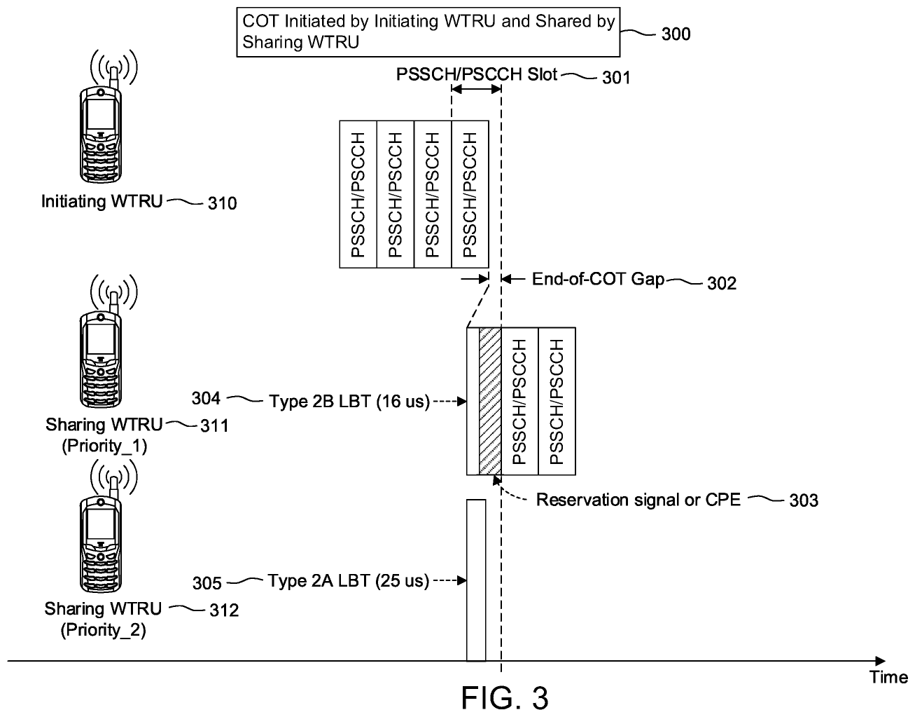

FIG. 3 illustrates an example of sharing WTRU determination of Type 2 LBT for COT sharing. As shown, there may be an initiating WTRU 310, a sharing WTRU 311 with priority 1, and a sharing WTRU 312 with priority 2. Time is shown on the horizontal axis, however, frequency is not intended to be shown in the vertical axis. As shown, a WTRU 310 may initiate a COT, which then may be shared by WTRU 311 and 312. In one instance, since the transmissions of one WTRU will not overlap in time, each WTRU can use the same, partially the same (i.e., overlap), or different frequency resource(s).

Since Type 2B LBT procedure takes less time to acquire a channel when the channel is available, the priority-based Type 2 LBT selection may enable a WTRU with a TB of high priority to more easily share a COT when multiple WTRUs attempt to share the COT. This can apply to a low congestion scenario where collision is not a concern. As shown in the example of FIG. 3, both WTRU 311 and WTRU 312 may detect an on-going sharable COT (e.g., initiated by WTRU 310) and perform Type 2 LBT at the same Type 2 LBT occasion. WTRU 311 may perform a Type 2B LBT because the priority (Priority_1) may be higher than a threshold and associated with Type 2B LBT and a measured CBR is below a (pre)configured threshold (e.g., where CBR is a SL measurement of a resource pool; it is an indication of congestion in the channel). WTRU 312 may perform a Type 2A LBT because the priority (Priority_2) of its TB(s) may be lower than a threshold and associated with Type 2A LBT (e.g., the measured CBR is also below the threshold). WTRU 311 with transmissions of TB(s) with a higher priority may share the COT with WTRU 310 and WTRU 312 may detect a busy channel due to WTRU 311 transmissions, and continue to gain channel access (e.g., repeating one or more procedures referenced herein). In one case, WTRU 311 may transmit a reservation signal 303, such as a Cyclic Prefix Extension (CPE), at the end of the COT so that it can begin transmission of its higher priority TB(S).

In a further example, a WTRU may determine to perform Type 2A LBT if the distance between the WTRU and the intended target WTRU of the transmission may be higher than or equal to a (pre)configured threshold and Type 2B LBT otherwise.

In another example, a WTRU that shares a COT may perform a Type 2 LBT procedure based on the Type 2 channel access information indicated in the SCI of the PSSCH/PSCCH transmissions in a COT. In this case, a WTRU that initiates and/or shares a COT may indicate the following information in the SCI of the PSSCH/PSCCH transmissions in the COT: the value of COT sharing for PSSCH/PSCCH indication as “Enabled” when the COT is to be shared by another WTRU's PSCCH/PSSCH transmissions; the value of COT sharing for PSFCH indication as “Enabled” when the COT is to be shared by another WTRU's PSFCH transmission; the start of a period for Type 2 LBT procedure (e.g., logical slot index, symbol index with a slot, a (pre)configured Type 2 LBT occasion, etc.); the Type (2A, 2B or 2C) of Type 2 LBT to perform for sharing the COT; the length of the gap reserved for Type 2 LBT preceding the start of transmission to share the COT; the indication of SL slots available for sharing in the COT; and/or COT time, such as an MCOT, remaining COT duration, and/or COT starting slot index.

In some cases, a WTRU may perform a transmission of a channel reservation signal and/or a CPE following the end of the last PSCCH/PSSCH transmission scheduled in a COT (e.g., as in example of FIG. 3). In some instances, a WTRU may not perform a PSSCH/PSSCH transmission in the last symbol of the last SL slot scheduled in a COT. A WTRU may, instead, transmit a channel reservation signal and/or a CPE from the start of the last symbol to hold the initiated and/or shared COT. A WTRU may leave a gap of length X us between the end of the channel reservation signal and/or CPE transmission and the end of the last symbol. In one example, the value of X may be explicitly indicated in a SCI bit field with log 2(maximum(X)) bits where maximum (X) is the maximum gap length (e.g., one symbol). In another example, the gap length may be indicated with an index in the SCI bit field. A set of indices may be (pre)configured to indicate, for example, a gap length of below 16 us, 16 us, larger than 16 us and smaller than 25 us, and/or equal to or larger than 25 us.

A WTRU that shares an initiated and/or shared COT may determine to perform a Type 2 LBT channel access according to the gap length indicated in the received SCI in the COT. For example: a WTRU may perform a Type 2C LBT channel access when the indicated gap length is below 16 us; a WTRU may perform a Type 2B LBT channel access when the indicated gap length is 16 us.

A WTRU may perform a Type 2B LBT channel access when the indicated gap length is larger than 16 us and smaller than 25 us. A WTRU may randomly select a 16-us period within the gap to perform a Type 2B LBT. In another approach, a WTRU may select a start time Type 2B LBT based on the priority of the TB to transmit in the shared COT. For example, when the priority is higher than a (pre)configured threshold, a WTRU may perform Type 2B LBT within the first 16 us period of the gap. Otherwise, a WTRU may perform Type 2B LBT within the last 16-us period of the gap.

In one case, a WTRU may be (pre)configured with a Type 2X (e.g., Type 2A, 2B, or 2C) LBT channel access when the indicated gap length is larger than 16 us and smaller than 25 us. With Type 2X LBT channel access, a WTRU may perform a SL transmission after sensing the channel to be idle within the duration equal to the length of the gap indicated in the SCI received in the COT. The Type 2X LBT duration may include a sensing slot (e.g., at the end of the duration).

A WTRU may perform a transmission of a reservation signal and/or CPE between the end of a Type 2 LBT channel access (e.g., Type 2A LBT) and the start of PSSCH/PSCCH transmission to share a COT. In one case, the WTRU may determine the duration of the channel reservation signal and/or CPE based on the priority of the TB to transmit in the shared COT.

In one example, a reservation signal and/or CPE may have a duration (T_{Reserve/CPE}) of an integer (N_{Reserv/CPE}) number of (pre)configured time units (Tᵤₙᵢₜ), Such as T_{Reserve/CPE}=N_{Reserv/CPE}×Tᵤₙᵢₜ. The time unit may be a LBT sensing slots (T_{SL}), a LBT contention period (T_{contention}), 16 us and/or 25 us. Each SL priority may be (pre)configured with a corresponding N_{Reserv/CPE} value. The higher priority (lower priority value) may be associated with a larger N_{Reserv/CPE} value.

A WTRU (e.g., that wants to share a COT) may determine the start of the PSSCH/PSCCH transmission (e.g., the boundary of first SL slot of the shared COT (t_{sharing-start})) to share a COT based, at least in part, on one or more of the SCI indications including MCOT, remaining COT duration, starting slot index, indication of SL slots for sharing, and/or something similar disclosed herein. A WTRU may determine the start of Type 2 LBT channel access (e.g., Type 2A LBT) based, at least in part, on the determined start of the PSSCH/PSCCH transmission (t_{sharing-start}) and/or the duration of the channel reservation signal and/or CPE (T_{Reserve/CPE}). For example, the start of Type 2A LBT channel access may be at (t_{sharing-start}−T_{Reserve/CPE}−25).

Thus, when multiple WTRUs attempt to share a detected COT starting from the same SL slot, a WTRU with TB(s) of higher priority may perform a longer channel reservation signal and/or CPE transmission and accordingly start a Type 2 LBT channel access earlier in the gap. The resulting channel reservation signal and/or CPE transmission may cause Type 2 LBT channel access failure of another WTRU with TB(s) of lower priority (e.g., see example of FIG. 3).

In another example, a WTRU may be (pre)configured with a set of Type 2 LBT procedures in addition to other Type 2A/2B/2C procedures (e.g., as discussed herein). Each Type 2 LTB may include N sensing slots and a WTRU may determine a channel to be available before performing COT sharing. The number (N) may be associated with a priority of the TB to transmit in the shared COT and/or channel congestion level (e.g., CBR, Channel Occupancy (CO), and/or RSSI). In one example, when the congestion level exceeds a (pre)configured threshold, a WTRU may determine a large number (N) of sensing slots for high-priority TB(s). When the congestion level is below a (pre)configured threshold, a WTRU may determine a small number (N) of sensing slots for high-priority TB(s).

In an example, a WTRU may determine not to perform a PSSCH/PSCCH transmission(s) of one or more TB(s) within the shared current COT when a WTRU determines an absence of SL transmission in the SL slot immediately preceding the 1^{st} SL slot to share the COT, such as the last SL slot of a remaining transmission indicated in the current share COT. A WTRU may determine such an absence of transmission when a WTRU does not detect a SCI in the SCI decoding in the said SL slot (e.g., the slot immediately preceding the 1^{st} SL slot to share the COT). For this example, an absence of a SL transmission does not necessarily mean the absence of any transmission, but rather an absence of a transmission where a SCI cannot be decoded (e.g., a non-3GPP transmission for example), so sharing would not be possible. For instance, the WTRU may only share a COT when the proceeding transmission is a SL transmission. In another example, a WTRU may determine such an absence of transmission when a WTRU may measure a RSSI level lower than a (pre)configured threshold in the LBT sensing in the said SL slot.

In some cases, a WTRU sharing a COT may perform non-contiguous transmissions within the COT. A WTRU may determine to share the COT based on the SCI indications and/or conditions disclosed herein. For the first transmission over one or more symbols or one or more consecutive SL slots, a WTRU may perform a Type 2 LBT channel access and transmission of a channel reservation signal and/or CPE based on the SCI indication or priority of the TB(s) to transmit in the COT. The first transmission may, for example, be a PSFCH and/or PSSCH. The second transmission will depend on the availability of the spectrum, and may have one or more approaches.

If the first transmission ends before the end of a sharable COT length, a WTRU may perform a second transmission and continue sharing the COT when the following conditions are met: a WTRU may determine the channel may be available until the start of the second transmission, and the WTRU may perform LBT sensing immediately after the first transmission and determine a channel availability based on the LBT result over this period (e.g., a WTRU may perform LBT in each sensing slot and determine the channel is available when the results of all sensing slots indicate the channel is idle, such as the measured RSSI is below a (pre)configured threshold); and/or, a WTRU may further perform a Type 2 LBT channel access (e.g. a Type 2A LBT channel access) and determine the channel may be available immediately before the second transmission. A WTRU may determine the sharable COT length (e.g., number of sharable slots in a COT) based on one or more of the following: Maximum COT (MCOT) associated with the priority as indicated in CAPC configuration; Remaining scheduled transmission duration and/or remaining COT; COT starting slot index; and/or, indication of the shared slots.

If either of these conditions are met, then the second transmission may occur. However, if these conditions are not met, a WTRU may not perform the second transmission and stop the COT sharing. If the second transmission is not sent, a WTRU may perform a Type 1 LBT channel access to initiate another COT for the transmission of TB(s) that would have been carried in the never-sent second transmission.

In this approach of COT sharing for non-contiguous transmission, no channel reservation signal and/or CPE transmissions may be performed between the first and second transmissions. A WTRU sharing a COT with a first transmission may continue with a second transmission to share the COT if the channel is sensed to be available within the COT.

For each PSSCH/PSCCH transmission performed in the shared current COT, a WTRU may indicate one or more pieces of SCI information in the PSCCH on the shared current COT, transmitted TB, transmission configuration, or the like.

The one or more pieces of SCI information may include L1 priority, cast type, WTRU Source ID and/or Destination ID of the TB(s) transmitted in PSSCH.

The one or more pieces of SCI information may include the remaining COT duration, which may be the remaining time of the COT between the slot in which the SCI is transmitted and the end of the shared current COT.

The one or more pieces of SCI information may include MCOT duration, where the maximum COT corresponding to the configuration used for the Type 1 LBT performed to initiate the current COT may be indicated by the initiating WTRU. It may be in the units of ms or logical SL slot. A sharing WTRU may duplicate (e.g., resend) this information in its transmissions within the shared COT.

The one or more pieces of SCI information may include COT starting slot index, where an initiating WTRU may indicate the logical slot index of the 1st slot of a COT. When a WTRU decodes a SCI within a COT, the WTRU may determine the number of remaining slots available for SL transmissions within the COT based on the indicated starting slot index and the MCOT duration. A sharing WTRU may duplicate this information in its transmissions within the shared COT.

The one or more pieces of SCI information may include COT sharing for PSSCH/PSCCH indication, where the value of this indication may be Enabled, which may be the same as the indication associated with the current shared COT.

The one or more pieces of SCI information may include COT sharing for PSFCH indication, which may be an indication of Enabled/Disabled according to PSFCH resource configuration (pre)configured for the resource pool when HARQ feedback is enabled for the TB transmitted in the PSSCH(s). When HARQ feedback is disabled for the TB transmitted in the PSSCH, the indication may be Disabled.

The one or more pieces of SCI information may include COT initiation/sharing indication. A WTRU that shares a COT may indicate a value corresponding to COT sharing (e.g., a value of one), in this SCI field of all transmissions performed to share a COT. In another example, when multiple WTRUs sharing a COT is enabled (e.g., in a resource pool (pre)configuration), a sharing WTRU may increment the value in this field to indicate the number of WTRUs sharing this COT.

The one or more pieces of SCI information may include channel congestion indication, where the value of this indication may be the same as the value indicated in the SCI associated with the shared current COT.

The one or more pieces of SCI information may include remaining transmission duration, which may be the number of contiguous slot(s) scheduled for PSCCH/PSSCH transmission(s) in the remaining the shared current COT duration, for example indicated in a TRIV.

The one or more pieces of SCI information may include frequency resource assignment(s) of PSSCH(s), which may be the RB interlace index(s) and/or RB set index(s) of the PSSCH transmission(s) performed within the shared current COT, for example indicated in a Frequency Resource Indication Value (FRIV).

The one or more pieces of SCI information may include COT and/or resource reservation window, where a WTRU may indicate a value of zero when COT and/or resource reservation for re-transmissions for COT sharing may be disabled in the resource pool. A WTRU may indicate a value of zero when all determined transmission(s) (N_{r_total}) for the TB(s) may be performed in the shared current COT. A WTRU may indicate a value of a time period in units of ms or number of slots following the end of the shared current COT, and/or between the end of the current COT and the start of the next reserved COT and/or reservation period. A WTRU may determine the length of the window based on the remaining packet delay budget (PDB) of a TB transmitted in the shared current COT.

The one or more pieces of SCI information may include a HARQ process number, New data indicator, and/or a Redundancy version.

The one or more pieces of SCI information may include HARQ feedback enabled/disabled indication, which may be an indication whether HARQ feedback may be enabled and a PSFCH carrying the HARQ ACK/NACK may be expected for the PSSCH/PSCCH transmission. A WTRU may determine this indication based on QoS requirements of the TB(s) transmitted in the shared current COT. In one instance, QoS may be associated with priority, as configured in the higher layers. In one instance, in order to decide whether HARQ is enabled/disabled, a WTRU may use one or more QoS parameters (e.g., priority, or other parameters).

The one or more pieces of SCI information may include a transmission configuration including number of DMRS port, DMRS pattern, MCS value and/or MCS table indication.

The one or more pieces of SCI information may include an indication of the SCI-2 format and Beta Offset value.

The one or more pieces of SCI information may include an indication of the synchronization source used by the sharing WTRU. In one example, the value may indicate one of the sources including GNSS, gNB, SyncRef WTRU, and WTRU internal clock. In another example, an additional indication may be (pre)configured to indicate the SL SSID.

The one or more pieces of SCI information may include COT and/or resource reservation interval, where a WTRU may indicate a value of zero when COT and/or resource reservation for another TB for COT sharing may be disabled in the resource pool, and/or a WTRU may indicate a value of zero when the TB transmitted in the PSSCH may be aperiodic.

When COT and/or resource reservation for another TB for COT sharing is enabled in the resource pool and the TB transmitted in the PSSCH is periodic, a WTRU may indicate a time period in units of ms or number of slots between the shared current COT and/or resource(s) and a reserved COT and/or resources for transmission(s) for another TB(s). This time period may be set as the COT and/or resource reservation interval (P_{rsvp_TX}) indicated by the higher layers.

By reserving such a COT and/or resource(s), a WTRU may perform a SL channel access to initiate the reserved COT corresponding to the priority indicated in the SCI of the transmission(s) performed in the shared current COT. Additionally, a reservation window may be (pre)configured with a COT length (e.g., may be associated with a specific COT length). A WTRU may initiate the reserved COT within the reservation window.

In another example, COT and/or resource reservation for transmission(s) performed in a shared COT may be enabled/disabled in a (pre)configuration of a resource pool. A WTRU may set the indication as zero when this (pre)configuration is Disabled in the resource pool regardless of the traffic type of the TB(s) transmitted in the shared current COT and/or the (pre)configuration for COT and resource reservation for another TB.

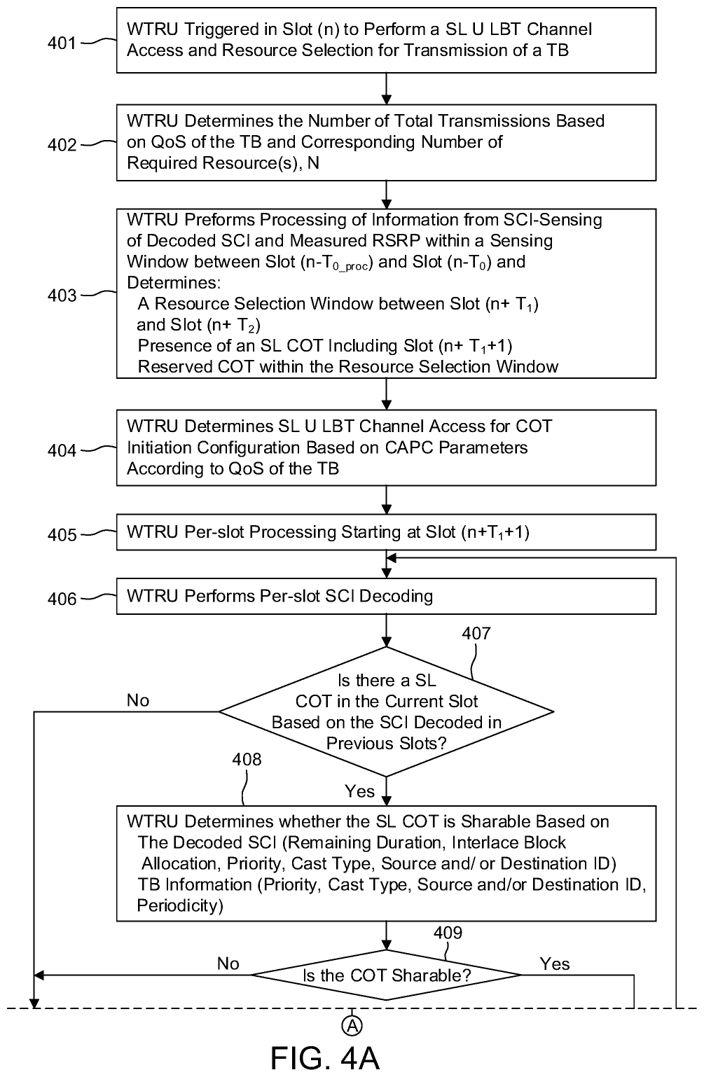

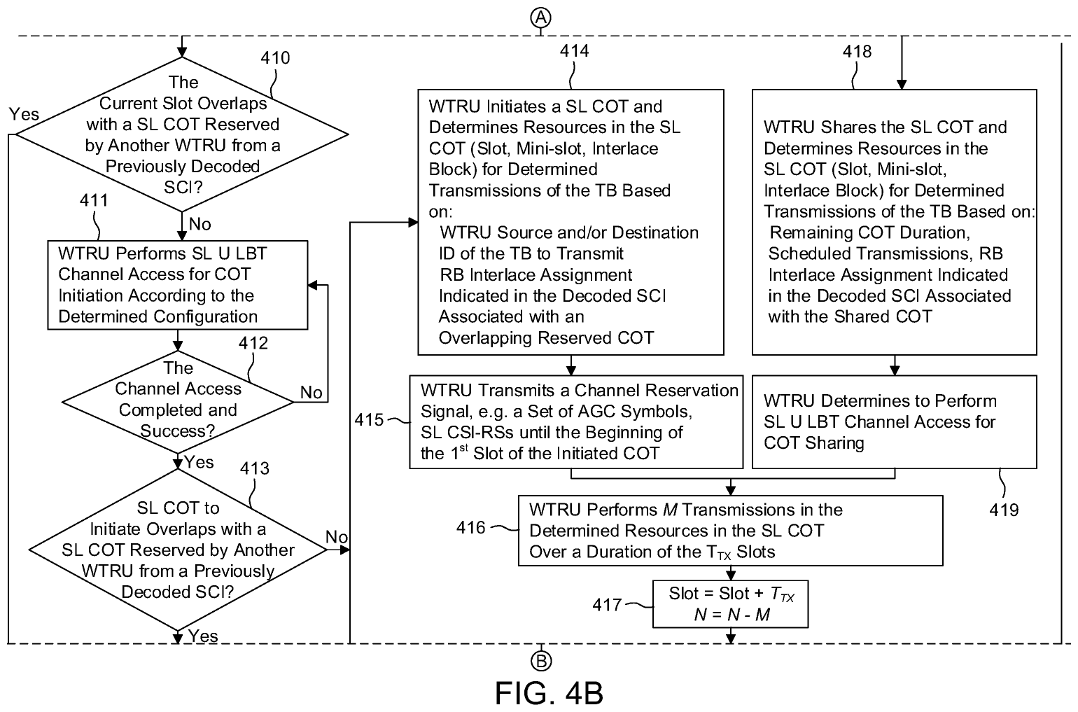

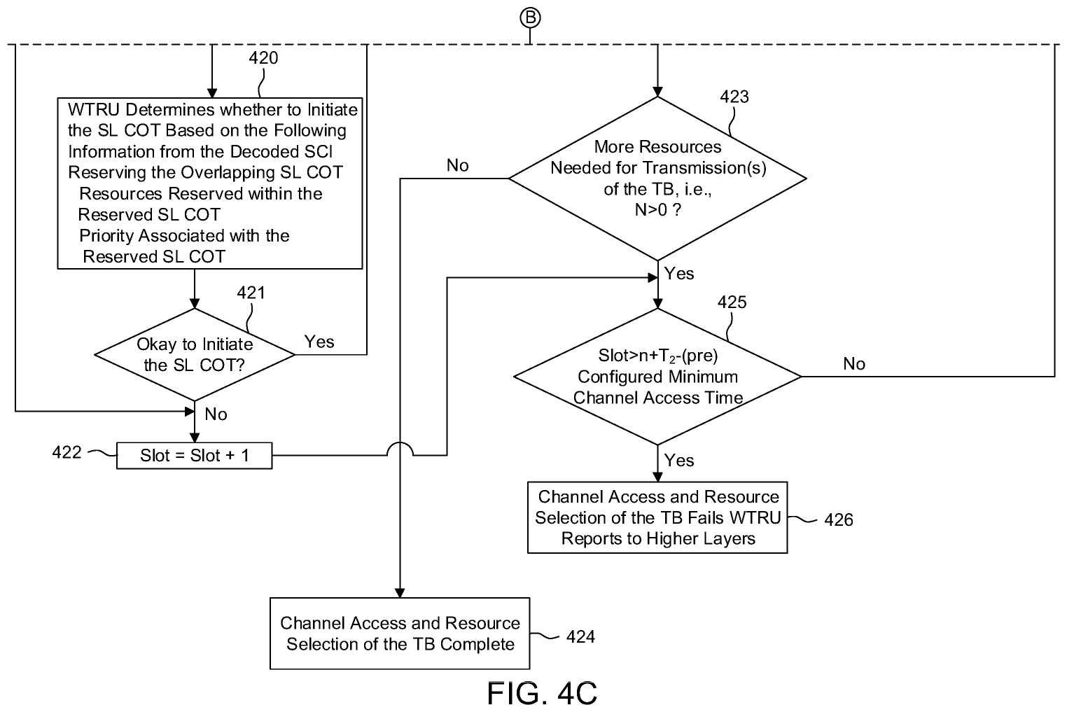

FIG. 4 refers to FIG. 4A, FIG. 4B, and FIG. 4C (the end of one figure flows into the following figure, and may be illustrated using the indicators of A in a circle, showing FIG. 4B is an extension of FIG. 4A, and indicator B in a circle showing that FIG. 4C is an extension of FIG. 4B). FIG. 4 illustrates an example of SL U channel access and resource selection. In some cases, a WTRU may perform SL U channel access and resource selection for COT initiation following a COT sharing. A WTRU may perform N_{r_share} transmission(s) in a current shared COT based on a SL U channel access and resource selection procedure for COT sharing. When the number of transmission(s) performed in the shared current COT may be smaller than the determined number of transmission(s) for the TB(s) (N_{r_share}<N_{r_total}), a WTRU may continue performing SCI sensing for the triggered SL U channel access and resource selection for COT sharing. When a WTRU may not detect a sharable COT, a WTRU may perform a SL U channel access and selection for COT initiation concurrently to SL U channel access and resource selection for COT sharing as indicated in FIG. 4.

As shown in FIG. 4A, at 401, a WTRU may be triggered in slot (n) to perform a SL U LBT channel access and resource selection for transmission of one or more TBs. At 402, the WTRU may determine the number of total transmissions based on QoS of the TB and/or corresponding number of required resources (N). At 403, the WTRU may receive and process information from SCI sensing of decoded SCI and measured RSRP within a sensing window between slot (n−T_{0_proc}) and slot (n−T₀) (e.g., processing historic transmission in which SCI information/measurement is obtained to see if there are any COT reservations). As a result of one or more pieces of received and/or gathered information, the WTRU may determine: a resource selection window between slot (n+T₁) and slot (n+T₂); a presence of an SL COT including slot (n+T₁+1); and/or, a reserved COT within a resource selection window. At 404, the WTRU may determine SL U LBT channel access for COT initiation configuration based on configured CAPC parameters according to QoS of the TB (e.g., configured by higher layers for each TB for transmission). At 405, the WTRU may perform per-slot processing starting at slot (n+T₁+1) (e.g., all processing that may occur in the slot after point 405). At 406, the WTRU may perform per-slot SCI decoding (e.g., the initiating WTRU is performing SCI decoding, which in this instance may be receiving/monitoring to see if there is a COT to share; since there is no transmission yet, then no COT is acquired yet). At 407, the WTRU may determine whether there is a SL COT in the current slot based on the SCI decoded in one or more previous slots (e.g., decoding on-going transmission in the current COT). If yes (there is a SL COT in the current slot based on the SCI decoded in a previous slot), then at 408, the WTRU may determine whether the SL COT is sharable based on one or more parameters, such as information from the SCI (e.g., remaining duration, interlace block allocation, priority, cast type, source and/or destination ID), and/or TB information (e.g., priority, cast type, source and/or destination ID, periodicity, etc.). At 409, the WTRU determines the COT shareable (as explained in 408). If no (the COT is not sharable), then at 410 the WTRU determines whether the current slot overlaps with a SL COT reserved by another WTRU from a previously decoded SCI. If yes (the COT is sharable), then the WTRU proceeds to 418, where the WTRU shared the SL. At 418, the WTRU shares the CL COT and determines resources in the SL COT (e.g., slot, mini-slot, interlace block, etc.) for determined transmission of the TB based on one or more of: a remaining COT duration; scheduled transmission(s); and/or, RB interlace assignment indicated in the decoded SCI associated with the shared COT. At 419, the WTRU determines to perform SL U LBT channel access for COT sharing.

Returning to 407, if no (there is not a SL COT in the current slot based on the SCI decoded in a previous slot), then at 410 the WTRU determines whether the current slot overlaps with a SL COT reserved by another WTRU from a previously decoded SCI. If yes (the current slot does overlap with SL COT reserved by another WTRU from a previously decoded DCI), then at 422, the WTRU continues processing, where the slotₙₑₓₜ=slot_{current}+1, and the WTRU may then proceed to 425, where the WTRU determines whether the slot is greater than n+T₂₋₍ₚᵣₑ₎ configured minimum channel access time as described herein (425 and results of its determination are further discussed herein). If no (the current slot does not overlap with SL COT reserved by another WTRU from a previously decoded DCI), then at 411 the WTRU performs SL U LBT channel access for COT initiation according to the determined configuration. At 412, if the channel access is completed and is not successful, then the WTRU may return to 411 and repeat the channel access again (e.g., in some instances, this may be repeated until channel is acquired, alternatively, this may be repeated until the latency of the TB is reached (when the TB expires)). At 412, if the channel access is completed and successful, then at 413 the WTRU may determine whether an initiating SL COT overlaps with a SL COT reserved by another WTRU from a previously decoded SCI. If yes (the initiating SL COT would overlap with a SL COT reserved by another WTRU from a previously decoded SCI), then at 420 the WTRU may assess whether to initiate the SL COT based on one or more of the following pieces of information (e.g., decoded from the SCI reserving the overlapping SL COT): resources reserved within the reserved SL COT; priority associated with the reserved SL COT; and/or other information or parameter (e.g., as described herein). If no, (the initiating SL COT would not overlap with a SL COT reserved by another WTRU from a previously decoded SCI), then the WTRU may proceed with initiating the SL COT (e.g., at 414).

Based on the assessment at 420, at 421 the WTRU may determine whether to initiate the SL COT. If yes, then the WTRU may proceed with initiating the SL COT (e.g., at 414). If no, the WTRU may continue processing to the next slot, where slotₙₑₓₜ=slot_{current}+1, and the WTRU may then proceed to 425, where the WTRU determines whether the slot is greater than n+T₂₋₍ₚᵣₑ₎ configured minimum channel access time as described herein (425 and results of its determination are further discussed herein).

At 414, the WTRU may initiate a SL COT and determine resources in the SL COT (e.g., slot, mini-slot, interface block, etc.) for determined transmission(s) of the TB(s) based on one or more of: a WTRU source and/or destination ID of the TB(s) to transmit; and/or, RB interlace assignment indicated in a decoded SCI associated with an overlapping reserved COT. At 415, the WTRU may transmit a channel reservation signal (e.g., a set of AGC symbols, a SL CSI-RSs, etc.) until the beginning of the 1^{st} slot of the initiated COT. At 416, the WTRU may perform the transmission (as further described herein).

At 416, the WTRU may perform M transmissions in the determined resources in the SL COT over a duration of the T_{TX} slots. So, as shown at 417, the next slot for processing may be equal to a slot plus the T_{TX} and N_{remaining} may equal N minus M (e.g., since the WTRU needs to transmit in N resources to start with, every time it gets to transmit M transmissions, the remaining resources will be N−M). At 423, the WTRU determines whether more resources are needed to the one or more transmissions of the TB (e.g., is N_{remaining} greater than 0 based on step 417). If no (more resources are not needed for transmission(s) of the TB(s)), then at 424, channel access and resource selection for the TB is complete, and the TB is transmitted. If yes (the WTRU does need more resources for transmission(s) of the TB(s)), then at 425, the WTRU determines whether the slot is greater than n+T₂₋₍ₚᵣₑ₎ configured minimum channel access time (e.g., configured as part of the channel access configuration). If no (the slot is not greater than n+T₂₋₍ₚᵣₑ₎ configured minimum channel access time), then the process may return to 406 (e.g., per-slot processing). If yes (the slot is greater than n+T₂₋₍ₚᵣₑ₎ configured minimum channel access time), then at 426, channel access and resource selection of the TB may fail, and this may be reported to higher layers.

In some cases, there may be one or more procedure(s) for SL U channel access and resource selection procedure for COT initiation. In some cases, a WTRU may determine COT initiation based on LBT sensing. In one case, when the number of performed transmissions within a shared or an initiated COT may be smaller than the determined total number of transmissions (N_{r_share}<N_{r_total}) and/or a WTRU may not detect a current COT available for sharing based on SCI sensing, a WTRU may determine to perform SL U channel access and resource selection for COT initiation. In one case, a WTRU may be triggered by higher layers to perform a SL U channel access and resource selection for COT initiation in a slot (n) for transmission(s) of one or more TB(s) when COT sharing is (pre)configured as Disabled in a resource pool.

A WTRU may perform LBT sensing-based SL U channel access (e.g., a Type 1 LBT channel access as discussed herein) for COT initiation. A WTRU may concurrently perform SCI sensing, as described herein, for detection of a current COT for COT sharing. A WTRU may determine the configuration for LBT sensing-based SL U channel access based on one or more of the following SCI information (as described in herein): the resource pool and/or RB set(s); the priority of the TB(s) (Priority_{TX}); remaining packet delay budget (PDB); resource selection window (RSW); and/or, number (N_{TX}) of transmission(s) including initial transmission(s) and re-transmission(s) of the TB(s) and the corresponding total number (N_{r_total}) of SL U resources within the RSW.

A WTRU may determine to use the bandwidth of the resource pool and/or RB set as the bandwidth of LBT sensing. In another example, a WTRU may be (pre)configured with a number of RB sets for LBT sensing. A WTRU may perform LBT sensing over the bandwidth of each RB set for a LBT sensing-based channel access.

A WTRU may determine the duration of the COT for initiation and the size of the contention window based on the priority, PDB, and/or number of transmission(s) of the TB(s). In one example, a WTRU may select a short COT duration and small contention window size for a TB with high priority and small PDB. With such a LBT sensing configuration, a WTRU may take less time to access the channel. In another example, a WTRU may select a long COT duration and large contention window size for a TB with low priority, large PDB, and/or a large number of transmissions.

In one approach, a WTRU may determine a time to start a LBT sensing for SL U channel access for COT initiation within a determined resource selection window (RSW). For example, when no current and sharable COT may be detected, a WTRU may start LBT sensing at the beginning of the RSW. In another example, a WTRU may randomly select a LBT sensing start time within the RSW.

In another approach, a WTRU may determine a time to start LBT sensing channel access (e.g., Type 1 LBT channel access to initiate a COT) based on (pre)configured LBT sensing start occasions within a SL slot, sub-frame, and/or frame. A set of LBT sensing channel access start occasions may be (pre)configured, for example, in a SL slot, sub-frame, and/or frame. Each (pre)configured LBT sensing channel access start occasion may be associated with a SL priority. When a WTRU is triggered to perform a LBT sensing channel access (e.g., Type 1 LBT channel access) for transmission of a TB, a WTRU may start the triggered LBT sensing channel access at the earliest LBT sensing channel access point in time associated with the priority of the TB.

In another approach, a WTRU may determine to exclude one or more reserved COT(s) and/or resource(s) from the determined RSW from LBT sensing. In one example, a WTRU may consider the LBT sensing slots included in the excluded periods with the RSW to be busy. In another example, a WTRU may suspend the LBT sensing during the LBT sensing slots, such as disregard the LBT sensing result from the sensing slots. A WTRU may determine whether to perform such an exclusion based on the priority (Priorityᵣₑₛᵥ) associated with the reserved COT and/or resource(s), such as the priority indicated in the SCI reserving the COT and/or resource(s) and/or the priority (Priority_{TX}) of the TB to transmit. In one example, a WTRU may determine to perform the said exclusion when the priority (Prioᵣₑₛᵥ) associated with the reserved COT and/or resource (s) may be higher than the priority (Priority_{TX}) of the TB to transmit. In another example, a WTRU may determine to perform the exclusion when the RSRP measured on PSSCH/PSCCH transmission reserving the COT and/or resource(s) exceeds a (pre)configured threshold. A WTRU may select such a threshold based on the priority (Priorityᵣₑₛᵥ) associated with the reserved COT and/or resource(s) and/or the priority (Priority_{TX}) of the TB to transmit.

In one case, during a LBT sensing for SL U channel access for COT initiation, when a WTRU detects a sharable current COT, a WTRU may switch from the on-going SL U channel access and resource selection for COT initiation to performing SL U channel access and resource selection for COT sharing. In another case, a WTRU may adjust LBT sensing-based channel access procedure based on SCI sensing and/COT sharing. A WTRU may pause and resume a LBT sensing-based SL U channel access by excluding one or more of the following slot(s) from the LBT sensing: Slot(s) within which a current COT is detected based on SCI sensing; and/or, Slot(s) within which a WTRU performs transmissions in a shared current COT.

In some instances, a WTRU may not perform LBT sensing within the slot(s) during a LBT sensing-based SL U channel access.

A WTRU may perform LBT sensing for SL U channel access for COT initiation, such as Type 1 channel access, in a set of consecutive logical slots in time domain of a determined SL resource pool. Such LBT sensing nay be performed continuously over time to ensure fair access to the spectrum.

In one example, a WTRU may perform LBT sensing in physical slots to ensure time consecutiveness of all sensing slots. Upon success of LBT channel access, a WTRU may determine to initiate a COT including a set of physical slots with consecutive physical slot index (tᵢ). A WTRU may determine the logical slot index (Tᵢ) of each of the included physical slots based on the mapping between the physical slots and logical slots belonging to the resource pool used for the PSSCH/PSCCH transmission(s) to be sent within the initiated COT. The WTRU determination of such a mapping is further discussed herein (e.g., WTRU process for determination of time consecutiveness of logical slots in a resource pool). A WTRU may thus initiate a COT including a set of logical slots with logical slot index (Tᵢ) that may or may not be consecutive. A WTRU may compute and include logical slot-based indications in the SCI transmissions accordingly, such as remaining COT duration, remaining transmission duration, COT and/or resource reservation interval, COT and/or resource reservation window, etc.

In another example, a WTRU may perform LBT sensing in logical slots of the resource pool used for the PSSCH/PSCCH transmission(s). A WTRU may determine to stop the on-going LBT sensing when the LBT sensing performed over logical slots (e.g., with consecutive logical slot indexes) that may not be consecutive (e.g., have a gap in time domain). A WTRU may re-start a LBT sensing for channel access after the gap in the time domain. Alternatively, a WTRU may continue an on-going LBT sensing and add a number of deferral periods in the LBT sensing corresponding to the length of the gap in the time domain. A WTRU may thus initiate a COT including a set of logical slots with consecutive logical slot index (Tᵢ).

When LBT sensing-based channel access is successful, for example, when a SL U channel is available, a WTRU may determine to initiate a COT and perform resource selection within the initiated COT. In another example, a WTRU may determine whether to initiate a COT and perform resource selection within the initiated COT based on the COT and resource reservation information based on SCI sensing.

In one example, a WTRU may determine to not initiate a COT when the duration of the COT for initiation overlaps with a reserved COT and/or resource(s). A WTRU may perform another LBT sensing-based channel access after the slot(s) reserved in the COT and/or resource reservation.

In another example, when the duration of COT to initiate overlaps with a reserved COT and/or resource(s), a WTRU may determine to not initiate a COT when the priority associated with the overlapping reserved COT (Priorityᵣₑₛᵥ) and/or resources (e.g., the priority indicated in the SCI reserving the COT and/or resources) is higher than the priority of the TB to transmit in the COT to initiate (Priority_{TX}). A WTRU may determine to perform LBT sensing-based SL U channel access for COT initiation after the end of the overlapping reserved COT.

In another example, a WTRU may determine to initiate a COT overlapping with a reserved COT and/or resource(s), when the RSRP associated with the overlapping (determined in SCI sensing) is lower than a (pre)configured threshold. For example, the value of such a threshold may be determined based on the L1 priority associated with the overlapping reserved COT (Priorityᵣₑₛᵥ) and the L1 priority of the TB(s) to transmit (Priority_{TX}). The value of such a threshold may also be associated with channel congestion. A WTRU may determine the RSRP threshold corresponding to Priorityᵣₑₛᵥ, Priority_{TX} and channel congestion measured in the LBT sensing and/or SCI sensing.

In another example, a WTRU may determine to initiate a COT overlapping with a reserved COT and/or resource(s) with the exclusion of the frequency resource(s) assigned for the reserved COT and/or resource(s) from the resource selection within the initiated COT. In this case, a WTRU may initiate a COT with resource(s) multiplexing with the frequency resource(s) assigned in the COT and/or resource reservation in the frequency domain.

Upon a successful LBT sensing channel access, a WTRU may determine to initiate a COT immediately after the end of the LBT sensing. A WTRU may determine whether to initiate a COT based on the time consecutiveness of the logical slots to be included in the COT to initiate. In one example, a WTRU may determine that the logical slots to be included in the COT may not be consecutive in time domain based on the mapping between the physical slots and logical slots belonging to the resource pool used for the PSSCH/PSCCH transmission(s) to perform within the initiated COT. A WTRU may then determine to not initiate a COT following the performed LBT sensing channel access and start another LBT sensing channel access for COT initiation.

Upon a successful LBT sensing channel access, a WTRU may determine to initiate a COT immediately after the end of the LBT sensing based on a measured congestion level. In one example, a WTRU may determine to initiate a COT when the measured congestion level is below a (pre)configured threshold. A WTRU may determine such a congestion level based on one or more (pre)configured measurements performed in LBT sensing and/or SCI sensing. The measurements may include, for example, RSSI measured in a sensing slot, RSSI measured in a SL slot, RSRP measured on PSCCH DMRS and/or PSSCH DMRS associated with a decoded SCI, the number of slots in which a LBT sensing result of the channel may be busy, and/or the like. A WTRU may perform such congestion level measurement within a (pre)configured SL U channel congestion measurement window.

The channel congestion level based on the measurement may be expressed as a ratio of the number of slots in which the measured values (e.g., RSSI or number of busy sensing slots) that exceed a (pre)configured level to the total number of measured sensing and/or SL slots in a resource pool. In one example, the (pre)configured threshold may be associated with L1 priority of the TB(s) to transmit (Priority_{TX}). A higher threshold may be associated with higher priority of the TB(s) to transmit (Priority_{TX}) so at a given congestion level a WTRU with TB(s) with higher priority may be allowed to initiate a COT upon a successful LBT sensing channel access.

In some cases, there may be a WTRU transmission after Type 1 LBT channel access success without transmission of channel reservation signal and/or CPE. In one approach for COT initiation, upon a successful LBT sensing channel access at a time instance t_{LBT-success}, a WTRU may not immediately perform a transmission of a channel reservation signal and/or CPE to hold the channel until the start time of PSSCH/PSCCH transmission of the initiated COT (t_{PSSCH-COT-start}). A WTRU may perform a PSSCH/PSCCH transmission of the initiated COT without a transmission of channel reservation signal and/or CPE when one or more conditions are satisfied.

For example, one condition may be where the time offset between Type 1 LBT channel access completion and the start of PSSCH/PSCCH transmission (i.e. t_{PSSCH-COT-start}−t_{LBT-success}) may be smaller than (pre)configured threshold and larger than a symbol.

For example, one condition may be where a WTRU may determine the channel may be available in all of N sensing slots before the start of the PSSCH/PSCCH transmission of the COT. A minimum N value may be (pre)configured, such as one sensing slot. In one example, a WTRU may select a N based on the measured SL U CBR. A larger value may be selected when SL U CBR is high, such as the channel is busy.

For example, one condition may be where a WTRU may determine the channel may be available in all sensing slots included in a LBT contention period following the N sensing slots. A LBT contention period may include a duration (T_{f}=16 us) immediately followed by mₚ consecutive sensing slot durations (Tₛₗ=9 us) where mₚ may be selected from the CAPC configuration based on the priority of the TB(s) to transmit in the initiated COT.

If one of the conditions is not met, a WTRU may not perform the PSSCH/PSCCH transmission and initiate a COT. A WTRU may perform another Type 1 LBT channel access to initiate another COT.

When the time offset between Type 1 LBT channel access completion and the start of PSSCH/PSCCH transmission (e.g., t_{PSSCH-COT-start}−t_{LBT-success}) is smaller than symbol, a WTRU may perform transmission of channel reservation signal and/or CPE immediately after the successful Type 1 LBT sensing channel access.

In some cases, in an initiated COT there may be one or more procedures for resource selection. When a WTRU initiates a COT, a WTRU may perform resource selection within the initiated COT. A WTRU may determine the number (N_{r_COT}) of available candidate resources within the initiated COT based on one or more of the following information: initiated COT duration (T_{initiated_COT}) in unit of slots; candidate resource, such as L_{RB_interface} RB interlaces in one slot, for the TB(s) to transmit; and/or, frequency resource assignment of overlapping reserved COT(s) and/or resource(s).

A WTRU may determine the number (N_{r_COT}) of available candidate resource(s) within the initiated COT to be T_{initiated_COT}×floor (M/L_{RB_interface}) where Nₛₗₒₜ is the number of slots within the initiated COT, M is the (pre)configured number of RB interlaces of the indicated resource pool, and/or RB set and floor (M/L_{RB_interface}) is the number of available candidate resources in each such slot. When a WTRU initiates a COT overlapping with a reserved COT and/or resource(s), a WTRU may determine the number (N_{r_COT}) of available candidate resource(s) within the initiated COT to be T_{initiated_COT}×floor (M/L_{RB_interface})−N_{r_reserve} where N_{r_reserve} may be the number of reserved resource(s).

A WTRU may be (pre)configured with a maximum number of available candidate resource(s) for COT initiation in a resource pool (N_{r_max}) and a WTRU may determine the number of resources to use (N_{r_init}) to be N_{r_init}=N_{r_max}. In another example, such a value may be associated with L1 priority (Priority_{TX}). A WTRU may determine a N_{r_max} based on the (pre)configured association and the L1 priority (Priority_{TX}) of the TB(s) to transmit.

In another example, a WTRU may be (pre)configured with a ratio (P %) relative to the determined available candidate resource(s) for COT initiation (N_{r_COT}). A WTRU may determine the number of resources to use (N_{r_init}) to be N_{r_init}=N_{r_COT}×P %. The value of P may be associated with L1 priority and a WTRU may determine the value of P based on L1 priority (Prio_{TX}) of the TB(s) to transmit. In a further example, the value of P may be associated with channel congestion status. A WTRU may determine the value of P based on L1 priority (Priority_{TX}) of the TB(s) to transmit and/or the channel congestion measured in LBT sensing and/or SCI sensing, such as based on RSSI over the bandwidth of LBT sensing, resource pool, and/or RB set.

When a WTRU is not (pre)configured with such N_{r_max} and/or P ratio, a WTRU may determine to use all determined available candidate resource(s) in the initiated COT, N_{r_init}=N_{r_COT}. When the determined N_{r_init} is larger than or equal to the determined total number of resource(s) for the transmission of the TB(s) (N_{r_init}>=N_{r_total}), a WTRU may determine the number of N_{r_init}=N_{r_total}. In this case, a WTRU may complete determined transmission(s) of the TB(s) in the initiated COT.

A WTRU may index the N_{r_COT} determined available candidate resource(s) for COT initiation in an ascending order in terms of RB interlace index and slot index. For example, a WTRU may index available candidate resource(s) first in a slot in the order of ascending RB interlace indexes and then continue the indexing to candidate resource(s) in the next slot until the last slot for sharing in the current COT. A WTRU may denote each available candidate resource(s) with such an index as rⱼ where the index j may be an integer in (0,1, . . . N_{r_COT}−1).

A WTRU may select N_{r_init} available candidate resource(s) for the transmission(s) of the TBs from the N_{r_COT} such resources as discussed herein. A WTRU may determine to have one or more available candidate resource(s) in each slot of initiated COT.

A WTRU may determine which N_{r_init} available candidate resource(s) to use for transmission(s) of the TB(s) based on one or more of the following: random selection; WTRU source and/or destination ID slot index; cast type; and/or, (pre)configured resource patterns.

A WTRU may randomly select N_{r_init} indexes from the range of (0,1, . . . N_{r_COT}−1) and determine to use available candidate resource(s) denoted by the selected indices. A WTRU may determine N_{r_init} indexes based on cast type and a numeric value of associated WTRU Source and/or Destination ID. In one example, for a unicast transmission, a WTRU may determine a random selection initialization seed based on WTRU Source ID and/or WTRU Destination ID. In addition, a WTRU may also include a slot index in the initialization of the seed. In another example, for a groupcast transmission, a WTRU may determine a random selection initialization seed based on WTRU Destination ID and/or a (pre)configured group member ID. For a broadcast transmission, a WTRU may determine a random selection initialization seed based on WTRU Destination ID.

A WTRU may be (pre)configured with a set of available candidate resource patterns. For example, a WTRU may select the first group of consecutive N_{r_init} available candidate resources whose indexes may be denoted by (r₀, r₁, . . . r_{Nr_init}). When N_{r_init}=N_{r_total}, a WTRU may perform all transmissions of the TB(s) within the first consecutive available candidate resources within the initiated COT. When N_{r_init}<N_{r_total}, a WTRU may perform N_{r_init} transmissions of the TB(s) within the first consecutive available candidate resources within the initiated COT and perform a new SL U channel access procedure to perform the remaining transmissions of the TB(s) in a new initiated COT or in another shared COT.

In another example, a WTRU may select a group of consecutive N_{r_tx_init} available candidate resources whose indexes are denoted by (r_{offset}, r_{offset+1}, . . . r_{offset+Nr_init}). A WTRU may determine the available candidate resource group offset value based on the WTRU Source and/or Destination ID for a unicast transmission and WTRU Destination ID. A WTRU may determine the available candidate resource group offset value based on the WTRU Destination ID and/or a (pre)configured groupcast member ID for a groupcast transmission. A WTRU may determine the available candidate resource group offset value based on the WTRU Destination ID for a broadcast transmission. For example, a WTRU may determine such an offset by performing modular function using the numeric value of the said WTRU ID(s) and/or groupcast member ID and the number of available candidate resource group, which may equal to floor (N_{r_COT}/N_{r_init}).

In some cases, there may be PSSCH/PSCCH transmissions in an initiated COT. A WTRU may perform PSSCH/PSCCH transmission(s) of one or more TB(s) in the determined N_{r_init} available candidate resource(s) within the initiated COT. For each PSSCH/PSCCH transmission performed in the initiated COT, a WTRU may indicate one or more of SCI information in the PSCCH on the initiated COT, transmitted TB(s), transmission configuration, or the like.

One example of SCI information may be L1 priority, cast type, and/or, WTRU Source ID and/or Destination ID of the TB(s) transmitted in PSSCH.

One example of SCI information may be remaining COT duration, which may be the remaining time of the COT between the slot in which the SCI is transmitted and the end of the initiated COT. In one example, the unit of remaining COT duration may be a logical slot of the resource pool used for the PSCCH/PSCCH transmissions within the initiated COT. In another example, a physical slot may be applied to indicate the time duration. A WTRU may determine a remaining COT duration in each SCI transmitted in a COT based on the maximum COT and the index of the slot including the SCI transmission. A WTRU may not use all the remaining COT duration for SL transmissions. The actual transmissions scheduled within a COT may be indicated in another SCI indication of remaining transmission duration.

One example of SCI information may be MCOT duration. The maximum COT corresponding to the configuration of the Type 1 LBT a WTRU may perform to initiate the COT may be indicated. It may be in the unit of ms or logical SL slot.

One example of SCI information may be COT starting slot index. A WTRU may indicate the logical slot index of the 1st slot of a COT. When a WTRU decodes a SCI within a COT, the WTRU may determine the number of remaining slots available for SL transmissions within the COT based on the indicated starting slot index and the MCOT duration.

One example of SCI information may be COT initiation/sharing indication. A WTRU that initiates a COT may indicate a value corresponding to COT initiation (e.g., a value of one) in this SCI field of all SL transmissions performed in the initiated COT by the WTRU.

One example of SCI information may be COT sharing for PSSCH/PSCCH indication, where a WTRU may set the value of this indication based on a (pre)configuration (enabled/disabled) of the resource pool. A WTRU may set the value as “Enabled” when a COT transmitted by the WTRU may be shared by another WTRU. When it is set as “Disabled”, the COT may not be shared.

One example of SCI information may be COT sharing for PSFCH indication, where a WTRU may set the value of this indication based on a (pre)configuration (enabled/disabled) of the resource pool when HARQ feedback is enabled for the TB transmitted in the PSSCH(s). When HARQ feedback is disabled for the TB(s) transmitted in the PSSCH, a WTRU may set the indication as Disabled. When this SCI indication is set as “Enabled” and HARQ is enabled, a PSFCH may be transmitted in the same COT (e.g., share the COT) in which the associated PSSCH/PSCCH transmission is received. When this SCI indication is set as “Disabled” and HARQ is enabled, a PSFCH may not be transmitted in the same COT (e.g., share the COT) in which the associated PSSCH/PSCCH transmission is received. In one example, when there is no (pre)configured PSFCH occasion in a COT, a WTRU may disable the PSFCH sharing.

One example of SCI information may be channel congestion indication, where a WTRU may determine such a value based on one or more (pre)configured attributes of LBT sensing and/or SCI sensing performed to initiate the COT. The attributes may include, for example, the length of time to complete the procedure, the number of slots in which an LBT sensing result of the channel may be busy, the number of performed deferred durations, and/or the like. A WTRU may set the value as one when one or more said numbers exceed a (pre)configured threshold. In another example, a WTRU may determine the channel congestion indication value based on RSSI measured in the resource pool and/or RB set. A WTRU may set the indication as one when the measured RSSI may exceed a (pre)configure threshold. Also, a WTRU may determine a channel congestion level, such as SL U Channel Busy Ratio (CBR), using a ratio of the number of slots in which the measured RSSI for a resource pool and/or RB set may exceed a (pre)configured level to the number of measured SL slots in a resource pool. A WTRU may set the indication when this channel congestion level may exceed a (pre)configured threshold. The RSSI measurement may be based on LBT sensing and/or measurement on PSCCH DMRS associated with a decoded SCI. A WTRU may perform such a RSSI measurement within a (pre)configured SL U CBR measurement window.

One example of SCI information may be a remaining transmission duration, which may be the number of contiguous slot(s) scheduled for PSCCH/PSSCH transmission(s) between the slot in which the SCI is transmitted and the end of the initiated COT, such as indicated in a TRIV. In one example, the unit of remaining transmission duration may be a logical slot of the resource pool used for the PSCCH/PSCCH transmissions within the initiated COT. In another example, a physical slot may be applied.

One example of SCI information may be frequency resource assignment(s) of PSSCH(s), which may be the RB interlace index(s) and/or RB set index(s) of the PSSCH transmission(s) between the slot in which the SCI is transmitted and the end of the initiated COT, such as indicated in a FRIV.

One example of SCI information may be COT and/or resource reservation interval, where a WTRU may indicate a value of zero when COT and/or resource reservation for another TB may be disabled in the resource pool. A WTRU may indicate a value of zero when the TB transmitted in the PSSCH may be aperiodic.

When COT and/or resource reservation for another TB may be enabled in the resource pool and the TB transmitted in the PSSCH may be periodic, a WTRU may indicate a time period in unit of ms or number of slots between the initiated COT and/or resource(s) and a reserved COT and/or resources for transmission(s) for another TB(s). This time period may be set as the COT and/or resource reservation interval (P_{rsvp_TX}) indicated by the higher layers. In one example, the unit of COT and/or resource reservation interval may be a logical slot of the resource pool used for the PSCCH/PSCCH transmissions within the initiated COT. In another example, a physical slot may be applied to indicate this interval time.

By reserving such a COT and/or resource(s), a WTRU may perform SL channel access to initiate the reserved COT of the same length as the initiated COT. In addition, a reservation window may be (pre)configured with association with COT length. A WTRU may initiate the reserved COT within the reservation window. In another example, a reservation window associated with the indicated COT and/or resource reservation interval may be indicated in the same SCI.

In another example, COT and/or resource reservation for transmission(s) performed in an initiated COT may be enabled/disabled in a (pre)configuration of a resource pool. A WTRU may set the indication as zero when this (pre)configuration is Disabled in the resource pool regardless of the traffic type of the TB(s) transmitted in the shared current COT and/or the (pre)configuration for COT and resource reservation for another TB.

One example of SCI information may be COT and/or resource reservation window, where a WTRU may indicate a value of zero when COT and/or resource reservation for re-transmissions for COT initiation may be disabled in the resource pool. A WTRU may indicate a value of zero when all determined transmission(s) (N_{r_total}) for the TB(s) may be performed in the initiated COT. A WTRU may indicate a value of a time period in units of ms or a number of slots following the end of the current COT. A WTRU may determine the length of the window based on the remaining packet delay budget (PDB) of a TB transmitted in the shared current COT. Also, a WTRU may determine the length of the window based on the remaining packet delay budget (PDB) of a TB transmitted in an initiated COT. In one example, the unit of COT and/or resource reservation window may be a logical slot of the resource pool used for the PSCCH/PSCCH transmissions within the initiated COT. In another example, a physical slot may be applied to indicate this window length.

One example of SCI information may be a HARQ process number, New data indicator, and/or Redundancy version.

One example of SCI information may be HARQ feedback enabled/disabled indication, which may be an indication of whether HARQ feedback is enabled and a PSFCH carrying the HARQ ACK/NACK is expected for the PSSCH/PSCCH transmission. A WTRU may determine this indication based on QoS requirements of the TB(s) transmitted in the shared current COT.

One example of SCI information may be transmission configuration including number of DMRS port, DMRS pattern, MCS value and MCS table indication.

One example of SCI information may be indication of the SCI-2 format and Beta Offset value.

One example of SCI information may be Zone ID of the WTRU determined based on the geographic coordinates (e.g., from GNSS).

One example of SCI information may be an indication of the (pre)configured Minimum Communication Range (MCR) requirement (e.g., in unit of meters) for the TB transmitted in the PSSCH/PSCCH transmission, such as an index corresponding to a (pre)configured MCR requirement.

One example of SCI information may be an indication of the synchronization source of the WTRU. A WTRU may set a set of values in this SCI indicator corresponding to the source that the WTRU synchronizes with. The values may be (pre)configured to correspond to GNSS, gNB, SyncRef WTRU, and/or internal WTRU clock. In another case, an additional SCI indication may be applied to indicate a SL Synchronization Signal ID received from SL synchronization signal (SLSS).

One example of SCI information may be an indication of SL slots for sharing within a COT. A WTRU may indicate explicitly which SL slots in the COT may be shared. In one example, a TRIV may be used to indicate a logical slot offset, such as a number of logical slots between the SL slot, including the SCI indication and the SL slot indicated for sharing. In another example, the logical slot index of the SL slot for sharing may be indicated.

In some cases, a WTRU may determine a COT starting position for COT initiation and COT sharing. In one case, a WTRU may be (pre)configured with a set of starting positions of a COT (e.g., a time instance to start a SL transmission in a COT) within a (pre)configured period. The (pre)configured period may be a SL slot, a SL subframe, a radio frame (denoted by SFN), and/or a (pre)configured period in a SL resource pool. The (pre)configured set may include N COT starting positions in each consecutive (pre)configured period in a resource pool. Each starting position may be denoted by a COT starting position index specific to the (pre)configured period. When a (pre)configured period is one SL slot, the COT starting position may also be denoted by a symbol index. For example, when there are two COT starting positions (pre)configured in a SL slot (N=2), the 1^{st} COT starting position may be located at Symbol 0 and the 2^{nd} at Symbol 7 of the SL slot. In one example, a COT starting position may be the start of a (pre)configured SL slot and/or mini-slot.

In one approach, a COT starting position may be one or more of the following transmission instances: the start of the PSSCH/PSCCH transmission(s) included in an initiated and/or shared COT, where such a COT starting position may be (pre)configured as the beginning of a slot, a mini-slot and/or a symbol in a SL resource pool; and/or, the start of the transmission of a reservation signal and/or CPE preceding the PSSCH/PSCCH transmission(s) included in an initiated and/or shared COT, where the duration of the reservation signal and/or CPE may not be counted in the length of the initiated and/or shared COT.

Such a COT starting position may be (pre)configured as the beginning of a time unit. Such a time unit may be (pre)configured as one of the following: SL slot, a mini-slot, a symbol, a LBT sensing slot (e.g., Tₛₗ of 9 us) and/or a LBT contention period (e.g., T_{d}=T_{f}+mₚ×Tₛₗ where T_{f} may be 16 us, Tₛₗ may be 9 us and mₚ may be a value of 1, 3, or 7 selected from CAPC configuration based on the priority of the TB(s) to transmit in the imitated and/or shared COT.

A reservation signal and/or CPE may have a duration over an integer number of aforementioned (pre)configured time units. In one example, a SL slot may be (pre)configured with a set of LBT sensing slots and/or LBT contention periods and the beginning of each LBT sensing slot and/or LBE contention period may be a COT starting position. A WTRU may start a transmission for an initiated and/or shared COT by performing a transmission of a channel reservation signal and/or a CPE at an earliest COT starting position associated with the priority of the TB to be transmitted in the initiated and/or shared COT.

In another example, a WTRU may determine a transmission starting position based on the duration of a channel reservation signal and/or CPE associated with the priority of the TB to transmit in the COT. The duration may include a number of time units and such time unit may be a LBT sensing slots (T_{SL}), a LBT contention period (T_{contention}), a duration of 16 us, a duration of 25 us, a symbol, a SL mini-slot, and/or a SL slot. Each such channel reservation and/or CPE duration may be (pre)configured with an association with a SL priority. A WTRU may select a channel reservation signal and/or CPE associated with the priority of the TB to transmit in a COT and determine the corresponding transmission starting position based on the duration and the start symbol/mini-slot/slot of a first PSSCH/PSCCH transmission of a COT, such as the starting position of a channel reservation signal and/or CPE (the start of the PSSCH/PSCCH transmission—the duration of the channel reservation signal and/or CPE).

In one case, a WTRU may be (pre)configured with an association between a COT starting position and a SL TB priority threshold. When a WTRU completes a Type 1 LBT and finds an available channel, the WTRU may determine whether or not to initiate a COT and perform SL transmissions at the earliest upcoming COT starting position after Type 1 LBT completion based on the priority of the TB to transmit in the COT and the priority threshold associated with the earliest upcoming COT starting position.

Eight priority values for SL TB from 1 to 8 may be defined and indicated in a 3-bit SCI field. In one case, the higher a priority value indicated for a TB the lower the priority of a TB is, or the opposite may be another case.

When the priority of the TB is higher than or equal to the priority threshold associated with the earliest COT starting position (e.g., the priority value of the TB is smaller than or equal to the priority threshold value), a WTRU may determine to initiate a COT and perform SL transmissions at the earliest upcoming COT starting position.

When the priority of the TB is lower than the priority threshold associated with the earliest COT starting position (e.g., the priority value of the TB is larger than the priority threshold value), a WTRU may determine not to initiate a COT (e.g., give up the available channel) and perform SL transmissions (e.g., give up the available channel) at the earliest upcoming COT starting position.

In one example, there are two COT starting positions (pre)configured in a SL slot (N=2) and COT starting position 1 may be (pre)configured to be associated with priority threshold value 4 and COT position 2 with priority threshold value 8. In this example, both COT starting position 1 and 2 may be used by a COT for SL transmission of TB with priority value 1, 2, 3 and 4. However, for a TB with priority value of 5, 6, 7 and 8, a WTRU may not use COT starting position 1 and may have one starting position in each SL slot (e.g., COT starting position 2).

In another approach, a set of (pre)configured COT starting positions may be divided into a number of subsets and each subset of COT starting positions may be associated with a range of SL TB priorities. When the priority of a TB is associated with the earliest upcoming COT starting position after Type 1 LBT completion, a WTRU may determine to initiate a COT and perform SL transmissions of the TB at the earliest upcoming COT starting position. When the priority of the TB is not associated with the earliest upcoming COT starting position after Type 1 LBT completion, a WTRU may determine not to initiate a COT and perform SL transmissions of the TB at the earliest upcoming COT starting position.

In the above-mentioned example with two (pre)configured COT starting positions in the set, the 1st subset may include both COT starting positions and be associated with a range of priority values from 1 to 4. The 2nd subset may include the 2nd COT starting position in each SL slot and associated with a range of priority values from 1 to 8.

When a WTRU determines to initiate a COT at the earliest upcoming COT starting position, the WTRU may perform a transmission of CPE (cyclic prefix extension) and/or a channel reservation signal in the time gap between the completion of Type 1 LBT and the earliest upcoming COT starting position. When a WTRU determines not to initiate a COT at the earliest upcoming COT starting position, the WTRU may start another Type 1 LBT and continue to acquire a channel for SL transmissions of the TB.

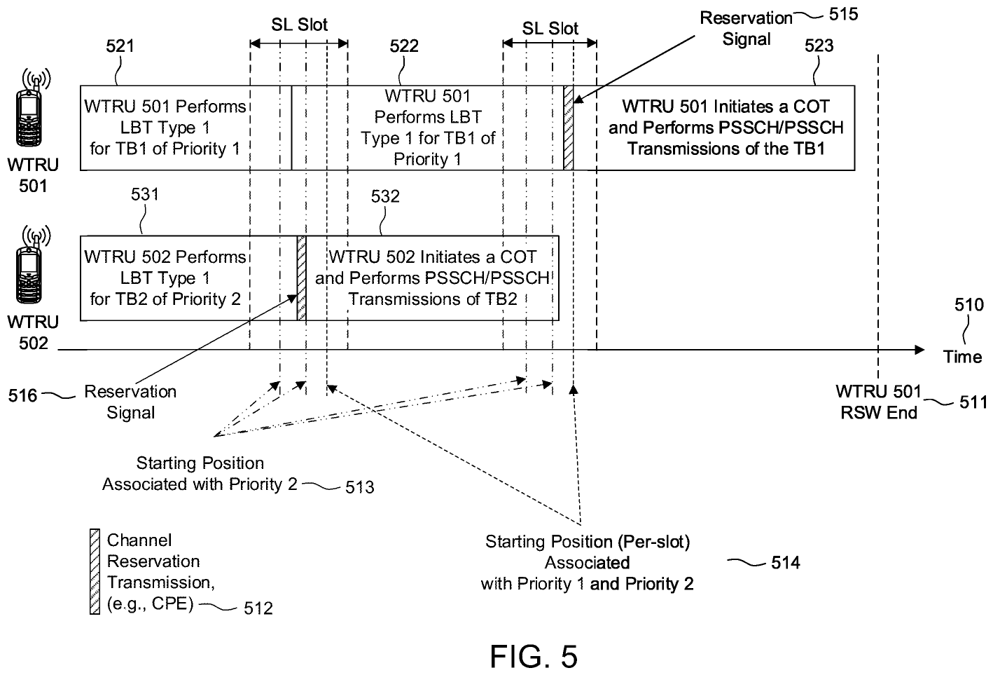

FIG. 5 illustrates an example of a WTRU determining a COT starting position within a SL slot. As shown, there are two WTRUs 501 and 502 that are attempting to transmit a message (e.g., transport block(s)), with time being shown in the horizontal axis 510. The vertical axis exists only to illustrate two WTRUs, however, each WTRU may be transmitting on the same channel/spectrum (e.g., hence, the need for a system to avoid competing transmissions). This priority-based COT starting position determination may enable a WTRU with high priority TBs to access the channel more often when multiple SL WTRUs are contending for the channel. As shown in the example of FIG. 5, two WTRUs (e.g., 501 and 502) contend for a channel for SL transmission of TBs with different priorities (e.g., priority 1 and priority 2, with priority 1 being lower). The result of this approach is that WTRU 501 may complete Type 1 LBT first but determine to forgo the available channel, and WTRU 502, with TB of the highest priority, may acquire the channel and initiate a COT for SL transmission. The WTRUs may utilize a CPE transmission and/or channel reservation signal transmission (512) to accomplish this approach.

As shown in the example, a first set of starting positions 513 (pre)configured in a SL slot may be associated with priority 2 and/or associated with a priority threshold value higher than or equal to priority 2 value. A second set of starting positions 514 (pre)configured in a SL slot may be associated with both priority 1 and priority 2 and/or associated with a priority threshold value higher than or equal to priority 1.

At 521, WTRU 501 may detect an available channel and determine the earliest upcoming COT starting position is not associated with the second set of starting positions 514 for priority 1 and/or priority 1 value is larger than the associated priority threshold. Accordingly, WTRU 501 may determine not to initiate a COT and perform another Type 1 LBT (e.g., at 522) to continue to acquire a channel.

At 531, WTRU 502 may complete Type 1 LBT and determine the earliest upcoming COT starting position is associated with priority 2 and/or priority 2 value is smaller than the associated priority threshold value. WTRU 502 may thus determine to initiate a COT at the earliest upcoming COT starting position of the first set 513. WTRU 502 may perform a CPE transmission and/or channel reservation signal transmission (e.g., 516) until the earliest upcoming COT starting position of the first set 513, at which point, at 532, WTRU 502 may proceed with the transmission of a TB(s).

WTRU 501 may acquire an available channel within the resource selection window and determine that the earliest upcoming COT starting position is associated with priority 1 and/or priority 1 value is smaller than the associated priority threshold value. At 522, the WTRU 501 may perform another LBT Type 1 of priority 1, where there may actually be two starting positions from the second set of starting positions 514 applicable to a TB of priority 1 (e.g., one in each slot), but WTRU 501 will detect the reservation signal 516 from WTRU 502 prior to the first starting position 514, therefore, WTRU 501 may thus determine to initiate a COT at the second appropriate starting position 514. WTRU 502 may perform a CPE transmission and/or channel reservation signal transmission 515 until the earliest upcoming COT starting position of the first set 514. At 523, the WTRU may proceed with the transmission of the TB(s).

Hypothetically, if WTRU 501 failed to acquire an available channel within the resource selection window 511, WTRU 501 may report to a higher layer a LBT and/or channel access failure.

In one approach, a WTRU may apply the slot structure used for the COT starting position for PSSCH/PSCCH transmissions. For example, when COT starting positions are symbol-based and (pre)configured with a slot, each COT starting position and the following symbols until the next COT start position may be a PSSCH/PSCCH mini-slot. When a WTRU initiates a COT, the WTRU may determine to apply such a mini-slot structure to perform PSSCH/PSCCH transmission(s) within the COT.

In another approach, a WTRU may switch from the slot structure used for COT starting position to another slot structure (pre)configured for PSSCH/PSCCH transmissions in an initiated COT. In one example, a WTRU may apply a slot-based PSSCH/PSCCH transmissions in a COT starting from the first SL slot boundary following one or more mini-slot-based transmissions within the COT. A WTRU may indicate the duration of PSSCH/PSCCH transmission in a COT (e.g., number of symbols, mini-slot, and/or slot in SCI).

Similarly, the WTRU determination of COT starting position(s) based on priority of the TB may apply for COT sharing to enable a WTRU with TB(s) of high priorities to share a COT more easily. In one case, a WTRU may determine whether to share a COT and start performing SL transmissions at an earliest upcoming COT starting position within an on-going sharable COT based on the priority of the TB and a range of priorities and/or a priority threshold associated with the (pre)configured COT starting position.

Following a successful Type 2 LBT, a WTRU may determine not to share a COT when the earliest upcoming COT starting position within the COT is not associated with the priority of the TB and/or associated with a priority threshold higher than the priority of the TB. A WTRU may determine to share an on-going and sharable COT when the earliest upcoming COT starting position within the COT is associated with the priority of the TB and/or associated with a priority threshold lower than the priority of the TB.

In another case, a WTRU may apply a COT starting position determination (e.g., as discussed herein) when CBR and/or RSSI measured in Type 1 and/or Type 2 LBT exceeds a (pre)configured threshold. When the CBR and/or RSSI measurement is below the (pre)configured threshold, the WTRU may initiate and/or share a COT at an earliest upcoming COT starting position without consideration of the priority of the TB to transmit in the COT.

In some cases, a WTRU may perform SL U channel access for a SL Synchronization Signal Block (S-SSB) transmission based on a synchronization reference (SyncRef) WTRU priority level. A WTRU may become a SyncRef WTRU and perform SL Synchronization Signal Block (S-SSB) transmission. A WTRU may be (pre)configured to a periodicity (e.g., X frames) of SL Synchronization Signal Block (S-SSB) transmission. In each period, the number of S-SSB transmissions may be (pre)configured. The S-SSB candidate occasion, such as the time domain location of a S-SSB transmission within a period, may be (pre)configured with a starting slot offset and S-SSB interval (e.g., in unit of slots). A WTRU may determine a first S-SSB candidate occasion in the slot, which may be N slots after the beginning of a period where N is the (pre)configured starting slot offset. A WTRU may determine the subsequent S-SSB candidate occasions based on the determined first S-SSB candidate occasion and the S-SSB interval.

A priority level of the SyncRef WTRU may be based on one or more of the following: the GNSS coverage of a SyncRef WTRU; the network coverage of a SyncRef WTRU; and/or, the synchronization reference of the SyncRef WTRU.

A SyncRef WTRU may synchronize with a GNSS (e.g., when in coverage), base station (e.g., when in coverage), another SyncRef WTRU, or its own internal clock.

In one example, a priority level of a SyncRef WTRU may be (pre)configured as following in descending order: First priority level where a SyncRef WTRU may be in coverage and directly synchronize with GNSS; Second priority level where a SyncRef WTRU may be out of coverage and synchronize with another SyncRef WTRU who may directly synchronize with GNSS (e.g., one hop away from GNSS); Third priority level where a SyncRef WTRU may directly synchronize with a base station; Fourth priority level where a SyncRef WTRU who synchronizes with another SyncRef WTRU who directly synchronizes with a base station (e.g., one hop away from the base station); Fifth priority level where a SyncRef WTRU may synchronize with another SyncRef WTRU whose synchronization source may be two or more hops away from a base station or GNSS; and/or, Sixth priority level where a SyncRef WTRU may synchronize with its own internal clock.

A SyncRef WTRU may perform a Type 2 (e.g., Type 2A) channel access prior to a S-SSB candidate occasion. If one S-SSB transmission (pre)configuration is applied, SyncRef WTRUs of different priority levels may contend for channel access prior to same S-SSB candidate occasions. Depending on the proximity and timing references of the SyncRef WTRUs, a SyncRef WTRU of low priority level may access the channel first and block another SyncRef WTRU of a higher priority level. It may be beneficial to avoid such blocking.

In one approach, a WTRU may be (pre)configured with an association between each S-SSB candidate occasion and a SyncRef WTRU priority level. In one example, one or more S-SSB candidate occasion(s) may be associated with priority level(s) higher than or equal to a (pre)configured threshold. At these occasions, a SyncRef WTRU of a priority level higher than or equal to a (pre)configured threshold may avoid channel contention with a SyncRef WTRU with priority level(s) lower than the threshold. The remaining S-SSB candidate occasions may be associated with all priority levels. Thus, a SyncRef WTRU of high priority level may contend for the channel at more S-SSB candidate occasions.

In another approach, a WTRU may be (pre)configured with a set of S-SSB transmission (pre)configurations. Each S-SSB transmission (pre)configuration may include a different starting slot offset and/or S-SSB interval and/or may have a different number of S-SSB candidate occasions. A WTRU may be (pre)configured with an association between a S-SSB transmission (pre)configuration and the priority level of the SyncRef WTRU.

In one example, a SyncRef WTRU may apply a S-SSB transmission (pre)configuration(s) when its priority level is higher than or equal to a (pre)configured threshold. The S-SSB transmission occasions of such S-SSB transmission (pre)configuration(s) may not overlap with S-SSB transmission occasions of S-SSB transmission (pre)configuration(s) associated with a priority level lower than the threshold. As a result, a SyncRef WTRU may avoid contending for a channel at the same S-SSB transmission occasions. In another example, S-SSB transmission (pre)configuration(s) associated with a priority level higher than or equal to a (pre)configured threshold may have more S-SSB candidate occasions. Thus, a SyncRef WTRU of high priority level(s) may access to the channel more often.

In another approach, a WTRU may be (pre)configured with multiple starting positions associated with priority levels for one or more S-SSB candidate occasions of a S-SSB transmission (pre)configuration. In one example, a starting position may be indicated by a timing offset before the symbol boundary of the first symbol of a S-SSB candidate occasion. The timing offset may be an integer number of a (pre)configured time unit(s) of a LBT sensing slot, a contention period, a symbol, a mini-slot, and/or a slot. A starting position with a large timing offset may indicate an early starting position for a S-SSB candidate occasion. A WTRU may perform a reservation signal transmission and/or CPE transmission from the starting position to the start of the S-SSB candidate occasion. In another example, a starting position may be indicated by a duration of a CPE transmission performed before the symbol boundary of the first symbol of a S-SSB transmission. A WTRU may be (pre)configured with a set of CPE durations to indicate a starting position for a S-SSB candidate occasion.

Prior to a S-SSB candidate occasion (pre)configured with multiple starting positions associated with priority levels, a SyncRef WTRU of a high priority level may start a CPE transmission at an early starting position and thus block the channel access by another SyncRef WTRU of a lower priority level.

A WTRU may also be (pre)configured for single starting positions for one or more S-SSB candidate occasions of a S-SSB transmission (pre)configuration. At these S-SSB candidate occasion(s), a SyncRef WTRU may access the channel regardless of the priority level.

In some cases, a WTRU may perform a SL U channel access and resource selection procedure for initiation of a reserved COT to perform re-transmissions of a TB transmitted in a previous COT.

A WTRU may determine to perform LBT sensing-based SL U channel access and resource selection for COT initiation following performing initial transmission and re-transmissions of a TB in a shared or initiated COT when the number of performed transmissions may be less than the determined total number (N_{TX}) of transmission(s) including initial transmission(s) and re-transmission(s) to be performed within the determined RSW of the TB.

A WTRU may indicate a COT and/or resource reservation window in the SCI of the PSSCH/PSCCH transmission(s) performed in the shared or initiated COT. A WTRU may perform channel access and resource selection for COT initiation within the indicated window. In one example, a WTRU may indicate a value of L_{w} logical slots, such as a reservation window with length of L_{w} logical slots of the resource pool used for the PSSCH/PSCCH transmissions. A WTRU may determine L_{w} based on the remaining PDB of the TB to transmit.

The start of a reservation window may be (pre)configured relative to the end of the COT in which the SCI including the reservation window information may be transmitted. In one example, when a WTRU performs transmissions of a TB in a shared or initiated COT ending in slot (t), the starting slot of the reservation window may be slot (t+T_{ch}) where T_{ch} may be a (pre)configured processing time and the end slot of the window may be slot (t+T_{ch}+L_{w}+1). In another example, the indicated window length and window start and end slots may use a unit of physical slot.

A WTRU may perform LBT sensing-based SL U channel access and resource selection for COT initiation within the indicated window, and upon a successful channel access the WTRU may determine the available resources within the initiated COT according to resource selection in an initiated COT. A WTRU may indicate a failure to higher layers for a channel access and resource selection triggered for the transmitted (TB)s when the LBT sensing-based SL U channel access is not successful within the indicated reservation window.

In some cases, there may be SL U channel access and resource selection procedure for initiation of a reserved COT to perform initial transmission and re-transmissions of a new TB.

A WTRU may perform semi-static COT and/or resource reservation for initial transmission and re-transmissions of another TB when COT and/or resource reservation for another TB for COT sharing are enabled in the resource pool.

The reservation interval may be indicated in the unit of ms or number of logical or physical slots between the current COT and a reserved COT for transmission(s) of another TB(s) by the same WTRU. A WTRU may be (pre)configured to reserve a COT of the same length of the current COT. Also, a WTRU may be (pre)configured to reserve the same frequency resource(s) as those used within the current COT.

In one example, a reservation window associated with the indicated reservation interval may be included in the same SCI (e.g., the reservation window is associated with a reservation interval, and both pieces of information are included in the SCI). A WTRU may determine the length of such an associated reservation window based on the remaining PDB of the TB transmitted in the current COT. A WTRU may assume the TB transmitted in the current COT and the one to be transmitted in the reserved COT have the same remaining PDB. In another example, such an associated reservation window may have a (pre)configured length.

When a WTRU performs a transmission of a TB in a first SL slot (t) of an initiated or a first shared SL slot (t) in a shared COT, the WTRU may indicate a reservation interval (P_{rsvp_TX}) in the SCI associated with the PSSCH/PSCCH transmission(s) performed in the COT. The indication may announce that the WTRU may perform SL U channel access and resource selection for COT initiation to initiate a COT starting at and/or including SL slot (t+P_{rsvp_TX}). In another example, the WTRU may perform SL U channel access and resource selection for COT sharing to share a COT including a SL slot (t+P_{rsvp_TX}).

In another example, a WTRU may perform SL U channel access and resource selection for COT initiation to initiate a COT within the associated reservation window. The associated reservation window may be (pre)configures to include the SL slot (t+P_{rsvp_TX}) at the beginning, in the middle, at the end, or in a (pre)configured location of the window. A WTRU may initiate and/or share a COT within the associated reservation window.

In another approach, the reservation window may include a period reserved for Type 1 LBT channel access preceding the reserved COT. A WTRU may determine the duration of the period based on the duration of LBT contention window indicated in the CAPC configuration in accordance with the priority of the TB to transmit in the reserved COT. A WTRU may perform Type 1 LBT sensing channel access within this period to initiate the reserved COT in the reservation window.

In another example, when a WTRU performs a transmission of a TB in slot (t) in an initiated or shared COT, the WTRU may indicate a reservation range and/or latency bound in the SCI associated with the PSSCH/PSCCH transmission(s) performed in the COT. A WTRU may perform a LBT sensing-based SL U channel access and resource selection for COT initiation to initiate a COT of same length within the indicated range and/or before the latency bound. A WTRU may indicate the start and end slot of the range and latency bound in units of logical slot of the resource pool. In another example, a physical slot may be applied for the indication. A WTRU may determine the range and/or latency bound based on one or more factors, such as the remaining PDB of the TB to transmit.

Upon a successful channel access within the indicated associated window, range and/or latency bound, a WTRU may determine the available resources within the initiated COT according to Resource selection in an initiated COT. A WTRU may indicate a failure to higher layers for a channel access and resource selection triggered for the transmitted TB(s) when the LBT sensing-based SL U channel access is not successful.

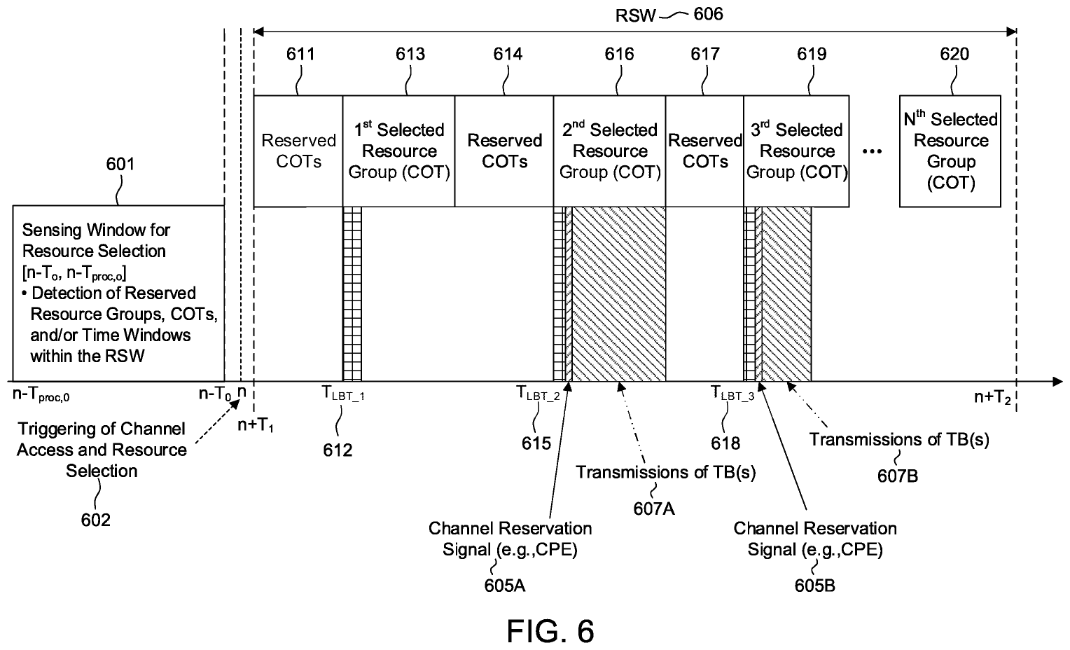

FIG. 6 illustrates an example of a WTRU resource group/COT selection before Type 1 LBT for COT initiation. In some cases, a WTRU may select a resource group/COT before LBT for COT initiation. As shown, time may be shown in the horizontal axis. A WTRU may determine a set of resource groups and/or COTs based on sensing information (e.g., SCI, RSRP, etc.) before performing Type 1 LBT to initiate a COT.

In one example, a resource group may include a number of slots with a number of RB interlaces selected in each slot for an initial transmission or a re-transmission of a TB. A COT may be the time duration of such a resource group, such as the number of consecutive slots. In one example, a duration of a resource group may be the maximum COT indicated in the CAPC configuration corresponding to the priority of the TB.

In another example, a duration of resource group may include a period preceding the COT. A WTRU may determine the duration of the period based on the duration of LBT contention window indicated in the CAPC configuration and associated with the priority of the TB to transmit in the reserved COT. A WTRU may reserve the SL slots included in the determined period in the resource group. The reserved period may be intended for the WTRU to perform Type 1 LBT sensing channel access before initiating the reserved COT.

At 601, the WTRU may determine a resource selection window (RSW) 606 between slot (n+T₁) and (n+T₂), where T₁ and T₂ may be a (pre)configured WTRU processing time and a value based on the indicated remaining PDB (e.g., sensing window means where the WTRU decodes all detected SCI and other related information and stores the information for processing and later use). At 602, the WTRU may be triggered in slot (n) by a higher layer to transmit a SL TB with a priority (Priority_{TX}) and remaining PDB.

In some instances, a WTRU may determine a total number of initial and re-transmissions of the TB based on the indicated priority of the TB. A WTRU may determine a total number of SL slots for initial transmission and re-transmissions of the TB, which may be identical to the total number of transmissions of the TB. In one approach, if a TB's priority corresponds to a MCOT of X slots and the total number of transmissions of the TB is Y, a WTRU may determine a number (N_{required}) of required resource groups and/or COT for the transmissions may be Ceiling(Y/Z), such as the closest integer larger than Y/Z.

In some instances, a WTRU may determine a number (N) of resource groups and/or COTs within the RSW to acquire using Type 1 LBT. Due to the LBT uncertainty, a WTRU may determine a number larger than the required number (e.g., N=N_{required}+offset). The offset may be a (pre)configured value. In one approach, the offset may be associated with channel congestion level and/or priority of the TB. A larger offset may be associated with high congestion level and high priority of the TB. The increased number of resource groups and/or COTs may allow WTRU to perform more Type 1 LBTs to acquire a channel.

In some instances, a WTRU may determine the locations of the N resource groups and/or COTs within the RSW based on the reserved COT/resources information decoded in the sensing. A WTRU may exclude one or more of the following slots from the RSW: the slots reserved in a COT and/or resource reservation; and/or, the RSRP measured at the PSSCH/PSCCH transmission reserving the resources/COT that may exceed a (pre)configure threshold, where the value of the threshold may be based on the priority associated with the PSSCH/PSCCH transmission (Priorityᵣₑₛᵥ) and the priority of the TB to transmit (Priority_{TX}).

In the remaining SL slots within the RSW, a WTRU may determine N selected resource groups and/or COTs (as shown in the FIG. 6). Before each selected resource group and/or COT, a WTRU may determine an associated LBT period to perform Type 1 LBT procedure. The duration of LBT period may be (pre)configured.

In some instances, a WTRU may determine the frequency resources in each slot of a selected resource group and/or COT. The frequency resources may be a number of sub-channel or a number of RB of interlaces. The determination of the sub-channels or RB interlaces may be based on one or more of the following: Total number of sub-channel or RB interlaces (pre)configured in a resource pool; WTRU source and/or destination ID; Random selection; Logical slot index; and/or, (pre)configured patterns.

As shown in FIG. 6, a WTRU may perform a Type 1 LBT procedure in a LBT period associated with a selected resource group and/or COT. When the channel is sensed to be available, the WTRU may perform a transmission of channel reservation signal and/or CPE before the earliest slot boundary (e.g., 605A and 605B). The WTRU may initiate a COT and perform transmissions of the TB at the slot boundary (e.g., 607A and 607B). When the channel is sensed to be busy in the end of the LBT period, a WTRU may stop LBT sensing (e.g., stop the LBT procedure for this period) and perform Type 1 LBT procedure at the LBT period associated with the next selected resource group and/or COT.

As shown in the example in FIG. 6, during the LBT period 612 associated with the first selected resource group and/or COT 613 within the RSW 606, the WTRU fails to acquire a channel (e.g., channel is not available at the start of the selected resource group/COT/time window) and stops Type 1 LBT. The WTRU may perform Type 1 LBT in the LBT period 615 associated with the second selected resource group and/or COT 616 (e.g., 604), and the LBT may be successful (e.g., channel is available at the start of the selected resource group/COT/time window) and initiate a COT for SL transmissions (e.g., 607A). The WTRU may send a reservation signal 605A prior to transmitting a TB 607A. The WTRU may continue performing Type 1 LBT in the LBT period 618 associated with the next selected resource group and/or COT (e.g., the third selected resource group 619) when the determined number of COT to be initiated (N_{required}) is larger than the number of COT already initiated. In this example, a WTRU initiates another COT at the third selected resource group and/or COT 619, and the LBT is successful, and completes all transmissions determined for the TB (e.g., 607B). The WTRU may send a reservation signal 605B prior to transmitting a TB 607B. As the transmissions are complete, the WTRU may not perform LBT and acquire channel at the remaining selected resource groups and/or COTs within the RSW (e.g., LBT may not need to be performed between 619 and 620).

In one example, the examples of FIG. 5 and FIG. 6 may be read together, where the second selected resource group (COT) 616 encompasses the instances where WTRU 501 and WTRU 502 perform LBT, and WTRU 502 sends a reservation signal and transmits a TB (e.g., 521, 522, 531, and 532). Further, the third selected resource group (COT) 619 may encompass where WTRU 501 performs LBT, sends a reservation signal, and is able to transmit its TB (e.g., 522 and 523). In this combined example, neither WTRU 501 nor WTRU 502 are able to access the channel during the first selected group (e.g., due to a busy channel). WTRU 501 and WTRU 502 may consequently perform LBT in the next available occasion (e.g., time) in the second selected resource group 616. The number of starting positions associated with priority 1 (e.g., as referenced in FIG. 5) would be more than priority 2. When the channel is idle, the WTRU 501 may finish LBT first, but during the long gap to WTRU 501's (pre)configured starting position, WTRU 502 may access the channel first and transmit its TB. WTRU 501 must then perform LBT prior to its associated next starting position and determine if the channel is idle.

Generally, a WTRU may indicate a LBT failure to the higher layers when a WTRU does not acquire a channel in all selected resource groups and/or COTs and/or the number of initiated COT is smaller than the determined number of required COT (N_{required}). In another case, a WTRU may trigger a resource re-selection when Type 1 LBT sensing channel access fails prior to one or more selected resource group(s) and/or COT(s).

A WTRU may perform a channel access (e.g., a Type 1 LBT channel access) prior to the start of the selected resource group. When the channel is sensed to be available, the WTRU may initiate a COT and perform PSSCH/PSCCH transmissions in the selected resources. In one case, when the channel is sensed to be busy at the start of the selected resource group, a WTRU may stop the channel access and perform a new channel access prior to the next selected resource group within the resource selection window. In another case, when the channel is sensed to be busy at the start of the selected resource group, a WTRU may continue performing the LBT channel access in the selected resource group. A WTRU may sense the channel to be idle within the selected resource group and may initiate a COT with the remainder of the resource group. In another example, a WTRU may indicate a COT with the remainder of the selected resource group when the number of remaining logical slots in the selected resource group exceeds a (pre)configured threshold.

In some cases, a WTRU may initiate a COT with MCOT overlapping with reserved resources/COT. When a WTRU is triggered to perform resource selection for a TB with priority (p), a WTRU may determine a transmission duration, such as a number of consecutive SL slots for transmissions of initial transmission and re-transmissions of the TB. A WTRU may determine a maximum COT (MCOT) duration according to the priority from the CAPC configuration.

When a WTRU selects a resource group and/or COT for initiation including a period for Type 1 LBT sensing channel access and the determined transmission duration (as discussed herein), a WTRU may initiate a COT with a MCOT duration that may overlap with a reserved resource group and/or COT. A WTRU may not perform transmission during the overlapping duration, such as the determined transmission duration may not overlap any reserved resource group and/or COT. Additionally, a WTRU may indicate in SCI the overlapping duration within the COT may not be shared by another WTRU. In one example, a WTRU may indicate “Disabled” in the COT sharing SCI indication. In another example, a WTRU may explicitly indicate the index of the non-overlapping SL slots to share within the COT.

In some cases, a WTRU may initiate a COT base on frequency domain multiplexing. A WTRU may select a resource group to initiate a COT that may overlap in time with a reserved resource group and/or COT. A WTRU may select one or more frequency resource(s) that may not be reserved in the resource group and/or COT reservation. For example, the frequency resource(s) may comprise of one or more RBs, one or more sub-channels, one or more RB interlaces, and/or one or more RB sets.

A WTRU may determine to perform a Type 1 LBT prior to the selected resource group. A WTRU may determine to initiate a COT within the selected resource group when one of the following occurs: the channel may be sensed to be available as a result of the Type 1 LBT; and/or, the channel may be sensed to be busy as a result of the Type 1 LBT and the decoded SCI may indicate the selected frequency resources may not be used.

A WTRU may perform PSSCH/PSCCH transmission(s) within the initiated COT in different frequency resource(s) than the one(s) indicated in a resource group and/or COT reservation detected in SCI sensing.

In another example, a WTRU may perform a frequency re-selection when the channel is sensed to be busy as a result of the Type 1 LBT and the decoded SCI may indicate the selected frequency resources may be used. A WTRU may perform PSSCH/PSCCH transmission(s) within the initiated COT in different frequency resource(s) than the one(s) indicated in the SCI received during Type 1 LBT.

Thus, a WTRU may initiate a COT that may be frequency domain multiplexed (FDM:ed) with a reserved and/or an on-going resource group and/or COT. A WTRU may be (pre)configured to perform such a FDM:ed COT initiation when one or more of the following occurs: the number of candidate resource groups and/or COTs within the RSW is below a (pre)configured threshold; Channel congestion metrics (e.g., CBR and/or CO) exceeds a (pre)configured threshold.

In some cases, a WTRU may determine success or failure for SL U channel access and resource selection. A WTRU may perform one or more SL U channel access and resource selection for COT initiation in a determined RSW. A WTRU may stop performing a LBT sensing-based SL U channel access and resource selection for COT initiation in a determined RSW when the determined number (N_{TX}) of transmission(s) of the TB(s) have been performed. A WTRU may indicate a success to higher layers for a channel access and resource selection triggered for the transmitted (TB)s.

A WTRU may stop performing LBT sensing-based SL U channel access and resource selection for COT initiation in a slot (n+T₂−T_{process_min}) where slot (n+T₂) is the determined end of RSW and T_{process_min} is a (pre)configured minimum process time, and/or when the number (N_{tx_performed}) of performed transmission(s) within initiated COT(s) and/or shared COT(s) within the RSW is smaller than the determined number (N_{TX}) of transmission(s) of the TB(s) (N_{tx_performed}<N_{TX}). In this case, a WTRU may indicate a failure to higher layers for a channel access and resource selection triggered for the transmitted (TB)s.

In another example, a WTRU may be (pre)configured with a percentile threshold (Thₜₓ%), which may indicate a minimum number of transmission(s) to be performed for the TB(s) relative to the determined number of transmission(s) (N_{TX}). When a WTRU stops LBT sensing-based SL U channel access and resource selection for COT initiation in a slot (n+T₂−T_{process_min}) as described herein, a WTRU may indicate failure to higher layers for a channel access and resource selection triggered for the transmitted (TB)s; for example, when the number (N_{tx_performed}) of performed transmission(s) within initiated COT(s) and/or shared COT(s) within the RSW is smaller than the number the transmission(s) of the TB(s) (N_{tx_performed}<Thₜₓ%×N_{TX}). Otherwise, a WTRU may indicate a success to higher layers for a channel access and resource selection triggered for the transmitted (TB)s. In another example, such a threshold may be associated with priority of the TB(s) and a WTRU may select a threshold based on the (pre)configuration and the priority of the (TB)s to transmit.

In one example, when a WTRU initiates a COT, a WTRU may determine to apply a gap period in the end of the last PSSCH/PSCCH transmission scheduled in the COT. A WTRU may perform TX/RX switch during this gap period. In one example, a gap period may be (pre)configured with a duration larger than 16 us and a gap period of one symbol may be (pre)configured for a resource pool with SCS of 15 kHz, 30 kHz and 60 kHz. In another example, a gap period may be (pre)configured with a duration larger than 25 us. In this case, a gap period of one symbol may be (pre)configured in a resource pool with SCS of 15 kHz and 30 kHz and two symbols in a resource pool with SCS of 60 kHz.

In some cases, there may be a WTRU physical layer LBT failure indication based on channel access for PSSCH/PSCCH transmission. A WTRU may indicate a LBT failure to higher layers based on Type 1 LBT channel access performed at one or more selected resource group(s) and/or COT(s) in a RSW for PSSCH/PSCCH transmission(s). An example of such selected resource group(s) and/or COT(s) are shown in FIG. 6.

In some instances, a WTRU may indicate a LBT failure to higher layers according to one or more circumstances.

For example, a WTRU may indicate a LBT failure when a WTRU performs a Type 1 LBT channel access and fails to access the channel and fails to perform a PSSCH/PSCCH transmission during one selected resource group(s) and/or COT(s) within a RSW. A WTRU may evaluate a LBT failure indication per selected resource group and/or COT within a RSW.

For example, a WTRU may indicate a LBT failure when a WTRU performs a Type 1 LBT channel access and fails to access the channel and fails to perform a PSSCH/PSCCH transmission during the 1st selected resource group and/or COT within a RSW. A WTRU may not indicate a LBT failure at the subsequent selected resource group(s) and/or COTs within a RSW regardless of the LBT channel access results. A WTRU may evaluate a LBT failure indication per RSW.

For example, a WTRU may indicate a LBT failure when a WTRU performs a Type 1 LBT channel access and fail to access the channel and fails to perform a PSSCH/PSCCH transmission during all selected resource group(s) and/or COT(s) within a RSW. Thus, a WTRU may evaluate a LBT failure indication per RSW.

For example, a WTRU may indicate a LBT failure when a WTRU performs a Type 1 LBT channel access and fails to access the channel and fails to perform a PSSCH/PSCCH transmission during each of a number of the selected resource group(s) and/or COT(s) within a RSW. A WTRU may determine the number based on a (pre)configured ratio relative to the total number of selected resource group(s) and/or COT(s) within a RSW. A WTRU may evaluate such a LBT failure indication per RSW.

In some instances, a WTRU may indicate a LBT failure to higher layers based on the number of PSSCH/PSCCH transmissions performed within a RSW. A WTRU may indicate a LBT failure according to one or more circumstances.

For example, a WTRU may perform one or more Type 1 LBT channel access and fail to access the channel and fail to perform PSSCH/PSCCH transmission(s) of TB(s) within a RSW.

For example, a WTRU may perform one or more Type 1 LBT channel access and fail to perform a required number of PSSCH/PSCCH transmission(s) for TB(s) within a RSW. A WTRU may determine the required number of PSSCH/PSCCH transmissions(s) including initial transmission(s) and re-transmission(s) of one or more TB(s) when the WTRU is triggered for resource selection and LBT channel access for COT initiation by higher layers.

In some instances, a WTRU may indicate a LBT failure to higher layers based on Type 1 LBT channel access performed for PSSCH/PSCCH transmission(s) scheduled by a base station. A WTRU may indicate a LBT failure according to one or more circumstances.

For example, a WTRU may perform one or more Type 1 LBT channel access and fail to access the channel prior to the start of a PSSCH/PSCCH transmission scheduled in a dynamic grant (DG). A WTRU may determine the start of a PSSCH/PSCCH transmission based on SL transmission timing information received in a DCI including the dynamic grant. The SL timing information may be indicated as a time gap (e.g., in unit of logical SL slots) between the DL slot in which the DCI is received and the SL slot in which the PSSCH/PSCCH transmission is scheduled.

For example, a WTRU may perform one or more Type 1 LBT channel access and fail to access the channel and fail to perform PSSCH/PSCCH transmission(s) within a scheduled transmission period/window indicated in a dynamic grant (DG). A WTRU may receive a SL transmission period and/or window duration information (e.g., in units of logical slot) in a DCI including the dynamic grant. The period and/or window may start from the DL slot in which the DCI is received and end after the indicated duration.

For example, a WTRU may perform one or more Type 1 LBT channel access and fail to access the channel prior to the start of a periodical SL transmission according to a configured grant (CG). A WTRU may determine the start of the SL transmission based on the transmission timing information included in the RRC configuration of the configured grant. The timing information may include transmission periodicity, reference slot and/or slot offset.

In some instances, a WTRU may indicate a LBT failure to higher layers based on Type 2 LBT channel access performed for PSSCH/PSCCH transmission(s). A WTRU may indicate a LBT failure when the following occurs. A WTRU may perform a Type 2 LBT channel access (e.g., Type 2A/2B) and fail to access the channel prior to the starting position associated with the priority of the TB(s) to transmit in a current sharable COT. A WTRU may thus fail to share a current sharable COT (e.g., as shown in FIG. 3).

In some cases, there may be a WTRU physical layer LBT failure indication based on channel access for PSFCH transmission. A WTRU may indicate a LBT failure to higher layers based on Type 1 LBT channel access performed for one or more PSFCH transmission(s) at one or more PSFCH occasion(s) within a HARQ latency. In one example, such PSFCH occasions may be within PSFCH slots outside the COT including the PSSCH/PSCCH transmission(s) associated with the PSFCH transmission(s).

A WTRU may determine a HARQ latency based on the QoS of the TB(s) and indicate it in the SCI of the PSSCH/PSCCH transmission(s). In another example, a HARQ latency may be (pre)configured with an association with priority and a WTRU may accordingly determine a HARQ latency based on such a (pre)configuration and L1 priority indicated in the SCI of the associated PSSCH/PSCCH transmission(s).

In a further example, a WTRU may determine a HARQ latency to indicate in the SCI of the PSSCH/PSCCH transmissions(s) based on the received PUCCH resource configuration/scheduling. A WTRU may perform PSSCH/PSCCH transmission(s) according to a SL scheduling grant received in a DCI from a base station. A WTRU may receive a PUCCH resource configuration/scheduling in the same DCI to transmit a PUCCH carrying the SL HARQ feedback information associated with the scheduled PSSCH/PSCCH transmission(s). A WTRU may thus indicate a LBT failure to higher layers based on Type 1 LBT channel access performed for PSFCH transmission(s) to be included in a PUCCH scheduled by a base station.

A WTRU may determine one or more PSFCH slots with each including a PSFCH occasion within the determined HARQ latency. In one example, the PSFCH slots may be (pre)configured in a resource pool. In another example, the PSFCH slots may be indicated in a SCI of the associated PSSCH/PSCCH transmission(s).

In some instances, a WTRU may indicate a LBT failure to higher layers under one or more circumstances.

For example, a WTRU may perform a Type 1 LBT channel access and fail to access the channel prior to the start of each PSFCH occasion within the HARQ latency. A WTRU may evaluate a LBT failure per PSFCH occasion.

For example, a WTRU may perform a Type 1 LBT channel access and fail to access the channel prior to the start of the 1st PSFCH occasion within the determined HARQ latency. A WTRU may not indicate a LBT failure at the subsequent PSFCH occasions and thus may evaluate a LBT failure per HARQ latency.

In some instances, a WTRU may indicate a LBT failure to higher layers based on whether PSFCH transmission(s) may be performed within the HARQ latency. A WTRU may indicate a LBT failure under one or more circumstances.

For example, a WTRU may perform one or more Type 1 LBT channel access and fail to access the channel and fail to perform PSFCH transmission(s) within the HARQ latency. A WTRU may evaluate a LBT failure per HARQ latency.

For example, a WTRU may perform one or more Type 1 LBT channel access and fail to access the channel and fail to perform PSFCH transmission(s) prior to the scheduled PUCCH transmission. A WTRU may evaluate a LBT failure per scheduled PUCCH transmission.

For example, a WTRU may perform one or more Type 1 LBT channel access and fail to access the channel at a number of PSFCH occasions before a successful PSFCH transmission within the HARQ latency. The number of such PSFCH occasions may be (pre)configured with association with priority. A low threshold may be (pre)configured for high priority to enable a WTRU to adjust the channel access parameter more quickly for HARQ feedback associated with high-priority PSSCH/PSCCH transmission(s).

For example, a WTRU may fail to receive PSFCH transmission(s) within the HARQ latency indicated in the performed PSSCH/PSCCH transmission(s). In another example, a WTRU may fail to receive PSFCH transmission(s) prior to the scheduled PUCCH transmission. A WTRU may report such LBT failure to the base station.

In some instances, a WTRU may indicate a LBT failure to higher layers based on Type 2 LBT channel access performed for one or more PSFCH transmission(s) at one or more PSFCH occasion(s) within a HARQ latency. In one example, such PSFCH occasions may be within PSFCH slots within the COT including the PSSCH/PSCCH transmission(s) associated with the PSFCH transmission(s). A WTRU may indicate a LBT failure to higher layers under one or more circumstances. For example, may perform a Type 2 LBT channel access (e.g., Type 2A/2B) and fail to access the channel prior to start of the PSFCH occasion in a current COT sharable for PSFCH transmission(s).

In some cases, there may be a WTRU physical layer failure indication based on channel access for S-SSB (SL Synchronization Signal Block) transmission. A WTRU may indicate a LBT failure to higher layers based on Type 1 and/or Type 2 LBT channel access performed for one or more S-SSB transmission(s) at one or more S-SSB candidate occasion(s) within a (pre)configured S-SSB period. A WTRU may determine one or more S-SSB candidate occasions (e.g., the SL slot and symbol location) based on the (pre)configured S-SSB period duration, S-SSB starting slot offset, and/or interval between S-SSBs within a period (e.g., all in unit of logical SL slot).

In some instances, a WTRU may indicate LBT failure to higher layers according to one or more circumstances.

For example, a WTRU may indicate a LBT failure when a WTRU performs a Type 1 and/or Type 2 LBT (e.g., Type 2A/2B) channel access and fails to access the channel prior to a S-SSB candidate occasion and fail to perform a S-SSB transmission. A WTRU may evaluate a LBT failure indication per S-SSB candidate occasion.

For example, a WTRU may indicate a LBT failure when a WTRU performs a Type 1 and/or Type 2 LBT (e.g., Type 2A/2B) channel access and fails to access the channel prior to the 1st S-SSB candidate occasion within a S-SSB period. A WTRU may not indicate a LBT failure at the remaining S-SSB candidate occasions within the S-SSB period. A WTRU may evaluate a LBT failure per S-SSB period.

For example, a WTRU may indicate a LBT failure when a WTRU performs one or more Type 1 and/or Type 2 LBT (e.g., Type 2A/2B) channel access and fails to access the channel prior to all S-SSB candidate occasion within a S-SSB period. Thus, a WTRU may indicate a LBT failure when a WTRU fails to perform any S-SSB transmissions within a S-SSB period.

For example, a WTRU may indicate a LBT failure when a WTRU performs one or more Type 1 and/or Type 2 LBT (e.g. Type 2A/2B) channel access and fails to access the channel prior to a (pre)configured number of S-SSB candidate occasion(s) within a S-SSB period.

A WTRU may adjust the S-SSB transmission parameters when the number of indicated S-SSB LBT failures exceed a (pre)configured threshold. In one example, a WTRU may determine a different S-SSB starting slot offset within a S-SSB period to access the channel at different time instances.

In some cases, there may be a WTRU physical layer indication of additional information with LBT failures. A WTRU may provide one or more of the following information to higher layers in addition to a LBT failure indication: type of performed LBT channel access, such as Type 1, Type 2A, Type 2B LBT, etc.; type of the SL channel(s) to transmit, such as PSSCH/PSCCH, PSFCH, S-SSB, etc.; priority/CAPC configuration associated with the performed LBT channel access; and/or, mode of the channel access, such as a base station scheduled or WTRU autonomous.

In another example, a WTRU may determine a consecutive LBT sensing failure of SL U channel access and resource selection when a number of failures for SL U channel access and resource selection as discussed herein may exceed a (pre)configured threshold. In one example, the threshold may be a number of TBs that WTRU may fail to transmit due LBT sensing failure. A WTRU may report such a consecutive LBT sensing failure to higher layers. A WTRU may receive a LBT sensing configuration in response to the reported consecutive LBT sensing failure. For example, the CAPC configuration for the subsequent LBT sensing for SL U channel access and resource selection may have a longer contention window.

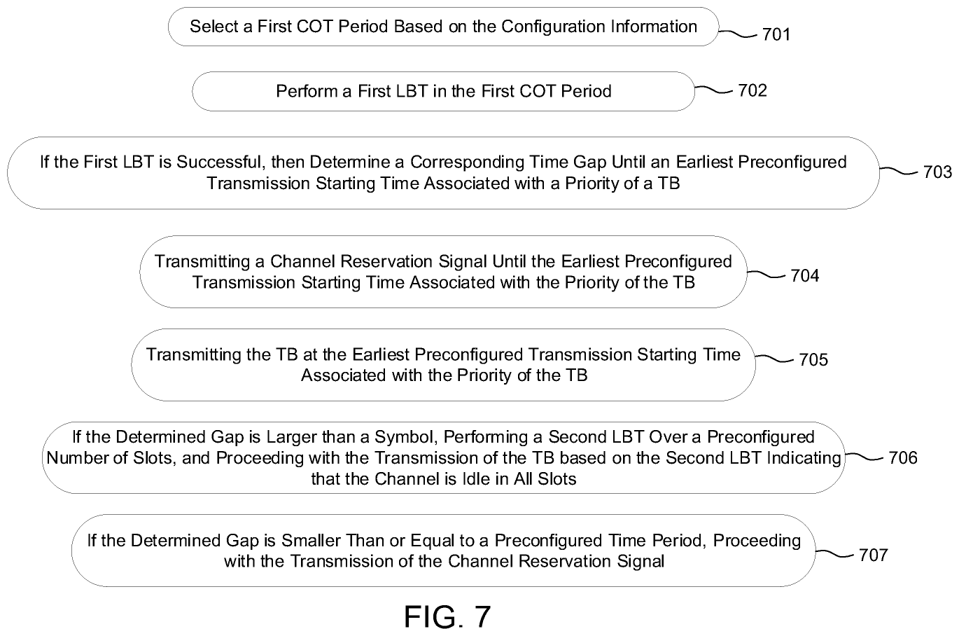

FIG. 7 illustrates an example process for a WTRU to transmit a message in unlicensed spectrum. At some point prior, a WTRU may receive one or more pieces of configuration information in one or more messages. At 701, the WTRU may select a first channel occupancy time (COT) period from a preconfigured number of candidate COT periods within a resource selection window (RSW). At 702, the WTRU may perform a first Listen Before Talk (LBT) in the first COT period on a channel in unlicensed spectrum. At 703, upon an indication of success with the first LBT, the WTRU may determine a corresponding time gap until an earliest preconfigured transmission starting time associated with a first priority of a sidelink transport block (SL-TB). At 704, the WTRU may transmit a channel reservation signal until the earliest preconfigured transmission starting time associated with the first priority of the SL-TB. At 705, the WTRU may transmit the TB (e.g., transmitting a Physical Sidelink Shared Channel transmission or a Physical Sidlelink Control Channel transmission) at the earliest preconfigured transmission starting time associated with the first priority of the SL-TB. At 706, in some instances, if the determined gap is larger than a symbol, the WTRU may perform a second LBT over a preconfigured number of slots, and proceed with the transmission of the PSSCH/PSCCH transmission based on the second LBT indicating that the channel is idle in all slots. At 707, in some instances, the channel reservation signal may be transmitted on a condition that the determined gap is smaller than or equal to a preconfigured time period, wherein the preconfigured time period is a symbol. In some instances, the configuration information may include a number of candidate COT periods within the RSW. In some instances, the first LBT may be Type 1. In some instances, selecting the first COT period may be based on COT reservation information from side link control information (SCI). In some instances, the RSW may be determined based on a remaining Packet Delay Budget (PDB) of the SL-TB.

Based on one or more techniques described herein, in one example there may be one or more methods related to SL U channel access and resource selection in Mode 2 based on LBT and SCI sensing-based channel access for COT initiation and COT sharing performed within the resource selection window.

For instance, a WTRU COT sharing method may comprise one or more steps. The WTRU may be triggered to perform a channel access and resource selection procedure for one or more TB(s) in slot (n). The WTRU may determine: a channel access and resource selection window (RSW) between slot (n+T₁) and slot (n+T₂) where T₁ is a (pre)configured and T₂ is based on remaining PDB of the TB(s); and/or, a number of re-transmission(s) based on QoS of TB(s) and corresponding total number of resource(s). The WTRU may determine a COT is detected in a slot within the determined RSW based on SCI sensing. The WTRU may determine to share the detected COT based on the one or more following decoded SCI from SCI sensing: the remaining duration of the detected COT; the number of scheduled transmission(s) within the COT; the frequency assignment of the scheduled transmission(s); the cast type, WTRU Source and/or Destination ID associated with the TB(s) transmitted in the COT; priority associated with the TB to transmit by the WTRU; and/or, channel congestion indication. The WTRU may perform transmission(s) within the determined shared COT using the following resource(s): one or more slot(s) not scheduled for transmission(s); and/or, one or more frequency resources, such as RB interlace index, not assigned for the scheduled transmission(s).

For instance, a WTRU COT initiation method may comprise of one or more steps. The WTRU may be triggered to perform a channel access and resource selection procedure for one or more TB(s) in slot (n). The WTRU may determine the following: a channel access and resource selection window (RSW) between slot (n+T₁) and slot (n+T₂) where T₁ is a (pre)configured and T₂ is based on remaining PDB of the TB(s); and/or, a number of re-transmission(s) based on QoS of TB(s) and corresponding total number of resource(s). The WTRU may determine to perform a SL U channel access procedure for COT initiation with the RSW. The WTRU may pause SL U channel access procedure for COT initiation in the slot(s) overlapping with a COT and/or resource(s) reserved by another WTRU according to SCI sensing information. Upon success of channel access, a WTRU may determine to initiate a COT and resource(s) within the COT for transmission(s) based on: WTRU source and/or destination ID, type cast, priority of the TB to transmit; and/or, Priority and scheduled resources of PSSCH/PSCCH transmission(s) in an overlapping reserved COT and/or resource(s).

The WTRU may transmit a channel reservation signal, such as AGC symbol and/or SL RS transmission until the beginning of the initiated COT. The WTRU may transmit PSSCH/PSCCH transmission(s) of the TB(s) using the determined resource(s) within the initiated COT with the following information indicated in the SCI: the remaining duration of the detected COT; the number of scheduled transmission(s) within the COT; the frequency assignment of the scheduled transmission(s); priority, cast type, WTRU Source and/or Destination ID associated with the TB(s) transmitted in the COT; and/or, channel congestion indication. The WTRU may repeat channel access and resource selection for COT initiation until: all determined transmission(s) of the TB(s) are performed within the RSW; and/or, a slot (n+T₂−X) where X is a (pre)configured minimum processing time and the number of performed transmissions is less than the determined number of the transmissions of the TB(s). In one case, the WTRU may drop the remaining transmission(s) of the TB(s). Additionally/Alternatively, the WTRU may indicate a failure of SL U channel access and resource selection of the TB(s).

Based on one or more techniques described herein, in one example there may be a WTRU determination of SL COT initiation based on measured congestion status, such as SL U CBR and the time consecutiveness of logical slots within the SL COT according to a mapping between physical slots and corresponding logical slot in the resource pool used for the SL COT.

Based on one or more techniques described herein, in one example there may be a WTRU switching between a blind SCI decoding in each (pre)configured PSCCH resources in a resource pool outside a detected COT and SCI decoding in a COT-specific PSCCH resource within the remaining duration of the detected COT.

Based on one or more techniques described herein, in one example there may be a WTRU determination of SL COT sharing based on distance between the WTRU and the WTRU initiating the COT, RSRP of the PSSCH/PSCCH DMRS, and measured congestion status (e.g. SL U CBR).

Based on one or more techniques described herein, in one example there may be WTRU performing LBT sensing channel access according to COT and/or resource reservation interval and associated reservation window, reservation range, latency bound indicated in a semi-persistence COT, and/or resource reservation in a previously transmitted SCI.

Based on one or more techniques described herein, in one example there may be a WTRU dynamic determination of COT starting position for COT initiation based on the priority of the TB, the priority associated with the COT starting position and channel congestion level.

Based on one or more techniques described herein, in one example there may be COT sharing conditions based on COT initiation/sharing indication in SCI, WTRU source and/or destination ID, TB priority or synchronization sources of the initiating and sharing WTRUs.

Based on one or more techniques described herein, in one example there may be WTRU selection of Type 2A/2B/2C LBT procedure in COT sharing based on channel congestion, TB priority, cast and channel type, remaining PDB and transmission duration.

Based on one or more techniques described herein, in one example there may be Frequency-multiplexing-based COT sharing with WTRUs determination of muting of interlace RB(s) to mitigate interference and setting the transmission power based on PSD regulation, transmission bandwidth and measured power in the shared COT

Based on one or more techniques described herein, in one example there may be WTRU dynamic adjustment of energy detection threshold (EDT) based on channel congestion, channel type, HARQ feedback status, CSI reporting, COT initiation/sharing, etc.

Based on one or more techniques described herein, in one example there may be WTRU COT initiation based on resource/COT selection before Type 1 LBT using the resource/COT reservation information from sensing.

Based on one or more techniques described herein, there may be a method implemented by WTRU. The WTRU may receive a trigger message that prompts performance of LBT and resource selection in order to transmit a SL-TB. The WTRU may determine a RSW based on remaining PDB of the SL-TBs remaining PDB. The WTRU may select frequency resources based on the WTRU source/destination ID. The WTRU may select a (pre)configured number of candidate COT period(s) within a determined RSW based on COT reservation information from sidelink control information sensing. The WTRU may perform LBT in the first determined candidate COT period to measure. The WTRU, upon successful LBT, may determine a corresponding time gap until an earliest preconfigured transmission starting position associated with a L1 priority of the SL-TB. The WTRU may transmit a channel reservation signal until the earliest preconfigured transmission starting position associated with a L1 priority of the SL-TB when the determined gap is smaller than or equal to a preconfigured time period. The WTRU may transmit PSSCH/PSCCH at the earliest preconfigured transmission starting position associated with a L1 priority of the SL-TB. The WTRU may, on a condition that the determined gap is larger than a symbol, perform LBT-sensing over a (pre)configured number of sensing slot(s), and proceeding with the transmission of the PSSCH/PSCCH when the channel is idle in all sensed slots. The preconfigured time period may be a symbol. The frequency resources may be an index of a resources block interlace. The WTRU may perform side link control information (SCI)-sensing. The LBT may be a Type 1. The WTRU may receive configuration information at an initial point, the configuration information related to performing one or more of the above actions.

In one or more embodiments disclosed herein, there may be a WTRU procedure of performing concurrently SL U channel access and resource selection for COT sharing and COT initiation within a RSW.

In one or more embodiments disclosed herein, there may be a WTRU determination of SL COT detection and sharing based on SCI sensing information including remaining duration, the number of scheduled transmission(s) within the COT, frequency resource assignment, priority, cast type, WTRU source and/or destination ID, COT/resource reservation, channel congestion, etc.

In one or more embodiments disclosed herein, there may be a WTRU determination of SL COT initiation based on LBT and SCI sensing information including COT/resource reservation, priority, cast type, WTRU source and/or destination ID, channel congestion, etc.

In one or more embodiments disclosed herein, there may be a WTRU determination of transmission resources within shared and initiated SL COT based on WTRU source and/or destination ID of the TB to transmit, RB interlace assignment indicated in the decoded SCI associated with an overlapping reserved COT.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere (e.g., in another figure, or in a separate portion of the description). In addition, the methods described herein may be implemented in a device running a computer program, software, and/or firmware incorporated in a computer-readable medium for execution by a computer and/or processor operatively connected with a transceiver (e.g., wireless or wired) of the device. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a wireless transmit-receive unit (WTRU), the method comprising:
receiving configuration information that indicates a set of cyclic prefix extension (CPE) starting positions associated with sharing a channel occupancy time (COT),
wherein each CPE starting position of the set of CPE starting positions is associated with a sidelink transmission priority,
wherein each CPE has a duration;
receiving a sidelink control information (SCI) message, wherein the SCI message indicates a remaining COT duration;
transmitting a CPE in the shared COT at a starting position for a duration, wherein the starting position and the duration of the CPE are determined based on a priority of a sidelink message and the configuration information;
transmitting the sidelink message in the shared COT following the CPE at a transmission time determined from the remaining COT duration.

2. The method of claim 1, wherein shared COT is initiated by a second WTRU that sends the SCI message.

3. The method of claim 1, wherein the sidelink message is a physical sidelink control channel (PSCCH) message or a physical sidelink shared channel (PSSCH) message.

4. The method of claim 1, wherein the SCI message indicates to share the shared COT.

5. The method of claim 1, wherein a type 2 listen-before-talk (LBT) is performed prior to transmitting the CPE.

6. The method of claim 1, wherein transmitting the CPE in the shared COT is further based on performing a type 2 listen-before-talk (LBT).

7. The method of claim 1, wherein the SCI message is received in a slot, wherein the transmission time is further determined based on the slot.

8. The method of claim 1, wherein the configuration information includes sidelink priority information.

9. A wireless transmit-receive unit (WTRU) comprising:
a processor operatively coupled to a transceiver,
the processor and transceiver configured to receive configuration information that indicates a set of cyclic prefix extension (CPE) starting positions associated with sharing a channel occupancy time (COT),
wherein each CPE starting position of the set of CPE starting positions is associated with a sidelink transmission priority,
wherein each CPE has a duration;
the processor and transceiver configured to receive a sidelink control information (SCI) message, wherein the SCI message indicates a remaining COT duration;
the processor and transceiver configured to transmit a CPE in the shared COT at a starting position for a duration, wherein the starting position and the duration of the CPE are determined based on a priority of a sidelink message and the configuration information;
the processor and transceiver configured to transmit the sidelink message in the shared COT following the CPE at a transmission time determined from the remaining COT duration.

10. The WTRU of claim 9, wherein shared COT is initiated by a second WTRU that sends the SCI message.

11. The WTRU of claim 9, wherein the sidelink message is a physical sidelink control channel (PSCCH) message or a physical sidelink shared channel (PSSCH) message.

12. The WTRU of claim 9, wherein the SCI message indicates to share the shared COT.

13. The WTRU of claim 9, wherein a type 2 listen-before-talk (LBT) is performed prior to transmitting the CPE.

14. The WTRU of claim 9, wherein transmitting the CPE in the shared COT is further based on performing a type 2 listen-before-talk (LBT).

15. The WTRU of claim 9, wherein the SCI message is received in a slot, wherein the transmission time is further determined based on the slot.

16. The WTRU of claim 9, wherein the configuration information includes sidelink priority information.
